(19) United States
(12) Patent Application Publication
(10) Pub. No.: US 2026/0084336 A1
(43) Pub. Date: Mar. 26, 2026

(54) WOOD CUTTER

(71) Applicant: Andreas Stihl AG & Co. KG, Waiblingen (DE)

(72) Inventors: Jonas LANK, Winnenden (DE); Jonas HEFTI, Stuttgart (DE); Heiko DIEHL, Esslingen (DE); Daniel MARTIN, Winnenden (DE); Carel KARRAR, Rechberghausen (DE); Helmut SCHLESSMANN, Berglen (DE)

(73) Assignee: Andreas Stihl AG & Co. KG, Waiblingen (DE)

(21) Appl. No.: 19/110,088

(22) PCT Filed: Sep. 6, 2023
(86) PCT No.: PCT/DE2023/100659

§ 371 Date: Mar. 9, 2025

(30) Foreign Application Priority Data
Sep. 9, 2022 (DE) 10 2022 123 058.9
Sep. 9, 2022 (DE) 10 2022 123 059.7
Sep. 9, 2022 (DE) 10 2022 123 060.0
Sep. 9, 2022 (DE) 10 2022 123 061.9
Sep. 9, 2022 (DE) 10 2022 123 062.7
Sep. 12, 2022 (DE) 10 2022 123 203.4

(51) Int. Cl. B27B 17/00; B25F 5/02; B27B 17/02; B27B 17/08; H02J 7/00

(52) U.S. Cl. CPC B27B 17/0008; B25F 5/021; B27B 17/02; B27B 17/08; H02J 7/731

(57) ABSTRACT

A pruner includes a housing and a drive motor. The drive motor drives a saw chain, which is guided in a guide groove of a guide bar, in a rotary motion via a drive chain sprocket. A fastening section for receiving a first rechargeable battery pack for supplying the drive motor with electrical energy is provided on a rear end of the housing. The fastening section is provided for receiving a second rechargeable battery pack. The fastening section is arranged on the housing, in particular at least on the first handle, in such a way that a center of gravity of the pruner lies in the first handle when the pruner is in a state in which the first rechargeable battery pack and the second rechargeable battery pack are arranged on the fastening section.

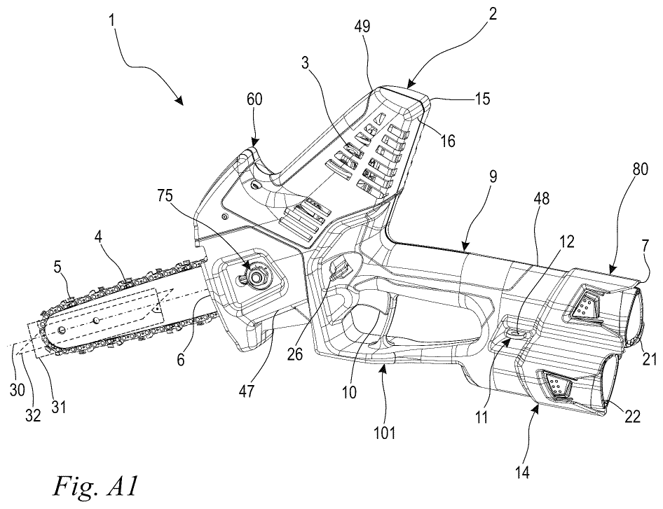

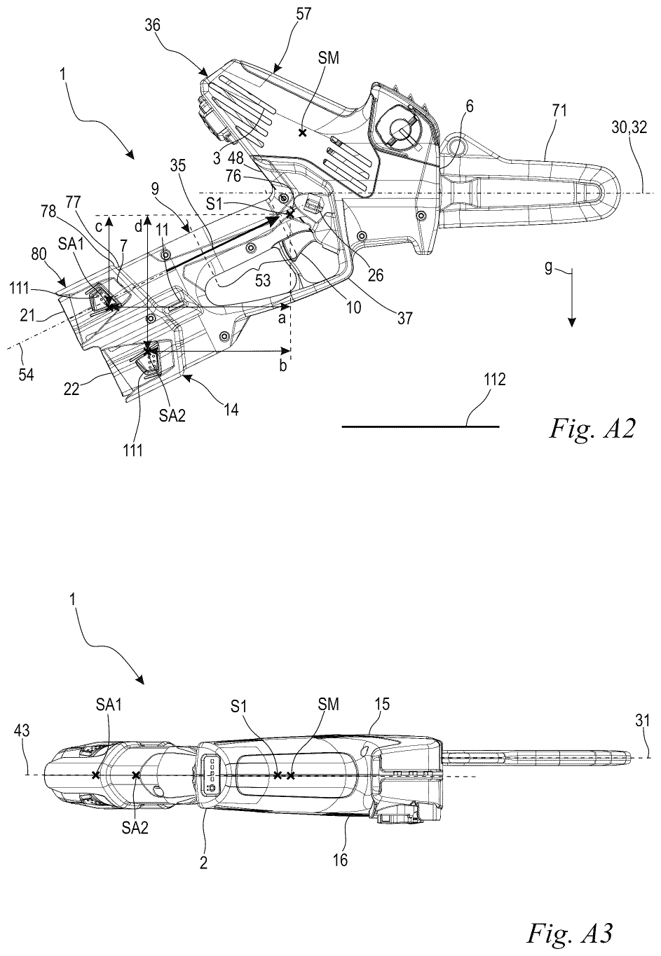

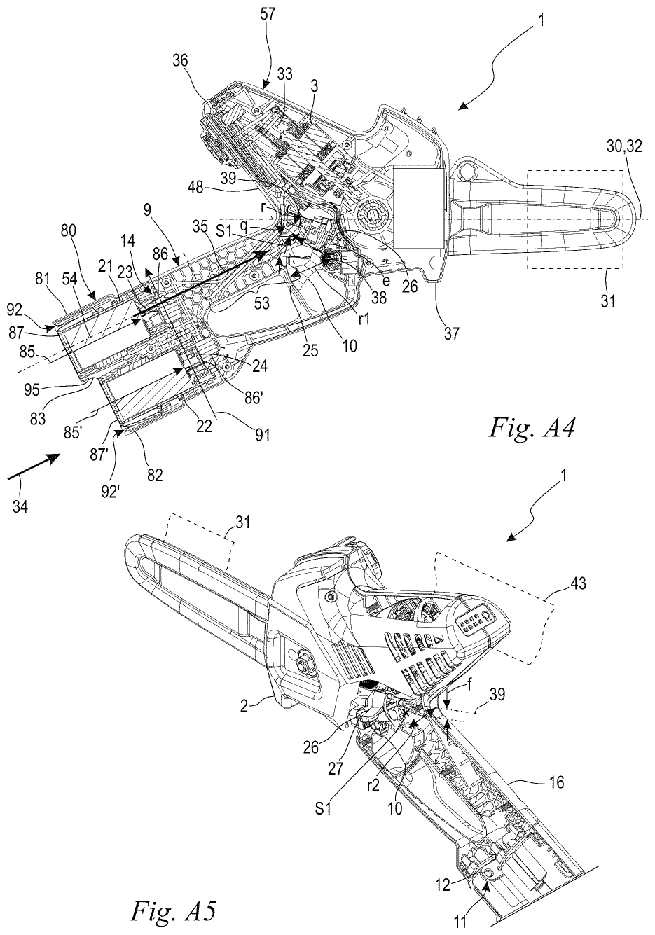

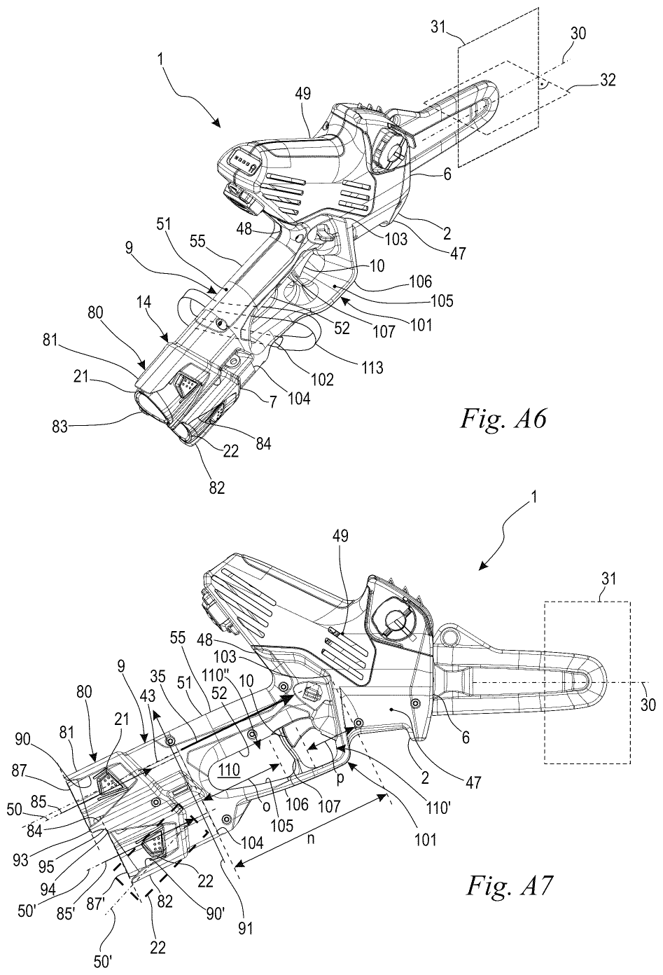

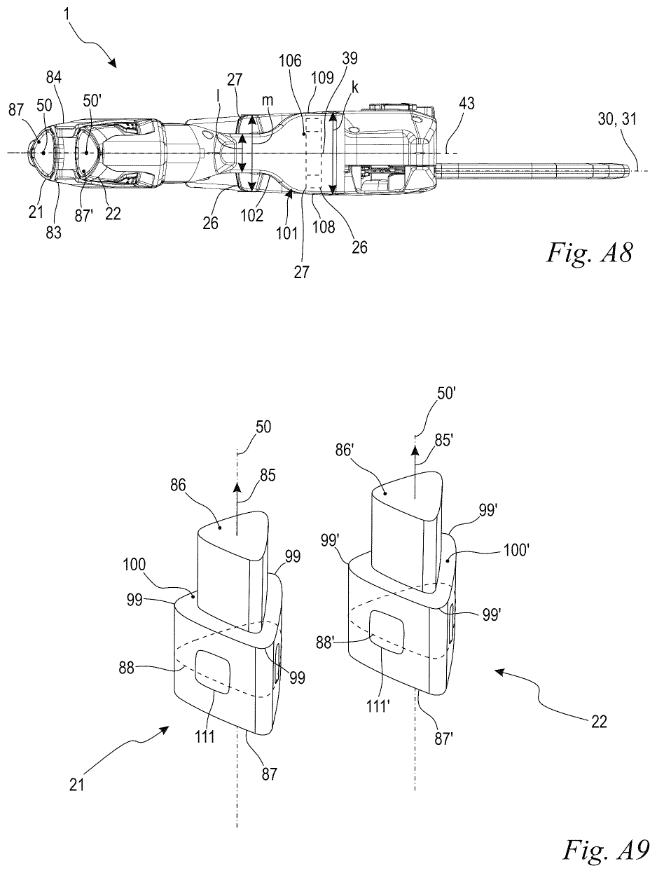

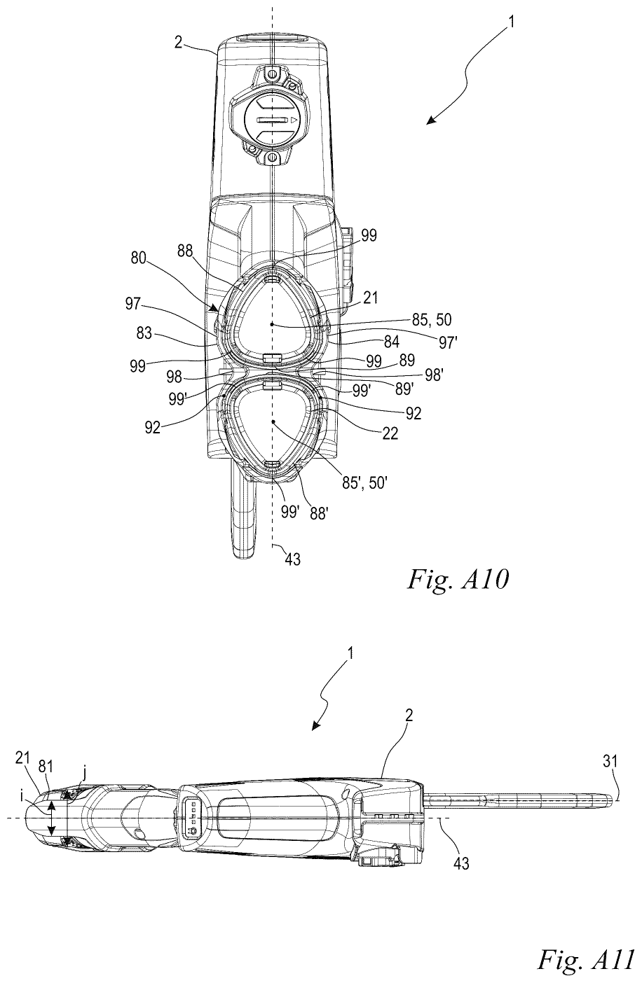

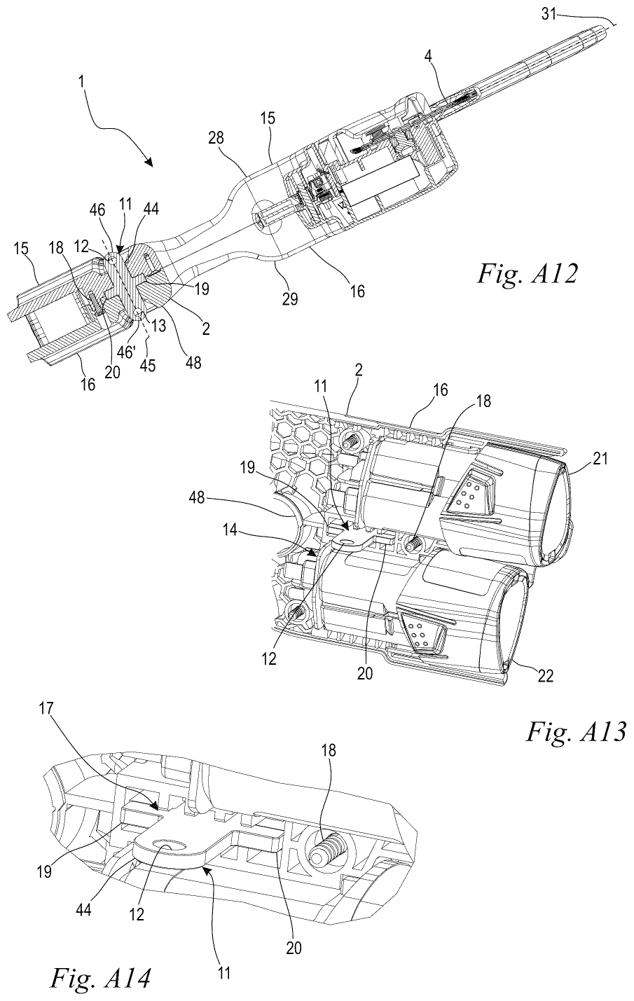

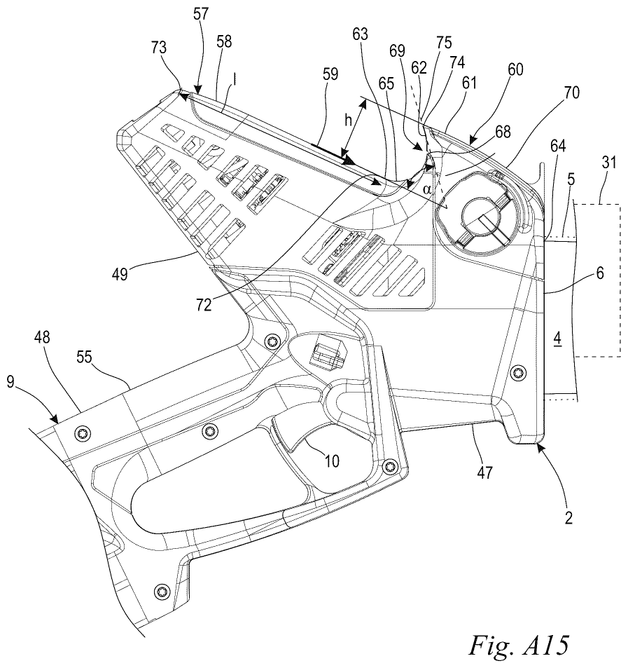

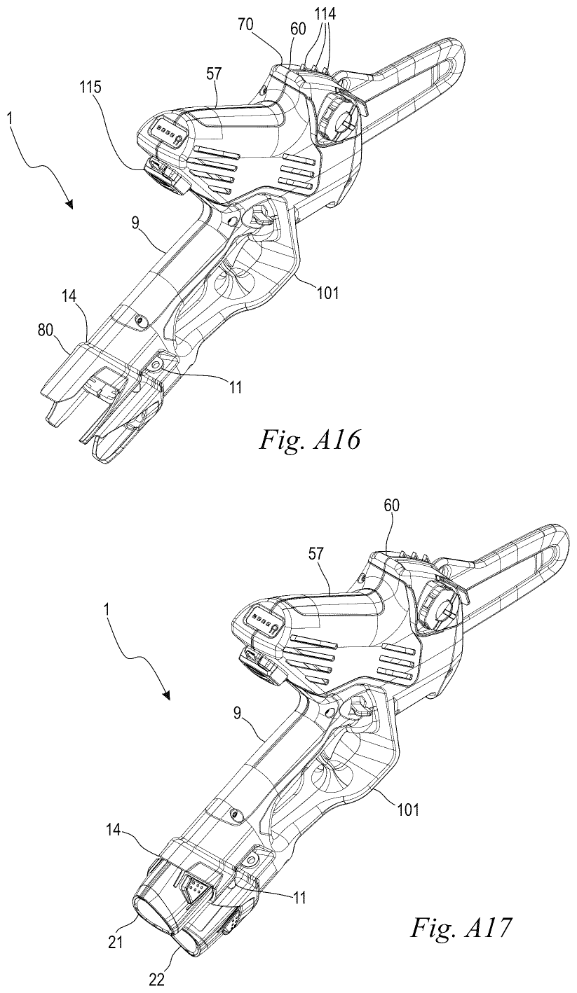

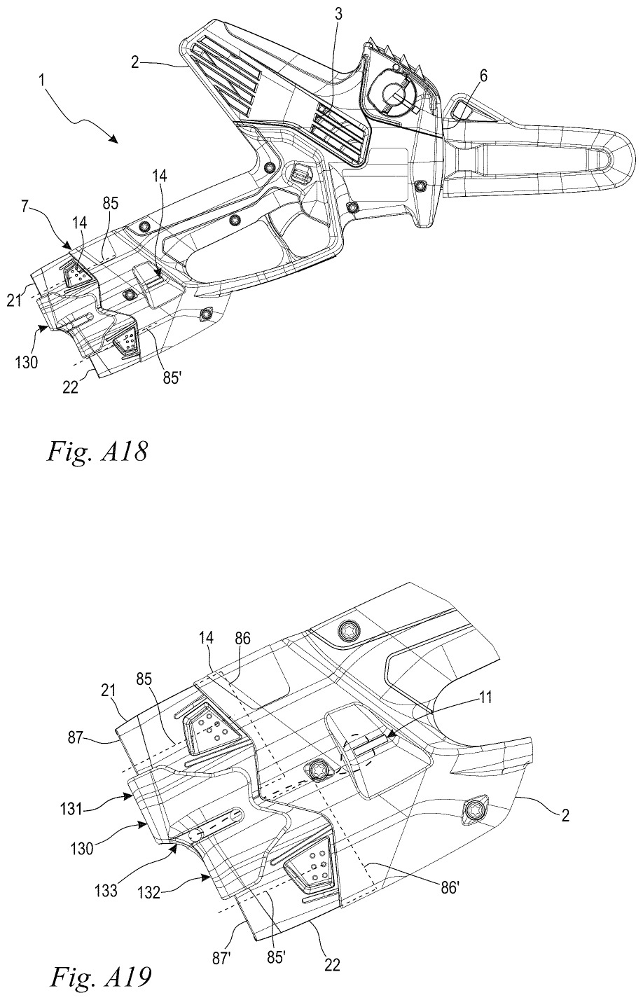

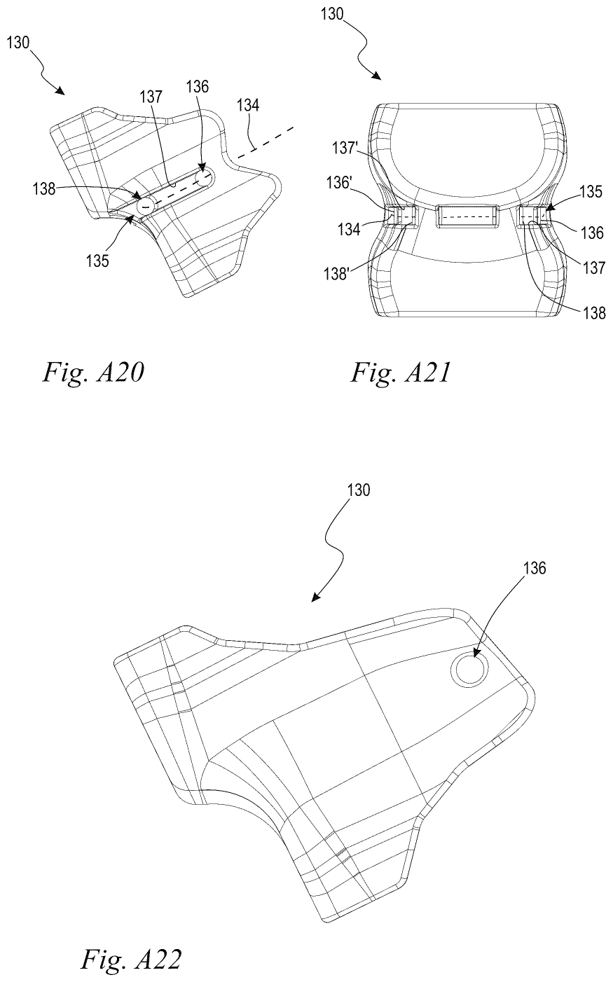

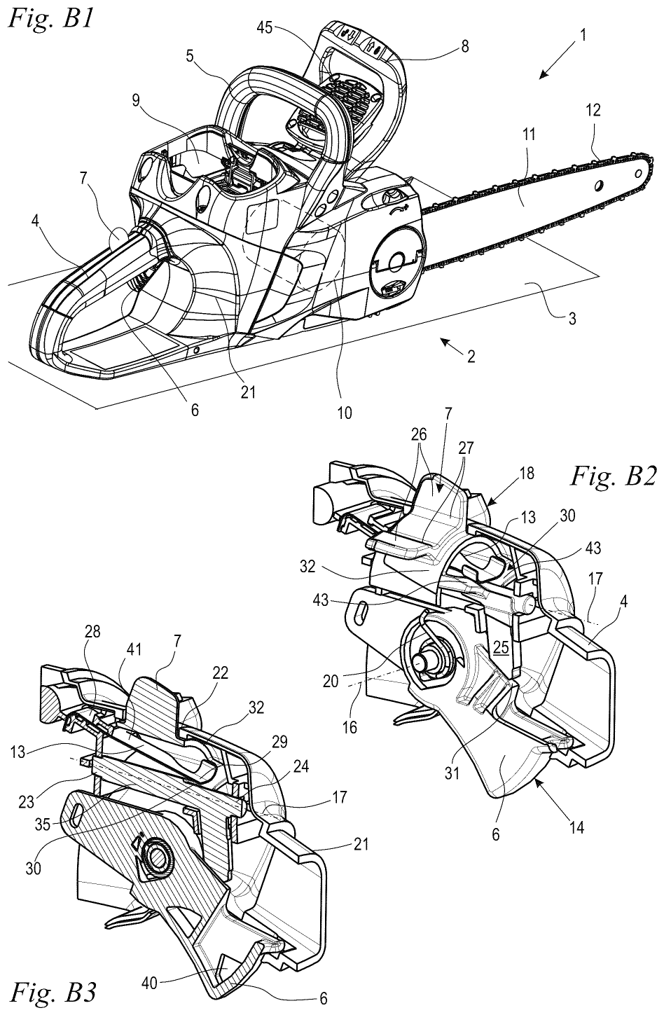

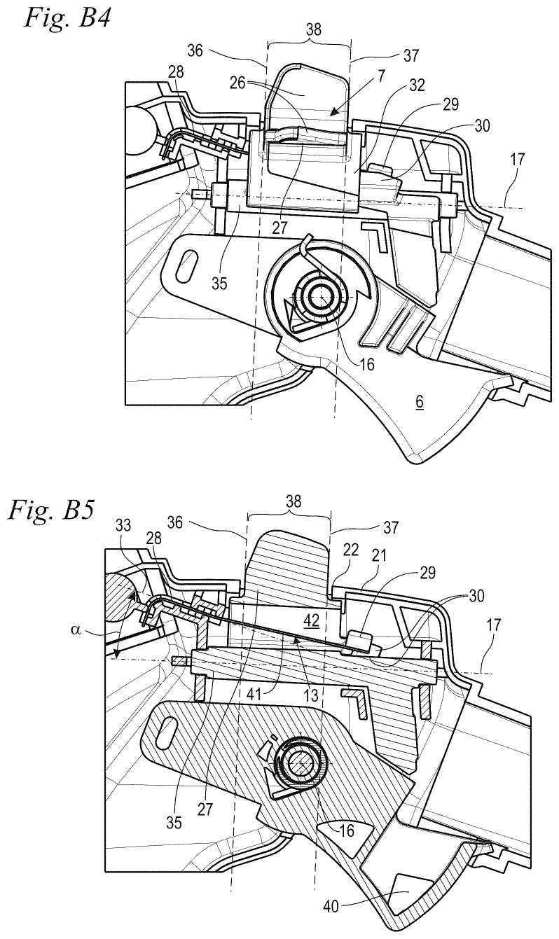

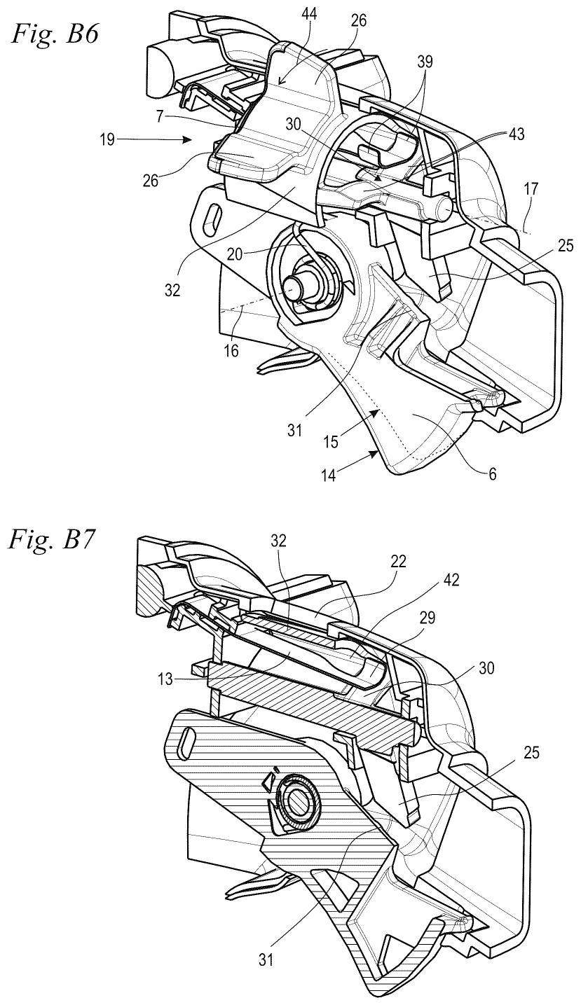

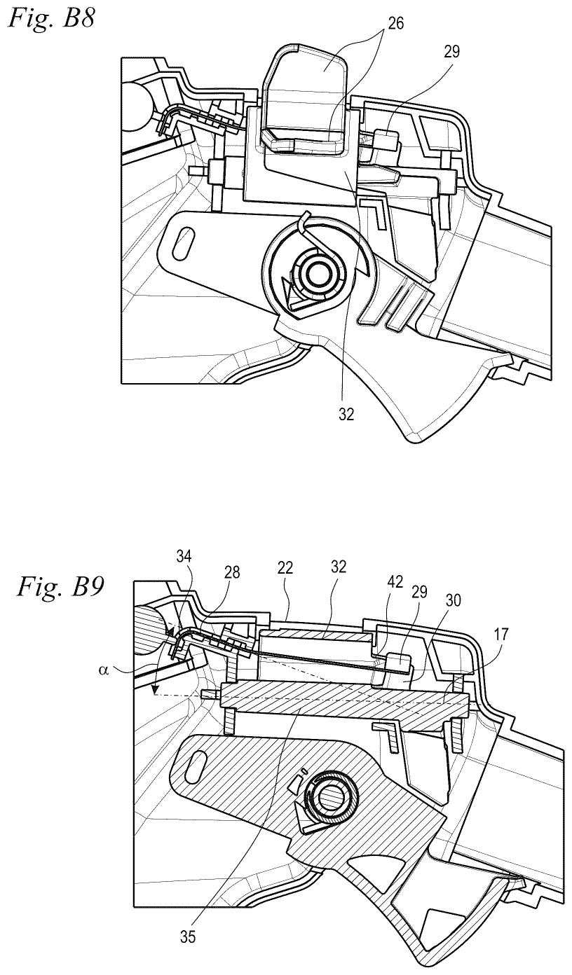

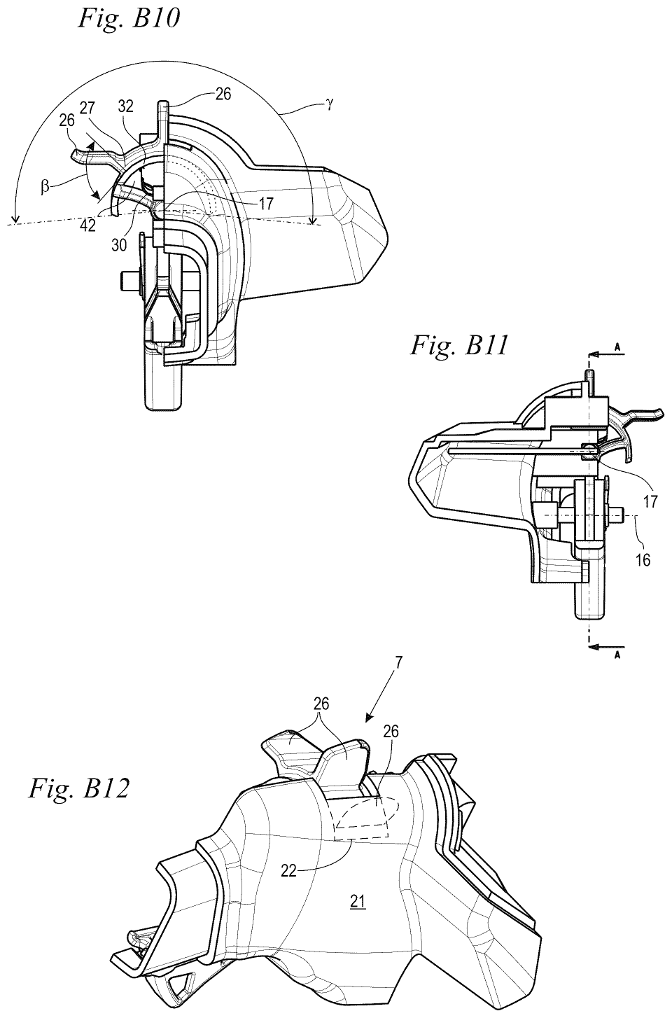

### CROSS-REFERENCE TO RELATED APPLICATION

This application is a national stage application, filed under 35 U.S.C. § 371, of International Patent Application PCT/DE2023/100659, filed on Sep. 6, 2023, which claims the benefit of German Patent Applications DE 10 2022 123 062.7, filed on Sep. 9, 2022; DE 10 2022 123 060.0, filed on Sep. 9, 2022; DE 10 2022 123 061.9, filed on Sep. 9, 2022; DE 10 2022 123 059.7, filed on Sep. 9, 2022; DE 10 2022 123 058.9, filed on Sep. 9, 2022; and DE 10 2022 123 203.4, filed on Sep. 12, 2022.

### TECHNICAL FIELD

The disclosure relates to a pruner, or wood cutter.

### BACKGROUND

Commercially available pruners comprise a housing and a drive motor arranged in the housing, wherein the drive motor drives a saw chain on a guide bar in a rotary motion.

### SUMMARY

The present application presents a particularly ergonomic pruner.

The pruner comprises a housing and a drive motor, wherein the drive motor drives a saw chain, which is guided in a guide groove of a guide bar, in a rotary motion via a drive chain sprocket, the guide bar being arranged on a front end of the housing and having a longitudinal plane spanned by the guide groove, wherein a fastening section is provided on a rear end of the housing for receiving a first rechargeable battery pack for supplying the drive motor with electrical energy, wherein the housing comprises a first handle on which a hand of the operator can rest, wherein in particular the first handle is assigned an actuating element for actuating the drive motor, wherein the fastening section is provided for receiving a second rechargeable battery pack, wherein the fastening section is arranged on the housing, in particular at least on the first handle, in such a way that a center of gravity of the pruner lies in the first handle when the pruner is in a state in which the first rechargeable battery pack and the second rechargeable battery pack are arranged on the fastening section.

The center of gravity of the pruner lies in the first handle of the pruner, whereby the user grips the pruner in the center of gravity. This reduces gravity-induced tilting moments that act around the handle and would have to be corrected by the operator. Consequently, the operator can easily hold and guide the pruner.

It is preferentially provided that the guide bar has a longitudinal center axis and a transverse plane that is aligned orthogonal to the longitudinal plane. The longitudinal center axis lies preferentially in the longitudinal plane and in the transverse plane. Preferably, the transverse plane divides the pruner into an upper section comprising the drive motor and into a lower section. The center of gravity of the pruner preferably lies in the lower section of the pruner. As a result, the pruner has a particularly low center of gravity and can be easily guided by the operator.

The fastening section for the rechargeable battery packs of the housing preferentially lies in the lower section of the pruner. Therefore, the rechargeable battery packs also lie in the lower section of the pruner when they have been inserted into the fastening section. As a result, the center of gravity can be shifted further into the lower section.

The drive motor preferably has a rotational axis, wherein the rotational axis runs parallel to the longitudinal plane of the guide bar or lies in the longitudinal plane of the guide bar. As a result, the pruner can have a slim structural design.

It is preferably provided that the fastening section is designed in such a way that the rechargeable battery packs can be inserted into the fastening section in an insertion direction. Advantageously, the insertion direction substantially corresponds to the longitudinal direction of the first handle. When inserting the rechargeable battery packs, the operator can hold the pruner with one hand and use their other hand to slide the rechargeable battery packs into the fastening section or pull them out. Since, preferably, the insertion direction and the longitudinal direction of the handle substantially correspond, the operator can easily apply the counterforce needed to slide in or pull out the rechargeable battery packs.

Preferably, the fastening section is designed in such a way that when the pruner is in a state in which the first rechargeable battery pack and the second rechargeable battery pack are inserted, a distance, measured in the direction of the longitudinal center axis, between a center of gravity of the first rechargeable battery pack and the center of gravity of the pruner is greater than a distance, measured in the longitudinal direction, between a center of gravity of the second rechargeable battery pack and the center of gravity of the pruner. Therefore, the rechargeable battery packs are arranged offset from each other in the direction of the longitudinal center axis. In other words, the distance between the first rechargeable battery pack and the center of gravity of the pruner differs from distance between the second rechargeable battery pack and the center of gravity of the pruner.

It is advantageously provided that the fastening section is designed in such a way that when the pruner is in a state in which the first rechargeable battery pack and the second rechargeable battery pack are inserted, a distance, measured perpendicularly to the transverse plane, between the center of gravity of the first rechargeable battery pack and the center of gravity of the pruner is smaller than a distance, measured perpendicularly to the transverse plane, between the center of gravity of the second rechargeable battery pack and the center of gravity of the pruner. Therefore, the rechargeable battery packs are arranged offset from each other in terms of “height”, i.e. in the direction perpendicular to the transverse plane.

Particularly preferably, the actuating element is arranged on the first handle. Preferably, the actuating element is designed as a lever that can pivot about a first pivot axis, wherein the actuating element has an outer contour with a maximum first radius with respect to the first pivot axis, wherein the first radius is greater than the distance between the center of gravity of the pruner and the first pivot axis. Preferably, the distance between the actuating element and the center of gravity of the pruner is not greater than 3 cm, preferentially not greater than 2 cm. Thus, the center of gravity of the pruner lies particularly close to the actuating element. The actuating element is actuated during normal operation of the pruner by means of the operator's index finger. Therefore, the operator grasps the handle with their index finger close to the center of gravity of the pruner. By clasping the center of gravity of the pruner with the thumb and the index finger, the operator is able to handle the pruner particularly ergonomically.

Preferably, the housing has a longitudinal midplane running parallel to the longitudinal plane, wherein the longitudinal midplane bisects the housing, wherein the center of gravity of the pruner lies almost in the longitudinal midplane, particularly preferably in the longitudinal midplane of the housing. Therefore, no lateral tilting moments arise that the operator would have to correct.

It is provided preferentially that the housing comprises a second handle on which the operator's other hand can rest, and wherein the center of gravity of the pruner is designed to be between the second handle and the actuating element assigned to the first handle. Preferably, the center of gravity of the pruner is designed to be between the second handle and the actuating element in relation to a direction perpendicular to the transverse plane of the guide bar.

Particularly preferably, the pruner has a fastener. The fastener preferably has at least one first fastening element for holding the pruner on the first fastening element. The fastener is arranged in particular on the handle housing. The operator can fasten the pruner to a carrying device or similar via the fastener. The pruner can be fastened via the at least one first fastening element, for example, to a cord, which is hung at the other end, for example, on a carrying device of the operator. If the operator accidentally drops the pruner, the latter can be held via the cord. Preferably, the first fastening element is designed as an eyelet.

The fastener preferably has a second fastening element for holding the pruner on the second fastening element. The second fastening element can be used analogously to the first fastening element. The second fastening element is designed in particular as an eyelet.

It is advantageously provided that the housing has a first longitudinal outer side and a second longitudinal outer side. The longitudinal outer sides are arranged opposite each other with respect to a plane that is aligned parallel to the longitudinal plane of the guide bar. The first fastening element is preferably arranged on the first longitudinal outer side. The second fastening element is preferably arranged on the second longitudinal outer side.

It is provided preferentially that the fastener is arranged in the fastening section of the housing. The fastening section is in particular part of the handle housing. Thus, the fastener lies more at the rear end of the pruner, whereby the pruner hangs from the fastener with the guide bar aligned towards the ground.

The fastener is preferably arranged in a transverse direction between the first rechargeable battery pack and the second rechargeable battery pack when the pruner is in a state in which the first rechargeable battery pack and the second rechargeable battery pack are inserted.

The fastener preferably comprises a base body. Preferentially, the fastener, in particular the base body of the fastener, is made as a single part. The base body is preferably flat. Due to the single-part design of the fastener, high forces can preferably be transmitted to the housing. On the other hand, the fastener therefore has a simple construction and can be produced cost-effectively.

Preferably, the housing comprises a first housing half and a second housing half, wherein the fastener is held between the first housing half and the second housing half, in particular in a form-fitting manner. Therefore, simple assembly of the pruner with regard to the fastener is possible.

It is advantageously provided that the base body extends in a longitudinal direction, wherein a fastening element is formed on at least one of the longitudinal ends of the base body. Particularly preferably, a fastening element is formed in each case on the longitudinal ends of the base body. Advantageously, the first housing half and the second housing half are connected to each another via a mechanical connection, adjacent to the fastener. The mechanical connection is preferably a screw connection. In an alternative configuration of the pruner, it may also be expedient to provide other mechanical connections, for example snap connections, rivet connections or similar. As a result, the forces transmitted from the fastener to the housing halves can be supported by the mechanical connection, in particular by the screw connection. Thus, the fastener can withstand high loads.

It is particularly preferably provided that the fastener is arranged between the center of gravity of the pruner and the rear end of the housing. Preferably, the fastener is arranged in relation to a longitudinal direction of the first handle between the center of gravity of the pruner and the rear end of the housing. If the pruner is hanging from its fastener, the pruner will be aligned owing to gravity in such a way that the center of gravity of the pruner lies below the fastener. This also means that the guide bar, which is arranged on the front end of the housing, is aligned towards the ground. On the one hand, this alignment of the pruner allows the operator to easily grip the first handle of the pruner from above. If the operator wishes to pick up the pruner for work again, they do not need to adjust the grip of their hands on the pruner. On the other hand, it is advantageous, in particular when pruning trees, that the pruner which is hanging from the fastener aligns itself with the guide bar pointing in the direction of the ground. If the operator pulls the pruner up towards them, there is less chance that pruner will get caught on the tree's branches with its saw chain.

It is advantageously provided that the first handle comprises a first handle section on which a hand of the operator can rest, wherein the handle section has a top side and a bottom side facing away from the top side. The housing preferably comprises a cover clip. The cover clip preferably extends from its first end up to its second end along the bottom side of the first handle section. Particularly preferably, the cover clip extends substantially parallel to the bottom side of the first handle section. The cover clip preferably has a taper in the direction of its second end. The operator can fasten the pruner at the taper to, for example, a carrying device of the operator, for example via a carabiner or another fastening means.

The first end of the cover clip is preferably adjacent to a motor housing of the housing and/or to a central housing of the housing.

The cover clip preferably has a maximum width measured perpendicular to the longitudinal plane spanned by the guide groove of the guide bar. The longitudinal plane preferably lies exactly in the center in the guide groove of the guide bar. The cover clip has a minimum width, in particular at its taper, measured perpendicularly to the longitudinal plane spanned by the guide groove of the guide bar. The minimum width at the taper corresponds to in particular at most 70%, preferably at most 60%, advantageously approximately 50% of the maximum width of the cover clip. Particularly preferably, the minimum width of the cover clip at the taper corresponds to at least 10%, preferably at least 20%, particularly preferably at least 30%, preferentially at least 40% of the maximum width of the cover clip. Due to this configuration of the cover clip, the cover clip is slim enough at its taper for the taper to be surrounded by a fastening means. Nevertheless, the cross-section of the cover clip is still sufficiently large at its taper to reinforce the housing.

It is advantageously provided that a lockout lever for locking and releasing the actuating element is provided. The lockout lever preferably has an outer contour which extends over a width perpendicular to the longitudinal plane of the guide bar, the width being in particular less than the maximum width of the cover clip. Particularly preferably, the cover clip extends from a first longitudinal side up to a second longitudinal side. Preferably, the outer contour of the lockout lever is arranged in the direction perpendicular to the longitudinal plane of the guide bar completely between the first longitudinal side and the second longitudinal side of the cover clip, at least in the region of the first end of the cover clip. The actuating element is preferably arranged between the first handle section and the cover clip. Thus, at least part of the actuating element lies behind the cover clip.

It is advantageously provided that the cover clip has a top side facing the bottom side of the first handle section. Preferably, the housing comprises a bridge, the bridge extending from the top side of the cover clip up to the bottom side of the handle section. The bridge has a reinforcing effect on the housing of the pruner. The actuating element is preferably arranged between the bridge and the first end of the cover clip. The taper of the cover clip is preferably arranged between the bridge and the second end of the cover clip. The second end of the cover clip leads into the fastening section of the housing.

It is advantageously provided that a protective device for protecting the rechargeable battery packs is provided on the fastening section, wherein the rechargeable battery packs each extend in their longitudinal direction from a first end face up to a second end face, wherein the first end face of the rechargeable battery packs faces the fastener and the second end face of the rechargeable battery packs faces away from the fastener, wherein the protective device comprises at least one first cover element, the first cover element extending in the longitudinal direction of the first rechargeable battery pack at least up to the second end face of the first rechargeable battery pack. The first cover element protects the first rechargeable battery pack from impact loads, for example if the pruner falls onto the ground. Damage to the first rechargeable battery pack can thus be prevented.

The protective device comprises at least one second cover element. The second cover element preferably extends in the longitudinal direction of the second rechargeable battery pack, at least up to the second end face of the second rechargeable battery pack. Thus, the second cover element protects the second rechargeable battery pack from impact loads, for example if the pruner falls onto the ground. Damage to the second rechargeable battery pack can thus be prevented.

It is advantageously provided that the rechargeable battery packs are each slid in their longitudinal direction into the fastener. Particularly preferably, the rechargeable battery packs are slid into the fastener, wherein the first rechargeable battery pack and the second rechargeable battery pack each have a longitudinal axis running in the longitudinal direction of the respective rechargeable battery pack. The longitudinal axes of the rechargeable battery packs are in particular aligned parallel to the longitudinal midplane of the housing. The longitudinal axes of the rechargeable battery packs can preferably also run at an angle to each other. The longitudinal axes of the rechargeable battery packs lie particularly preferably in the longitudinal midplane the housing. In a transverse direction, the rechargeable battery packs are preferably arranged one above the other. The transverse direction is advantageously aligned perpendicular to the longitudinal direction of the first rechargeable battery pack and/or to the longitudinal direction of the second rechargeable battery pack. The transverse direction preferably lies in a plane that is aligned parallel to the longitudinal midplane of the housing. Therefore, in a plan view of the pruner, the rechargeable battery packs lie one above the other, thereby enabling a particularly slim structural design of the pruner.

It is advantageously provided that the rechargeable battery packs are arranged offset from one another in their longitudinal direction, and that the second end faces of the rechargeable battery packs lie in different planes. Therefore, the rechargeable battery packs are arranged offset from one another in the longitudinal direction. Preferably, the rechargeable battery packs are arranged at least overlapping one another in the longitudinal direction. Preferably, the planes of the end faces of the first rechargeable battery pack and of the second rechargeable battery pack run parallel to each other.

Advantageously, the protective device comprises at least one third cover element. Preferably, the protective device comprises at least one fourth cover element. The third cover element preferably extends in the longitudinal direction of the rechargeable battery packs, at least up to the second end face of the rechargeable battery packs. The fourth cover element preferably extends in the longitudinal direction of the rechargeable battery packs, at least up to the second end face of the rechargeable battery packs. Particularly advantageously, the third cover element and the fourth cover element extend in the longitudinal direction of the rechargeable battery packs at least up to the second end face of the rechargeable battery packs. As a result, once inserted, the rechargeable battery packs are also protected from impact loads by the third cover element and by the fourth cover element.

Preferably, the rechargeable battery packs each have a substantially triangular cross-sectional contour with rounded corners. The rechargeable battery packs are preferably of identical construction. The rechargeable battery packs preferably each have a back wall formed between two rounded corners. The rechargeable battery packs are arranged in the fastening section in relation to each other in such a way that the back walls of the rechargeable battery packs lie opposite one another. Viewed in the direction of the longitudinal axes of the rechargeable battery packs and/or the direction in which the rechargeable battery packs are inserted, a contour encompassing the rechargeable battery packs has a diamond-shaped geometry. Due to this arrangement, the power tool has a slim structural design at its rear end. Advantageously, in this case, the first cover element is arranged on a rounded corner of the first rechargeable battery pack that faces away from the second rechargeable battery pack. The second cover element is preferably arranged on a rounded corner of the second rechargeable battery pack that faces away from the first rechargeable battery pack. As a result, the first cover element and the second cover element at least partially encompass the rechargeable battery packs together, whereby the first cover element also provides increased robustness for the second rechargeable battery pack and the second cover element also provides increased robustness for the first rechargeable battery pack.

Particularly preferably, the third cover element and the fourth cover element are arranged in a transverse direction between the rechargeable battery packs. The third cover element and the fourth cover element are designed to be opposite one another in relation to a plane aligned parallel to the longitudinal plane of the guide bar. The third cover element and the fourth cover element thus offer lateral protection for the rechargeable battery packs.

The protective device preferably has cutouts between the cover elements for gripping the rechargeable battery packs. The operator can consequently reach into the cutouts and pull the rechargeable battery packs out of the fastening section. The locking elements of the rechargeable battery packs are preferably arranged in the cutouts, so that the user can actuate the unlocking and subsequently remove the rechargeable battery from the appliance.

It is preferably provided that movement gaps are provided between the cover elements and the rechargeable battery packs. Preferably, the movement gaps taper in the direction of the first end face of the rechargeable battery packs. If one of the cover elements is subjected to an impact load, the latter deforms elastically, whereby the impact energy is mostly dissipated by the deformation of the cover element, thereby avoiding damage to the rechargeable battery pack.

The third cover element and/or the fourth cover element preferably have an outer face facing away from the rechargeable battery packs, wherein the outer face has a concave curvature that projects between the rechargeable battery packs. As a result, the third cover element and/or fourth cover element run close to the outer contour the rechargeable battery pack, thereby improving the protection for the rechargeable battery packs.

It is advantageously provided that the housing comprises a second handle with a second handle section on which the operator's other hand can rest, wherein a limiting device is provided between the second handle section and the guide bar, wherein the limiting device has an elevation, extending at least within the longitudinal plane, with respect to the second handle section, wherein the elevation is designed in such a way that the hand is prevented from slipping off the second handle section in the direction of the guide bar. This ensures that the operator of the pruner has a firm hold on the second handle of the pruner with their other hand. As a result, the operator can guide the pruner precisely and also perform precision work on the wood.

Preferably, the elevation is designed in such a way that the elevation forms a form-fitting stop in the direction of the guide bar for a hand of the operator resting on the second handle section. This can be advantageous in particular when using the power tool to cut branches. While the main load is supported on the first handle by the operator's hand, force can also be exerted via the form-fitting stop by the operator's other hand, in particular when cutting branches.

In the viewing direction perpendicular to the longitudinal plane, the limiting device preferably has an outer contour. The outer contour of the limiting device has in particular a first end adjoining the second handle section and a second end adjacent to the guide bar. Particularly preferably, the elevation of the limiting device is formed on the first end of the outer contour. Therefore, the elevation is directly adjacent to the second handle section of the second handle. By forming the elevation directly adjacent to the second handle section, the operator can place the palm of their other hand on the second handle section of the pruner and at the same time rest the side of the hand, i.e. the side of the little finger, against the elevation. The other hand thus sits firmly on the second handle of the pruner.

It is advantageously provided that the elevation has a concave contact section adjacent to the second handle section. The contact section forms an undercut for an operator's hand resting on the contact section. Therefore, when the operator's other hand rests on the second handle, it is securely molded to the undercut of the handle.

It is in particular provided that in the viewing direction perpendicular to the longitudinal plane, the elevation has a height measured perpendicular to the second handle section at the first end of the outer contour, wherein the height corresponds to at least 15%, in particular at least 20%, preferably approximately 25% of a length, measured in the longitudinal direction of the second handle, of the second handle section. Preferably, the housing comprises a lubricant tank for supplying the saw chain with lubricant, wherein the limiting device at least partially encompasses the lubricant tank.

Particularly preferably, the housing is open towards the top in the region of the second handle section. It is easier for the operator to grip and release the second handle section.

Preferably, the contact section is provided with an anti-slip coating. As a result, the operator has an improved hold on the pruner on the second handle section, whereby the operator can use the pruner for precision work.

The disclosure is furthermore based on the object of specifying a pruner that makes simple handling of the pruner possible.

This object is solved by a pruner which comprises a housing and a drive motor, wherein a fastening section is provided on a rear end of the housing for receiving a first rechargeable battery pack for supplying the drive motor with electrical energy, wherein the housing comprises a handle housing with a first handle on which a hand of the operator can rest, wherein the first handle is assigned an actuating element for actuating the drive motor, wherein the pruner has a fastener, wherein the fastener has at least one first fastening element for holding the pruner on the first fastening element, and wherein the fastener is arranged on the handle housing.

The operator can fasten the pruner to a carrying device or similar via the fastener. The pruner can be fastened via the at least one first fastening element, for example, to a cord, which is hung at the other end, for example, on a carrying device of the operator. If the operator accidentally drops the pruner, the latter can be held via the cord. Preferably, the first fastening element is designed as an eyelet.

The fastener preferably has a second fastening element for holding the pruner on the second fastening element. The second fastening element can be used analogously to the first fastening element. The second fastening element is designed in particular as an eyelet.

It is advantageously provided that the pruner has a guide bar with a guide groove and a saw chain that rotates in the guide groove, wherein the guide bar has a longitudinal plane spanned by the guide groove, and wherein the housing has a first longitudinal outer side and a second longitudinal outer side. The longitudinal outer sides are preferably arranged opposite each other with respect to a plane that is aligned parallel to the longitudinal plane of the guide bar. The first fastening element is preferably arranged on the first longitudinal outer side. The second fastening element is preferably arranged on the second longitudinal outer side.

It is preferably provided that the fastener is arranged in the fastening section of the housing. The fastening section is in particular part of the handle housing. Thus, the fastener lies more at the rear end of the pruner, whereby the pruner hangs from the fastener with the guide bar aligned towards the ground.

The fastening section is preferably provided for receiving a second rechargeable battery pack. The fastener is preferably arranged in a transverse direction between the first rechargeable battery pack and the second rechargeable battery pack when the pruner is in a state in which the first rechargeable battery pack and the second rechargeable battery pack are inserted.

The fastener preferably comprises a base body. Preferably, the fastener, in particular the base body of the fastener, is made as a single part. The base body is preferably flat. Due to the single-part design of the fastener, high forces can preferably be transmitted to the housing. On the other hand, the fastener therefore has a simple construction and can be produced cost-effectively.

Preferably, the housing comprises a first housing half and a second housing half, wherein the fastener is held between the first housing half and the second housing half, in particular in a form-fitting manner. As a result, simple assembly of the pruner with regard to the fastener is possible.

It is advantageously provided that the base body extends in a longitudinal direction, wherein a fastening element is formed on at least one of the longitudinal ends of the base body. Particularly preferably, a fastening element is formed in each case on the longitudinal ends of the base body. Advantageously, the first housing half and the second housing half are connected to each other via a mechanical connection adjacent to the fastener. The mechanical connection is preferably a screw connection. In an alternative configuration of the pruner, it may also be expedient to provide other mechanical connections, for example snap connections, rivet connections or similar. As a result, the forces transmitted from the fastener to the housing halves can be supported by the mechanical connection, in particular by the screw connection. Thus, the fastener can withstand high loads.

Preferably, the pruner has a center of gravity when the pruner is in a state in which the first rechargeable battery pack and the second rechargeable battery pack are inserted. It is particularly preferably provided that the fastener is arranged between the center of gravity of the pruner and the rear end of the housing. Preferably, the fastener is arranged in relation to a longitudinal direction of the first handle between the center of gravity of the pruner and the rear end of the housing. If the pruner is hanging from its fastener, the pruner will be aligned owing to gravity in such a way that the center of gravity of the pruner lies below the fastener. This also means that the guide bar, which is arranged on the front end of the housing, is aligned towards the ground. On the one hand, this alignment of the pruner allows the operator to easily grip the first handle of the pruner from above. If the operator wishes to pick up the pruner for work again, they do not need to adjust the grip of their hands on the pruner. On the other hand, it is advantageous, in particular when pruning trees, that the pruner which is hanging from the fastener aligns itself with the guide bar pointing in the direction of the ground. If the operator pulls the pruner up towards them, there is less chance that pruner will get caught on the tree's branches with its saw chain.

The guide bar is arranged in particular on a front end of the housing. Particularly preferably, the fastening section is arranged on the housing, in particular at least on the first handle, in such a way that a center of gravity of the pruner lies in the first handle when the pruner is in a state in which the first rechargeable battery pack and the second rechargeable battery pack are arranged on the fastening section.

The center of gravity of the pruner lies in the first handle of the pruner, whereby the user grips the pruner in the center of gravity. This reduces gravity-induced tilting moments that act around the handle and would have to be corrected by the operator. Consequently, the operator can easily hold and guide the pruner.

It is preferably provided that the guide bar has a longitudinal center axis and a transverse plane aligned orthogonal to the longitudinal plane. The longitudinal center axis lies preferentially in the longitudinal plane and in the transverse plane. Preferably, the transverse plane divides the pruner into an upper section comprising the drive motor and into a lower section. The center of gravity of the pruner preferably lies in the lower section of the pruner. As a result, the pruner has a particularly low center of gravity and can be easily guided by the operator.

The fastening section for the rechargeable battery packs of the housing preferentially lies in the lower section of the pruner. Therefore, the rechargeable battery packs also lie in the lower section of the pruner when they have been inserted into the fastening section. As a result, the center of gravity can be shifted further into the lower section.

The drive motor preferably has a rotational axis, wherein the rotational axis runs parallel to the longitudinal plane of the guide bar or lies in the longitudinal plane of the guide bar. As a result, the pruner can have a slim structural design.

It is preferably provided that the fastening section is designed in such a way that the rechargeable battery packs can be inserted into the fastening section in an insertion direction. Advantageously, the insertion direction substantially corresponds to the longitudinal direction of the first handle. When inserting the rechargeable battery packs, the operator can hold the pruner with one hand and use their other hand to slide the rechargeable battery packs into the fastening section or pull them out. Since, preferably, the insertion direction and the longitudinal direction of the handle substantially correspond, the operator can easily apply the counterforce needed to slide in or pull out the rechargeable battery packs.

Preferably, the fastening section is designed in such a way that when the pruner is in a state in which the first rechargeable battery pack and the second rechargeable battery pack are inserted, a distance, measured in the direction of the longitudinal center axis, between a center of gravity of the first rechargeable battery pack and the center of gravity of the pruner is greater than a distance, measured in the longitudinal direction, between a center of gravity of the second rechargeable battery pack and the center of gravity of the pruner. Therefore, the rechargeable battery packs are arranged offset from each other in the direction of the longitudinal center axis. In other words, the distance between the first rechargeable battery pack and the center of gravity of the pruner differs from the distance between the second rechargeable battery pack and the center of gravity of the pruner.

It is advantageously provided that the fastening section is designed in such a way that when the pruner is in a state in which the first rechargeable battery pack and the second rechargeable battery pack are inserted, a distance, measured perpendicularly to the transverse plane, between the center of gravity of the first rechargeable battery pack and the center of gravity of the pruner is smaller than a distance, measured perpendicularly to the transverse, between the center of gravity of the second rechargeable battery pack and the center of gravity of the pruner. Therefore, the rechargeable battery packs are arranged offset from one another in terms of “height”, i.e. in the direction perpendicular to the transverse plane.

Particularly preferably, the actuating element is arranged on the first handle. Preferably, the actuating element is designed as a lever that can pivot about a first pivot axis, wherein the actuating element has an outer contour with a maximum first radius with respect to the first pivot axis, wherein the first radius is greater than the distance between the center of gravity of the pruner and the first pivot axis. Preferably, the distance between the actuating element and the center of gravity of the pruner is not greater than 3 cm, preferably not greater than 2 cm. Thus, the center of gravity of the pruner lies particularly close to the actuating element. The actuating element is actuated during normal operation of the pruner by means of the operator's index finger. Therefore, the operator grasps the handle with their index finger close to the center of gravity of the pruner. By clasping the center of gravity of the pruner with the thumb and the index finger, the operator is able to handle the pruner particularly ergonomically.

Preferably, the housing has a longitudinal midplane parallel to the longitudinal plane, wherein the longitudinal midplane bisects the housing, wherein the center of gravity of the pruner lies almost in the longitudinal midplane, particularly preferably in the longitudinal midplane of the housing. Therefore, no lateral tilting moments arise that the operator would have to correct.

It is preferably provided that the housing comprises a second handle on which the operator's other hand can rest, and wherein the center of gravity of the pruner is designed to be between the second handle and the actuating element assigned to the first handle. Preferably, the center of gravity of the pruner is designed to be between the second handle and the actuating element in relation to a direction perpendicular to the transverse plane of the guide bar.

It is advantageously provided that the first handle comprises a first handle section on which a hand of the operator can rest, wherein the handle section has a top side and a bottom side facing away from the top side. The housing preferably comprises a cover clip. The cover clip preferably extends from its first end to its second end along the bottom side of the first handle section. Particularly preferably, the cover clip extends substantially parallel to the bottom side of the first handle section. The cover clip preferably has a taper in the direction of its second end. The operator can fasten the pruner at the taper to, for example, a carrying device of the operator, for example via a carabiner or another fastening means.

The first end of the cover clip is preferably adjacent to a motor housing of the housing and/or to a central housing of the housing.

The cover clip preferably has a maximum width measured perpendicular to a longitudinal plane spanned by the guide groove of the guide bar. The longitudinal plane preferably lies exactly in the center in the guide groove of the guide bar. The cover clip has a minimum width, in particular at its taper, measured perpendicularly to the longitudinal plane spanned by the guide groove of the guide bar. In particular, the minimum width at the taper corresponds to in particular at most 70%, preferably at most 60%, advantageously approximately 50% of the maximum width of the cover clip. Particularly preferably, the minimum width of the cover clip at the taper corresponds to at least 10%, preferably at least 20%, particularly preferably at least 30%, preferentially at least 40% of the maximum width of the cover clip. Due to this configuration of the cover clip, the cover clip is slim enough at its taper for the taper to be surrounded by a fastening means. Nevertheless, the cross-section of the cover clip is still sufficiently large at its taper to reinforce the housing.

It is advantageously provided that a lockout lever for locking and releasing the actuating element is provided. The lockout lever preferably has an outer contour which extends over a width perpendicular to the longitudinal plane of the guide bar, the width being in particular less than the maximum width of the cover clip. Particularly preferably, the cover clip extends from a first longitudinal side up to a second longitudinal side. Preferably, the outer contour of the lockout lever is arranged in the direction perpendicular to the longitudinal plane of the guide bar completely between the first longitudinal side and the second longitudinal side of the cover clip, at least in the region of the first end of the cover clip. The actuating element is preferably arranged between the first handle section and the cover clip. Thus, at least part of the actuating element lies behind the cover clip.

It is advantageously provided that the cover clip has a top side facing the bottom side of the first handle section. Preferably, the housing comprises a bridge, the bridge extending from the top side of the cover clip up to the bottom side of the handle section. The bridge has a reinforcing effect on the housing of the pruner. The actuating element is preferably arranged between the bridge and the first end of the cover clip. The taper of the cover clip is preferably arranged between the bridge and the second end of the cover clip. The second end of the cover clip leads into the fastening section of the housing.

It is advantageously provided that a protective device for protecting the rechargeable battery packs is provided on the fastening section, wherein the rechargeable battery packs each extend in their longitudinal direction from a first end face up to a second end face, wherein the first end face of the rechargeable battery packs faces the fastener and the second end face of the rechargeable battery packs faces away from the fastener, wherein the protective device comprises at least one first cover element, the first cover element extending in the longitudinal direction of the first rechargeable battery pack at least up to the second end face of the first rechargeable battery pack. The first cover element protects the first rechargeable battery pack from impact loads, for example if the pruner falls onto the ground. Damage to the first rechargeable battery pack can thus be prevented.

The protective device comprises at least one second cover element. The second cover element preferably extends in the longitudinal direction of the second rechargeable battery pack, at least up to the second end face of the second rechargeable battery pack. Thus, the second cover element protects the second rechargeable battery pack from impact loads, for example if the pruner falls onto the ground. Damage to the second rechargeable battery pack can thus be prevented.

It is advantageously provided that the rechargeable battery packs are each slid in their longitudinal direction into the fastener. Particularly preferably, the rechargeable battery packs are slid into the fastener, wherein the first rechargeable battery pack and the second rechargeable battery pack each have a longitudinal axis running in the longitudinal direction of the respective rechargeable battery pack. The longitudinal axes of the rechargeable battery packs are in particular aligned parallel to the longitudinal midplane of the housing. The longitudinal axes of the rechargeable battery packs can preferably also run at an angle to each other. The longitudinal axes of the rechargeable battery packs lie particularly preferably in the longitudinal midplane the housing. In a transverse direction, the rechargeable battery packs are preferably arranged one above the other. The transverse direction is advantageously aligned perpendicular to the longitudinal direction of the first rechargeable battery pack and/or to the longitudinal direction of the second rechargeable battery pack. The transverse direction preferably lies in a plane that is aligned parallel to the longitudinal midplane of the housing. Therefore, in a plan view of the pruner, the rechargeable battery packs lie one above the other, thereby enabling a particularly slim structural design of the pruner.

It is advantageously provided that the rechargeable battery packs are arranged offset from one another in their longitudinal direction, and that the second end faces of the rechargeable battery packs lie in different planes. Therefore, the rechargeable battery packs are arranged offset from one another in the longitudinal direction. Preferably, the rechargeable battery packs are arranged at least overlapping one another in the longitudinal direction. Preferably, the planes of the end faces of the first rechargeable battery pack and of the second rechargeable battery pack run parallel to each other.

Advantageously, the protective device comprises at least one third cover element. Preferably, the protective device comprises at least one fourth cover element. The third cover element preferably extends in the longitudinal direction of the rechargeable battery packs, at least up to the second end face of the rechargeable battery packs. The fourth cover element preferably extends in the longitudinal direction of the rechargeable battery packs, at least up to the second end face of the rechargeable battery packs. Particularly advantageously, the third cover element and the fourth cover element extend in the longitudinal direction of the rechargeable battery packs at least up to the second end face of the rechargeable battery packs. As a result, once inserted, the rechargeable battery packs are also protected from impact loads by the third cover element and by the fourth cover element.

Preferably, the rechargeable battery packs each have a substantially triangular cross-sectional contour with rounded corners. The rechargeable battery packs are preferably of identical construction. The rechargeable battery packs preferably each have a back wall formed between two rounded corners. The rechargeable battery packs are arranged in the fastening section in relation to each other in such a way that the back walls of the rechargeable battery packs lie opposite one another. Viewed in the direction of the longitudinal axes of the rechargeable battery packs and/or the direction in which the rechargeable battery packs are inserted, a contour encompassing the rechargeable battery packs has a diamond-shaped geometry. Due to this arrangement, the power tool has a slim structural design at its rear end. Advantageously, in this case, the first cover element is arranged on a rounded corner of the first rechargeable battery pack that faces away from the second rechargeable battery pack. The second cover element is preferably arranged on a rounded corner of the second rechargeable battery pack that faces away from the first rechargeable battery pack. As a result, the first cover element and the second cover element at least partially encompass the rechargeable battery packs together, whereby the first cover element also provides increased robustness for the second rechargeable battery pack and the second cover element also provides increased robustness for the first rechargeable battery pack.

Particularly preferably, the third cover element and the fourth cover element are arranged in a transverse direction between the rechargeable battery packs. The third cover element and the fourth cover element are designed to be opposite one another in relation to a plane aligned parallel to the longitudinal plane of the guide bar. The third cover element and the fourth cover element thus offer lateral protection for the rechargeable battery packs.

The protective device preferably has cutouts between the cover elements for gripping the rechargeable battery packs. The operator can consequently reach into the cutouts and pull the rechargeable battery packs out of the fastening section. The locking elements of the rechargeable battery packs are preferably arranged in the cutouts, so that the user can actuate the unlocking and subsequently remove the rechargeable battery from the appliance.

It is preferably provided that movement gaps are provided between the cover elements and the rechargeable battery packs. Preferably, the movement gaps taper in the direction of the first end face of the rechargeable battery packs. If one of the cover elements is subjected to an impact load, the latter deforms elastically, whereby the impact energy is mostly dissipated by the deformation of the cover element, thereby avoiding damage to the rechargeable battery pack.

The third cover element and/or the fourth cover element preferably have an outer face facing away from the rechargeable battery packs, wherein the outer face has a concave curvature that projects between the rechargeable battery packs. As a result, the third cover element and/or fourth cover element run close to the outer contour the rechargeable battery pack, thereby improving the protection for the rechargeable battery packs.

It is advantageously provided that the housing comprises a second handle with a second handle section on which the operator's other hand can rest, wherein a limiting device is provided between the second handle section and the guide bar, wherein the limiting device has an elevation, extending at least within the longitudinal plane, with respect to the second handle section, wherein the elevation is designed in such a way that the hand is prevented from slipping off the second handle section in the direction of the guide bar. This ensures that the operator of the pruner has a firm hold on the second handle of the pruner with their other hand. As a result, the operator can guide the pruner precisely and also perform precision work on the wood.

Preferably, the elevation is designed in such a way that the elevation forms a form-fitting stop in the direction of the guide bar for a hand of the operator resting on the second handle section. This can be advantageous in particular when using the power tool to cut branches. While the main load is supported on the first handle by the operator's hand, force can also be exerted via the form-fitting stop by the operator's other hand, in particular when cutting branches.

In the viewing direction perpendicular to the longitudinal plane, the limiting device preferably has an outer contour. The outer contour of the limiting device has in particular a first end adjoining the second handle section and a second end adjacent to the guide bar. Particularly preferably, the elevation of the limiting device is formed on the first end of the outer contour. Therefore, the elevation is directly adjacent to the second handle section of the second handle. By forming the elevation directly adjacent to the second handle section, the operator can place the palm of their other hand on the second handle section of the pruner and at the same time rest the side of the hand, i.e. the side of the little finger, against the elevation. The other hand thus sits firmly on the second handle of the pruner.

It is advantageously provided that the elevation has a concave contact section adjacent to the second handle section. The contact section forms an undercut for an operator's hand resting on the contact section. Therefore, when the operator's other hand rests on the second handle, it is securely molded to the undercut of the handle.

It is in particular provided that in the viewing direction perpendicular to the longitudinal plane, the elevation has a height measured perpendicular to the second handle section at the first end of the outer contour, wherein the height corresponds to at least 15%, in particular at least 20%, preferably approximately 25% of a length, measured in the longitudinal direction of the second handle, of the second handle section.

Preferably, the housing comprises a lubricant tank for supplying the saw chain with lubricant, wherein the limiting device at least partially encompasses the lubricant tank.

Particularly preferably, the housing is open towards the top in the region of the second handle section. It is easier for the operator to grip and release the second handle section.

Preferably, the contact section is provided with an anti-slip coating. As a result, the operator has an improved hold on the pruner on the second handle section, whereby the operator can use the pruner for precision work.

The disclosure is also based on the object of specifying a robust pruner that is simple to handle when held.

This object is solved by a pruner which comprises a housing and a drive motor, wherein the housing comprises a first handle with a first handle section on which a hand of the operator can rest, wherein the first handle is assigned an actuating element for actuating the drive motor, and wherein the handle section has a top side and a bottom side facing away from the top side, wherein the housing comprises a cover clip, wherein the cover clip extends from its first end up to its second end along the bottom side of the first handle section. Particularly preferably, the cover clip extends substantially parallel to the bottom side of the first handle section. The cover clip has a taper in the direction of its second end. The operator can fasten the pruner at the taper to, for example, a carrying device of the operator, for example via a carabiner or another fastening means. At the same time, the cover clip acts as a reinforcement for the housing, whereby the housing is made robust.

The first end of the cover clip is preferably adjacent to a motor housing of the housing and/or to a central housing of the housing. Preferably, the pruner comprises a guide bar with a guide groove and a saw chain guided in the guide groove. The cover clip preferably has maximum width measured perpendicular to a longitudinal plane of the guide bar spanned by the guide groove of the guide bar. The longitudinal plane preferably lies exactly in the center in the guide groove of the guide bar. The cover clip has a minimum width, in particular at its taper, measured perpendicularly to the longitudinal plane spanned by the guide groove of the guide bar. The minimum width at the taper corresponds to in particular at most 70%, preferably at most 60%, advantageously approximately 50% of the maximum width of the cover clip. Particularly preferably, the minimum width of the cover clip at the taper corresponds to at least 10%, preferably at least 20%, particularly preferably at least 30%, preferentially at least 40% of the maximum width of the cover clip. Due to this configuration of the cover clip, the cover clip is slim enough at its taper for the taper to be surrounded by a fastening means. Nevertheless, the cross-section of the cover clip is still sufficiently large at its taper to reinforce the housing.

It is advantageously provided that a lockout lever for locking and releasing the actuating element is provided. The lockout lever preferably has an outer contour which extends over a width perpendicular to the longitudinal plane of the guide bar, the width being in particular less than the maximum width of the cover clip. Particularly preferably, the cover clip extends from a first longitudinal side up to a second longitudinal side. Preferably, the outer contour of the lockout lever is arranged in the direction perpendicular to the longitudinal plane of the guide bar completely between the first longitudinal side and the second longitudinal side of the cover clip, at least in the region of the first end of the cover clip. The actuating element is preferably arranged between the first handle section and the cover clip. Thus, at least part of the actuating element lies behind the cover clip.

It is advantageously provided that the cover clip has a top side facing the bottom side of the first handle section. Preferably, the housing comprises a bridge, the bridge extending from the top side of the cover clip up to the bottom side of the handle section. The bridge has a reinforcing effect on the housing of the pruner. The actuating element is preferably arranged between the bridge and the first end of the cover clip. The taper of the cover clip is preferably arranged between the bridge and the second end of the cover clip. The second end of the cover clip leads into the fastening section of the housing.

It is advantageously provided that a fastening section is provided on a rear end of the housing for receiving a first rechargeable battery pack for supplying the drive motor with electrical energy. Particularly advantageously, the fastening section is provided for receiving a second rechargeable battery pack. The second end of the cover clip is preferably formed by the fastening section of the housing.

Particularly preferably, the drive motor drives the saw chain, which is guided in the guide groove of the guide bar, in a rotary motion via a drive chain sprocket, the guide bar preferably being arranged on a front end of the housing arranged is, wherein the fastening section is arranged in particular on the housing, in particular at least on the first handle, in such a way that a center of gravity of the pruner lies in the first handle when the pruner is in a state in which the first rechargeable battery pack and the second rechargeable battery pack are arranged on the fastening section.

The center of gravity of the pruner preferably lies in the first handle of the pruner, whereby the user grips the pruner in the center of gravity. This reduces gravity-induced tilting moments that act around the handle and would have to be corrected by the operator. Consequently, the operator can easily hold and guide the pruner.

It is provided preferentially that the guide bar has a longitudinal center axis and a transverse plane that is aligned orthogonal to the longitudinal plane. The longitudinal center axis lies preferentially in the longitudinal plane and in the transverse plane. Preferably, the transverse plane divides the pruner into an upper section comprising the drive motor and into a lower section. The center of gravity of the pruner preferably lies in the lower section of the pruner. As a result, the pruner has a particularly low center of gravity and can be easily guided by the operator.

The fastening section for the rechargeable battery packs of the housing preferentially lies in the lower section of the pruner. Therefore, the rechargeable battery packs also lie in the lower section of the pruner when they have been inserted into the fastening section. As a result, the center of gravity can be shifted further into the lower section.

The drive motor preferably has a rotational axis, wherein the rotational axis runs parallel to the longitudinal plane of the guide bar or lies in the longitudinal plane of the guide bar. As a result, the pruner can have a slim structural design.

It is preferably provided that the fastening section is designed in such a way that the rechargeable battery packs can be inserted into the fastening section in an insertion direction. Advantageously, the insertion direction substantially corresponds to the longitudinal direction of the first handle. When inserting the rechargeable battery packs, the operator can hold the pruner with one hand and use their other hand to slide the rechargeable battery packs into the fastening section or pull them out. Since preferably the insertion direction and the longitudinal direction of the handle substantially correspond, the operator can easily apply the counterforce needed to slide in or pull out the rechargeable battery packs.

Preferably, the fastening section is designed in such a way that when the pruner is in a state in which the first rechargeable battery pack and the second rechargeable battery pack are inserted, a distance, measured in the direction of the longitudinal center axis, between a center of gravity of the first rechargeable battery pack and the center of gravity of the pruner is greater than a distance, measured in the longitudinal direction, between a center of gravity of the second rechargeable battery pack and the center of gravity of the pruner. Therefore, the rechargeable battery packs are arranged offset from each other in the direction of the longitudinal center axis. In other words, the distance between the first rechargeable battery pack and the center of gravity of the pruner differs from distance between the second rechargeable battery pack and the center of gravity of the pruner.

It is advantageously provided that the fastening section is designed in such a way that when the pruner is in a state in which the first rechargeable battery pack and the second rechargeable battery pack are inserted, a distance, measured perpendicularly to the transverse plane, between the center of gravity of the first rechargeable battery pack and the center of gravity of the pruner is smaller than a distance, measured perpendicularly to the transverse plane, between the center of gravity of the second rechargeable battery pack and the center of gravity of the pruner. Therefore, the rechargeable battery packs are arranged offset from each other in terms of “height”, i.e. in the direction perpendicular to the transverse plane.

Particularly preferably, the actuating element is arranged on the first handle. Preferably, the actuating element is designed as a lever that can pivot about a first pivot axis, wherein the actuating element has an outer contour with a maximum first radius with respect to the first pivot axis, wherein the first radius is greater than the distance between the center of gravity of the pruner and the first pivot axis. Preferably, the distance between the actuating element and the center of gravity of the pruner is not greater than 3 cm, preferentially not greater than 2 cm. Thus, the center of gravity of the pruner lies particularly close to the actuating element. The actuating element is actuated during normal operation of the pruner by means of the operator's index finger. Therefore, the operator grasps the handle with their index finger close to the center of gravity of the pruner. By clasping the center of gravity of the pruner with the thumb and the index finger, the operator is able to handle the pruner particularly ergonomically.

Preferably, the housing has a longitudinal midplane running parallel to the longitudinal plane, wherein the longitudinal midplane bisects the housing, wherein the center of gravity of the pruner lies almost in the longitudinal midplane, particularly preferably in the longitudinal midplane of the housing. Therefore, no lateral tilting moments arise that the operator would have to correct.

It is provided preferentially that the housing comprises a second handle on which the operator's other hand can rest, and wherein the center of gravity of the pruner is designed to be between the second handle and the actuating element assigned to the first handle. Preferably, the center of gravity of the pruner is designed to be between the second handle and the actuating element in relation to a direction perpendicular to the transverse plane of the guide bar.

Particularly preferably, the pruner has a fastener. The fastener preferably has at least one first fastening element for holding the pruner on the first fastening element. The fastener is arranged in particular on the handle housing. The operator can fasten the pruner to a carrying device or similar via the fastener. The pruner can be fastened via the at least one first fastening element, for example, to a cord, which is hung at the other end, for example, on a carrying device of the operator. If the operator accidentally drops the pruner, the latter can be held via the cord. Preferably, the first fastening element is designed as an eyelet.

The fastener preferably has a second fastening element for holding the pruner on the second fastening element. The second fastening element can be used analogously to the first fastening element. The second fastening element is designed in particular as an eyelet.

It is advantageously provided that the housing has a first longitudinal outer side and a second longitudinal outer side. The longitudinal outer sides are arranged opposite each other with respect to a plane that is aligned parallel to the longitudinal plane of the guide bar. The first fastening element is preferably arranged on the first longitudinal outer side. The second fastening element is preferably arranged on the second longitudinal outer side.

It is provided preferentially that the fastener is arranged in the fastening section of the housing. The fastening section is in particular part of the handle housing. Thus, the fastener lies more at the rear end of the pruner, whereby the pruner hangs from the fastener with the guide bar aligned towards the ground.

The fastener is preferably arranged in a transverse direction between the first rechargeable battery pack and the second rechargeable battery pack when the pruner is in a state in which the first rechargeable battery pack and the second rechargeable battery pack are inserted.

The fastener preferably comprises a base body. Preferentially, the fastener, in particular the base body of the fastener, is made as a single part. The base body is preferably flat. Due to the single-part design of the fastener, high forces can preferably be transmitted to the housing. On the other hand, the fastener therefore has a simple construction and can be produced cost-effectively.

Preferably, the housing comprises a first housing half and a second housing half, wherein the fastener is held between the first housing half and the second housing half, in particular in a form-fitting manner. Therefore, simple assembly of the pruner with regard to the fastener is possible.

It is advantageously provided that the base body extends in a longitudinal direction, wherein a fastening element is formed on at least one of the longitudinal ends of the base body. Particularly preferably, a fastening element is formed in each case on the longitudinal ends of the base body. Advantageously, the first housing half and the second housing half are connected to each another via a mechanical connection, adjacent to the fastener. The mechanical connection is preferably a screw connection. In an alternative configuration of the pruner, it may also be expedient to provide other mechanical connections, for example snap connections, rivet connections or similar. As a result, the forces transmitted from the fastener to the housing halves can be supported by the mechanical connection, in particular by the screw connection. Thus, the fastener can withstand high loads.

It is particularly preferably provided that the fastener is arranged between the center of gravity of the pruner and the rear end of the housing. Preferably, the fastener is arranged in relation to a longitudinal direction of the first handle between the center of gravity of the pruner and the rear end of the housing. If the pruner is hanging from its fastener, the pruner will be aligned owing to gravity in such a way that the center of gravity of the pruner lies below the fastener. This also means that the guide bar, which is arranged on the front end of the housing, is aligned towards the ground. On the one hand, this alignment of the pruner allows the operator to easily grip the first handle of the pruner from above. If the operator wishes to pick up the pruner for work again, they do not need to adjust the grip of their hands on the pruner. On the other hand, it is advantageous, in particular when pruning trees, that the pruner which is hanging from the fastener aligns itself with the guide bar pointing in the direction of the ground. If the operator pulls the pruner up towards them, there is less chance that pruner will get caught on the tree's branches with its saw chain.

It is advantageously provided that a protective device for protecting the rechargeable battery packs is provided on the fastening section, wherein the rechargeable battery packs each extend in their longitudinal direction from a first end face up to a second end face, wherein the first end face of the rechargeable battery packs faces the fastener and the second end face of the rechargeable battery packs faces away from the fastener, wherein the protective device comprises at least one first cover element, the first cover element extending in the longitudinal direction of the first rechargeable battery pack at least up to the second end face of the first rechargeable battery pack. The first cover element protects the first rechargeable battery pack from impact loads, for example if the pruner falls onto the ground. Damage to the first rechargeable battery pack can thus be prevented.

The protective device comprises at least one second cover element. The second cover element preferably extends in the longitudinal direction of the second rechargeable battery pack, at least up to the second end face of the second rechargeable battery pack. Thus, the second cover element protects the second rechargeable battery pack from impact loads, for example if the pruner falls onto the ground. Damage to the second rechargeable battery pack can thus be prevented.

It is advantageously provided that the rechargeable battery packs are each slid in their longitudinal direction into the fastener. Particularly preferably, the rechargeable battery packs are slid into the fastener, wherein the first rechargeable battery pack and the second rechargeable battery pack each have a longitudinal axis running in the longitudinal direction of the respective rechargeable battery pack. The longitudinal axes of the rechargeable battery packs are in particular aligned parallel to the longitudinal midplane of the housing. The longitudinal axes of the rechargeable battery packs can preferably also run at an angle to each other. The longitudinal axes of the rechargeable battery packs lie particularly preferably in the longitudinal midplane the housing. In a transverse direction, the rechargeable battery packs are preferably arranged one above the other. The transverse direction is advantageously aligned perpendicular to the longitudinal direction of the first rechargeable battery pack and/or to the longitudinal direction of the second rechargeable battery pack. The transverse direction preferably lies in a plane that is aligned parallel to the longitudinal midplane of the housing. Therefore, in a plan view of the pruner, the rechargeable battery packs lie one above the other, thereby enabling a particularly slim structural design of the pruner.

It is advantageously provided that the rechargeable battery packs are arranged offset from one another in their longitudinal direction, and that the second end faces of the rechargeable battery packs lie in different planes. Therefore, the rechargeable battery packs are arranged offset from one another in the longitudinal direction. Preferably, the rechargeable battery packs are arranged at least overlapping one another in the longitudinal direction. Preferably, the planes of the end faces of the first rechargeable battery pack and of the second rechargeable battery pack run parallel to each other.

Advantageously, the protective device comprises at least one third cover element. Preferably, the protective device comprises at least one fourth cover element. The third cover element preferably extends in the longitudinal direction of the rechargeable battery packs, at least up to the second end face of the rechargeable battery packs. The fourth cover element preferably extends in the longitudinal direction of the rechargeable battery packs, at least up to the second end face of the rechargeable battery packs. Particularly advantageously, the third cover element and the fourth cover element extend in the longitudinal direction of the rechargeable battery packs at least up to the second end face of the rechargeable battery packs. As a result, once inserted, the rechargeable battery packs are also protected from impact loads by the third cover element and by the fourth cover element.

Preferably, the rechargeable battery packs each have a substantially triangular cross-sectional contour with rounded corners. The rechargeable battery packs are preferably of identical construction. The rechargeable battery packs preferably each have a back wall formed between two rounded corners. The rechargeable battery packs are arranged in the fastening section in relation to each other in such a way that the back walls of the rechargeable battery packs lie opposite one another. Viewed in the direction of the longitudinal axes of the rechargeable battery packs and/or the direction in which the rechargeable battery packs are inserted, a contour encompassing the rechargeable battery packs has a diamond-shaped geometry. Due to this arrangement, the power tool has a slim structural design at its rear end. Advantageously, in this case, the first cover element is arranged on a rounded corner of the first rechargeable battery pack that faces away from the second rechargeable battery pack. The second cover element is preferably arranged on a rounded corner of the second rechargeable battery pack that faces away from the first rechargeable battery pack. As a result, the first cover element and the second cover element at least partially encompass the rechargeable battery packs together, whereby the first cover element also provides increased robustness for the second rechargeable battery pack and the second cover element also provides increased robustness for the first rechargeable battery pack.

Particularly preferably, the third cover element and the fourth cover element are arranged in a transverse direction between the rechargeable battery packs. The third cover element and the fourth cover element are designed to be opposite one another in relation to a plane aligned parallel to the longitudinal plane of the guide bar. The third cover element and the fourth cover element thus offer lateral protection for the rechargeable battery packs.

The protective device preferably has cutouts between the cover elements for gripping the rechargeable battery packs. The operator can consequently reach into the cutouts and pull the rechargeable battery packs out of the fastening section. The locking elements of the rechargeable battery packs are preferably arranged in the cutouts, so that the user can actuate the unlocking and subsequently remove the rechargeable battery from the appliance.

It is preferably provided that movement gaps are provided between the cover elements and the rechargeable battery packs. Preferably, the movement gaps taper in the direction of the first end face of the rechargeable battery packs. If one of the cover elements is subjected to an impact load, the latter deforms elastically, whereby the impact energy is mostly dissipated by the deformation of the cover element, thereby avoiding damage to the rechargeable battery pack.

The third cover element and/or the fourth cover element preferably have an outer face facing away from the rechargeable battery packs, wherein the outer face has a concave curvature that projects between the rechargeable battery packs. As a result, the third cover element and/or fourth cover element run close to the outer contour the rechargeable battery pack, thereby improving the protection for the rechargeable battery packs.

It is advantageously provided that the housing comprises a second handle with a second handle section on which the operator's other hand can rest, wherein a limiting device is provided between the second handle section and the guide bar, wherein the limiting device has an elevation, extending at least within the longitudinal plane, with respect to the second handle section, wherein the elevation is designed in such a way that the hand is prevented from slipping off the second handle section in the direction of the guide bar. This ensures that the operator of the pruner has a firm hold on the second handle of the pruner with their other hand. As a result, the operator can guide the pruner precisely and also perform precision work on the wood.

Preferably, the elevation is designed in such a way that the elevation forms a form-fitting stop in the direction of the guide bar for a hand of the operator resting on the second handle section. This can be advantageous in particular when using the power tool to cut branches. While the main load is supported on the first handle by the operator's hand, force can also be exerted via the form-fitting stop by the operator's other hand, in particular when cutting branches.

In the viewing direction perpendicular to the longitudinal plane, the limiting device preferably has an outer contour. The outer contour of the limiting device has in particular a first end adjoining the second handle section and a second end adjacent to the guide bar. Particularly preferably, the elevation of the limiting device is formed on the first end of the outer contour. Therefore, the elevation is directly adjacent to the second handle section of the second handle. By forming the elevation directly adjacent to the second handle section, the operator can place the palm of their other hand on the second handle section of the pruner and at the same time rest the side of the hand, i.e. the side of the little finger, against the elevation. The other hand thus sits firmly on the second handle of the pruner.

It is advantageously provided that the elevation has a concave contact section adjacent to the second handle section. The contact section forms an undercut for an operator's hand resting on the contact section. Therefore, when the operator's other hand rests on the second handle, it is securely molded to the undercut of the handle.

It is in particular provided that in the viewing direction perpendicular to the longitudinal plane, the elevation has a height measured perpendicular to the second handle section at the first end of the outer contour, wherein the height corresponds to at least 15%, in particular at least 20%, preferably approximately 25% of a length, measured in the longitudinal direction of the second handle, of the second handle section.

Preferably, the housing comprises a lubricant tank for supplying the saw chain with lubricant, wherein the limiting device at least partially encompasses the lubricant tank.

Particularly preferably, the housing is open towards the top in the region of the second handle section. It is easier for the operator to grip and release the second handle section.

Preferably, the contact section is provided with an anti-slip coating. As a result, the operator has an improved hold on the pruner on the second handle section, whereby the operator can use the pruner for precision work.

The disclosure is also based on the object of specifying a particularly ergonomic pruner.

This object is solved by a pruner which comprises a housing and a drive motor, wherein the drive motor drives a saw chain, which is guided in a guide groove of a guide bar, in a rotary manner via a drive chain sprocket, wherein the guide bar is arranged on a front end of the housing and has a longitudinal plane spanned by the guide groove, wherein the housing has a first handle with a first handle section on which a hand of the operator can rest the operator, wherein the first handle is assigned an actuating element for actuating the drive motor, wherein the housing comprises a second handle with a second handle section on which the operator's other hand can rest, wherein a limiting device is provided between the second handle section and the guide bar, wherein the limiting device has an elevation, extending at least within the longitudinal plane, with respect to the second handle section, wherein the elevation is designed in such a way that the hand is prevented from slipping off the second handle section in the direction of the guide bar.

This ensures that the operator of the pruner has a firm hold on the second handle of the pruner with their other hand. As a result, the operator can guide the pruner precisely and also perform precision work on the wood. Thus, the pruner can be used particularly ergonomically.

Preferably, the elevation is designed in such a way that the elevation forms a form-fitting stop in the direction of the guide bar for a hand of the operator resting on the second handle section. This can be advantageous in particular when using the power tool to cut branches. While the main load is supported on the first handle by the operator's hand, force can also be exerted via the form-fitting stop by the operator's other hand, in particular when cutting branches.

In the viewing direction perpendicular to the longitudinal plane, the limiting device preferably has an outer contour. The outer contour of the limiting device has in particular a first end adjoining the second handle section and a second end adjacent to the guide bar. Particularly preferably, the elevation of the limiting device is formed on the first end of the outer contour. Therefore, the elevation is directly adjacent to the second handle section of the second handle. By forming the elevation directly adjacent to the second handle section, the operator can place the palm of their other hand on the second handle section of the pruner and at the same time rest the side of the hand, i.e. the side of the little finger, against the elevation. The other hand thus sits firmly on the second handle of the pruner.

It is advantageously provided that the elevation has a concave contact section adjacent to the second handle section. The contact section forms an undercut for an operator's hand resting on the contact section. Therefore, when the operator's other hand rests on the second handle, it is securely molded to the undercut of the handle.

It is in particular provided that in the viewing direction perpendicular to the longitudinal plane, the elevation has a height measured perpendicular to the second handle section at the first end of the outer contour, wherein the height corresponds to at least 15%, in particular at least 20%, preferably approximately 25% of a length, measured in the longitudinal direction of the second handle, of the second handle section.

Preferably, comprises the housing a lubricant tank for supplying the saw chain with lubricant, wherein the limiting device at least partially encompasses the lubricant tank.

Particularly preferably, the housing is open towards the top in the region of the second handle section. It is easier for the operator to grip and release the second handle section.

Preferably, the contact section is provided with an anti-slip coating. As a result, the operator has an improved hold on the pruner on the second handle section, whereby the operator can use the pruner for precise work.

Advantageously, a fastening section is provided on a rear end of the housing for receiving a first rechargeable battery pack for supplying the drive motor with electrical energy. The fastening section is provided in particular for receiving a second rechargeable battery pack. The fastening section is preferably arranged on the housing, in particular at least on the first handle, in such a way that a center of gravity of the pruner lies in the first handle when the pruner is in a state in which the first rechargeable battery pack and the second rechargeable battery pack are arranged on the fastening section.

The center of gravity of the pruner lies in the first handle of the pruner, whereby the user grips the pruner in the center of gravity. This reduces gravity-induced tilting moments that act around the handle and would have to be corrected by the operator. Consequently, the operator can easily hold and guide the pruner.

It is provided preferentially that the guide bar has a longitudinal center axis and a transverse plane that is aligned orthogonal to the longitudinal plane. The longitudinal center axis lies preferentially in the longitudinal plane and in the transverse plane. Preferably, the transverse plane divides the pruner into an upper section comprising the drive motor and into a lower section. The center of gravity of the pruner preferably lies in the lower section of the pruner. As a result, the pruner has a particularly low center of gravity and can be easily guided by the operator.

The fastening section for the rechargeable battery packs of the housing preferentially lies in the lower section of the pruner. Therefore, the rechargeable battery packs also lie in the lower section of the pruner when they have been inserted into the fastening section. As a result, the center of gravity can be shifted further into the lower section.

The drive motor preferably has a rotational axis, wherein the rotational axis runs parallel to the longitudinal plane of the guide bar or lies in the longitudinal plane of the guide bar. As a result, the pruner can have a slim structural design.

It is preferably provided that the fastening section is designed in such a way that the rechargeable battery packs can be inserted into the fastening section in an insertion direction. Advantageously, the insertion direction substantially corresponds to the longitudinal direction of the first handle. When inserting the rechargeable battery packs, the operator can hold the pruner with one hand and use their other hand to slide the rechargeable battery packs into the fastening section or pull them out. Since preferably the insertion direction and the longitudinal direction of the handle substantially correspond, the operator can easily apply the counterforce needed to slide in or pull out the rechargeable battery packs.

Preferably, the fastening section is designed in such a way that when the pruner is in a state in which the first rechargeable battery pack and the second rechargeable battery pack are inserted, a distance, measured in the direction of the longitudinal center axis, between a center of gravity of the first rechargeable battery pack and the center of gravity of the pruner is greater than a distance, measured in the longitudinal direction, between a center of gravity of the second rechargeable battery pack and the center of gravity of the pruner. Therefore, the rechargeable battery packs are arranged offset from each other in the direction of the longitudinal center axis. In other words, the distance between the first rechargeable battery pack and the center of gravity of the pruner differs from distance between the second rechargeable battery pack and the center of gravity of the pruner.

It is advantageously provided that the fastening section is designed in such a way that when the pruner is in a state in which the first rechargeable battery pack and the second rechargeable battery pack are inserted, a distance, measured perpendicularly to the transverse plane, between the center of gravity of the first rechargeable battery pack and the center of gravity of the pruner is smaller than a distance, measured perpendicularly to the transverse plane, between the center of gravity of the second rechargeable battery pack and the center of gravity of the pruner. Therefore, the rechargeable battery packs are arranged offset from each other in terms of “height”, i.e. in the direction perpendicular to the transverse plane.

Particularly preferably, the actuating element is arranged on the first handle. Preferably, the actuating element is designed as a lever that can pivot about a first pivot axis, wherein the actuating element has an outer contour with a maximum first radius with respect to the first pivot axis, wherein the first radius is greater than the distance between the center of gravity of the pruner and the first pivot axis. Preferably, the distance between the actuating element and the center of gravity of the pruner is not greater than 3 cm, preferentially not greater than 2 cm. Thus, the center of gravity of the pruner lies particularly close to the actuating element. The actuating element is actuated during normal operation of the pruner by means of the operator's index finger. Therefore, the operator grasps the handle with their index finger close to the center of gravity of the pruner. By clasping the center of gravity of the pruner with the thumb and the index finger, the operator is able to handle the pruner particularly ergonomically.

Preferably, the housing has a longitudinal midplane running parallel to the longitudinal plane, wherein the longitudinal midplane bisects the housing, wherein the center of gravity of the pruner lies almost in the longitudinal midplane, particularly preferably in the longitudinal midplane of the housing. Therefore, no lateral tilting moments arise that the operator would have to correct.

It is provided preferentially that the housing comprises a second handle on which the operator's other hand can rest, and wherein the center of gravity of the pruner is designed to be between the second handle and the actuating element assigned to the first handle. Preferably, the center of gravity of the pruner is designed to be between the second handle and the actuating element in relation to a direction perpendicular to the transverse plane of the guide bar.

Particularly preferably, the pruner has a fastener. The fastener preferably has at least one first fastening element for holding the pruner on the first fastening element. The fastener is arranged in particular on the handle housing. The operator can fasten the pruner to a carrying device or similar via the fastener. The pruner can be fastened via the at least one first fastening element, for example, to a cord, which is hung at the other end, for example, on a carrying device of the operator. If the operator accidentally drops the pruner, the latter can be held via the cord. Preferably, the first fastening element is designed as an eyelet.

The fastener preferably has a second fastening element for holding the pruner on the second fastening element. The second fastening element can be used analogously to the first fastening element. The second fastening element is designed in particular as an eyelet.

It is advantageously provided that the housing a first longitudinal outer side and a second longitudinal outer side. The longitudinal outer sides are arranged opposite each other with respect to a plane that is aligned parallel to the longitudinal plane of the guide bar. The first fastening element is preferably arranged on the first longitudinal outer side. The second fastening element is preferably arranged on the second longitudinal outer side.

It is provided preferentially that the fastener is arranged in the fastening section of the housing. The fastening section is in particular part of the handle housing. Thus, the fastener lies more at the rear end of the pruner, whereby the pruner hangs from the fastener with the guide bar aligned towards the ground.

The fastener is preferably arranged in a transverse direction between the first rechargeable battery pack and the second rechargeable battery pack when the pruner is in a state in which the first rechargeable battery pack and the second rechargeable battery pack are inserted.

The fastener preferably comprises a base body. Preferentially, the fastener, in particular the base body of the fastener, is made as a single part. The base body is preferably flat. Due to the single-part design of the fastener, high forces can preferably be transmitted to the housing. On the other hand, the fastener therefore has a simple construction and can be produced cost-effectively.

Preferably, the housing comprises a first housing half and a second housing half, wherein the fastener is held between the first housing half and the second housing half, in particular in a form-fitting manner. Therefore, simple assembly of the pruner with regard to the fastener is possible.

It is advantageously provided that the base body extends in a longitudinal direction, wherein a fastening element is formed on at least one of the longitudinal ends of the base body. Particularly preferably, a fastening element is formed in each case on the longitudinal ends of the base body. Advantageously, the first housing half and the second housing half are connected to each another via a mechanical connection, adjacent to the fastener. The mechanical connection is preferably a screw connection. In an alternative configuration of the pruner, it may also be expedient to provide other mechanical connections, for example snap connections, rivet connections or similar. As a result, the forces transmitted from the fastener to the housing halves can be supported by the mechanical connection, in particular by the screw connection. Thus, the fastener can withstand high loads.

It is particularly preferably provided that the fastener is arranged between the center of gravity of the pruner and the rear end of the housing. Preferably, the fastener is arranged in relation to a longitudinal direction of the first handle between the center of gravity of the pruner and the rear end of the housing. If the pruner is hanging from its fastener, the pruner will be aligned owing to gravity in such a way that the center of gravity of the pruner lies below the fastener. This also means that the guide bar, which is arranged on the front end of the housing, is aligned towards the ground. On the one hand, this alignment of the pruner allows the operator to easily grip the first handle of the pruner from above. If the operator wishes to pick up the pruner for work again, they do not need to adjust the grip of their hands on the pruner. On the other hand, it is advantageous, in particular when pruning trees, that the pruner which is hanging from the fastener aligns itself with the guide bar pointing in the direction of the ground. If the operator pulls the pruner up towards them, there is less chance that pruner will get caught on the tree's branches with its saw chain.

It is advantageously provided that the first handle comprises a first handle section on which a hand of the operator can rest, wherein the handle section has a top side and a bottom side facing away from the top side. The housing preferably comprises a cover clip. The cover clip preferably extends from its first end up to its second end along the bottom side of the first handle section. Particularly preferably, the cover clip extends substantially parallel to the bottom side of the first handle section. The cover clip preferably has a taper in the direction of its second end. The operator can fasten the pruner at the taper to, for example, a carrying device of the operator, for example via a carabiner or another fastening means.

The first end the cover clip is preferably adjacent to a motor housing of the housing and/or to a central housing of the housing.

The cover clip preferably has a maximum width measured perpendicular to the longitudinal plane spanned by the guide groove of the guide bar. The longitudinal plane preferably lies exactly in the center in the guide groove of the guide bar. The cover clip has a minimum width, in particular at its taper, measured perpendicularly to the longitudinal plane spanned by the guide groove of the guide bar. The minimum width at the taper corresponds to in particular at most 70%, preferably at most 60%, advantageously approximately 50% of the maximum width of the cover clip. Particularly preferably, the minimum width of the cover clip at the taper corresponds to at least 10%, preferably at least 20%, particularly preferably at least 30%, preferentially at least 40% of the maximum width of the cover clip. Due to this configuration of the cover clip, the cover clip is slim enough at its taper for the taper to be surrounded by a fastening means. Nevertheless, the cross-section of the cover clip is still sufficiently large at its taper to reinforce the housing.

It is advantageously provided that a lockout lever for locking and releasing the actuating element is provided. The lockout lever preferably has an outer contour that extends over a width perpendicular to the longitudinal plane of the guide bar, wherein the width is in particular less than the maximum width of the cover clip. Particularly preferably, the cover clip extends from a first longitudinal side up to a second longitudinal side. Preferably, the outer contour of the lockout lever is arranged in the direction perpendicular to the longitudinal plane of the guide bar completely between the first longitudinal side and the second longitudinal side of the cover clip, at least in the region of the first end of the cover clip. The actuating element is preferably arranged between the first handle section and the cover clip. Thus, at least part of the actuating element lies behind the cover clip.

It is advantageously provided that the cover clip has a top side facing the bottom side of the first handle section. Preferably, the housing comprises a bridge, the bridge extending from the top side of the cover clip up to the bottom side of the handle section. The bridge has a reinforcing effect on the housing of the pruner. The actuating element is preferably arranged between the bridge and the first end of the cover clip. The taper of the cover clip is preferably arranged between the bridge and the second end of the cover clip. The second end of the cover clip leads into the fastening section of the housing.

It is advantageously provided that a protective device for protecting the rechargeable battery packs is provided on the fastening section, wherein the rechargeable battery packs each extend in their longitudinal direction from a first end face up to a second end face, wherein the first end face of the rechargeable battery packs faces the fastener and the second end face of the rechargeable battery packs faces away from the fastener, wherein the protective device comprises at least one first cover element, the first cover element extending in the longitudinal direction of the first rechargeable battery pack at least up to the second end face of the first rechargeable battery pack. The first cover element protects the first rechargeable battery pack from impact loads, for example if the pruner falls onto the ground. Damage to the first rechargeable battery pack can thus be prevented.

The protective device comprises at least one second cover element. The second cover element preferably extends in the longitudinal direction of the second rechargeable battery pack, at least up to the second end face of the second rechargeable battery pack. Thus, the second cover element protects the second rechargeable battery pack from impact loads, for example if the pruner falls onto the ground. Damage to the second rechargeable battery pack can thus be prevented.

It is advantageously provided that the rechargeable battery packs are each slid in their longitudinal direction into the fastener. Particularly preferably, the rechargeable battery packs are slid into the fastener, wherein the first rechargeable battery pack and the second rechargeable battery pack each have a longitudinal axis running in the longitudinal direction of the respective rechargeable battery pack. The longitudinal axes of the rechargeable battery packs are in particular aligned parallel to the longitudinal midplane of the housing. The longitudinal axes of the rechargeable battery packs can preferably also run at an angle to each other. The longitudinal axes of the rechargeable battery packs lie particularly preferably in the longitudinal midplane the housing. In a transverse direction, the rechargeable battery packs are preferably arranged one above the other. The transverse direction is advantageously aligned perpendicular to the longitudinal direction of the first rechargeable battery pack and/or to the longitudinal direction of the second rechargeable battery pack. The transverse direction preferably lies in a plane that is aligned parallel to the longitudinal midplane of the housing. Therefore, in a plan view of the pruner, the rechargeable battery packs lie one above the other, thereby enabling a particularly slim structural design of the pruner.

It is advantageously provided that the rechargeable battery packs are arranged offset from one another in their longitudinal direction, and that the second end faces of the rechargeable battery packs lie in different planes. Therefore, the rechargeable battery packs are arranged offset from one another in the longitudinal direction. Preferably, the rechargeable battery packs are arranged at least overlapping one another in the longitudinal direction. Preferably, the planes of the end faces of the first rechargeable battery pack and of the second rechargeable battery pack run parallel to each other.

Advantageously, the protective device comprises at least one third cover element. Preferably, the protective device comprises at least one fourth cover element. The third cover element preferably extends in the longitudinal direction of the rechargeable battery packs, at least up to the second end face of the rechargeable battery packs. The fourth cover element preferably extends in the longitudinal direction of the rechargeable battery packs, at least up to the second end face of the rechargeable battery packs. Particularly advantageously, the third cover element and the fourth cover element extend in the longitudinal direction of the rechargeable battery packs at least up to the second end face of the rechargeable battery packs. As a result, once inserted, the rechargeable battery packs are also protected from impact loads by the third cover element and by the fourth cover element.

Preferably, the rechargeable battery packs each have a substantially triangular cross-sectional contour with rounded corners. The rechargeable battery packs are preferably of identical construction. The rechargeable battery packs preferably each have a back wall formed between two rounded corners. The rechargeable battery packs are arranged in the fastening section in relation to each other in such a way that the back walls of the rechargeable battery packs lie opposite one another. Viewed in the direction of the longitudinal axes of the rechargeable battery packs and/or the direction in which the rechargeable battery packs are inserted, a contour encompassing the rechargeable battery packs has a diamond-shaped geometry. Due to this arrangement, the power tool has a slim structural design at its rear end. Advantageously, in this case, the first cover element is arranged on a rounded corner of the first rechargeable battery pack that faces away from the second rechargeable battery pack. The second cover element is preferably arranged on a rounded corner of the second rechargeable battery pack that faces away from the first rechargeable battery pack. As a result, the first cover element and the second cover element at least partially encompass the rechargeable battery packs together, whereby the first cover element also provides increased robustness for the second rechargeable battery pack and the second cover element also provides increased robustness for the first rechargeable battery pack.

Particularly preferably, the third cover element and the fourth cover element are arranged in a transverse direction between the rechargeable battery packs. The third cover element and the fourth cover element are designed to be opposite one another in relation to a plane aligned parallel to the longitudinal plane of the guide bar. The third cover element and the fourth cover element thus offer lateral protection for the rechargeable battery packs.

The protective device preferably has cutouts between the cover elements for gripping the rechargeable battery packs. The operator can consequently reach into the cutouts and pull the rechargeable battery packs out of the fastening section. The locking elements of the rechargeable battery packs are preferably arranged in the cutouts, so that the user can actuate the unlocking and subsequently remove the rechargeable battery from the appliance.

It is preferably provided that movement gaps are provided between the cover elements and the rechargeable battery packs. Preferably, the movement gaps taper in the direction of the first end face of the rechargeable battery packs. If one of the cover elements is subjected to an impact load, the latter deforms elastically, whereby the impact energy is mostly dissipated by the deformation of the cover element, thereby avoiding damage to the rechargeable battery pack.

The third cover element and/or the fourth cover element preferably have an outer face facing away from the rechargeable battery packs, wherein the outer face has a concave curvature that projects between the rechargeable battery packs. As a result, the third cover element and/or fourth cover element run close to the outer contour the rechargeable battery pack, thereby improving the protection for the rechargeable battery packs.

The disclosure furthermore relates to a hand-held power tool.

Hand-held power tools comprise a housing and a drive motor arranged in the housing, wherein the drive motor drives a saw chain on a guide bar in a rotary motion. Such power tools comprise a rechargeable battery pack for supplying the drive motor with electrical energy.

The disclosure is based on the object of specifying a hand-held power tool of the generic type, which has a robust structure and can be handled in a straightforward manner by the operator.

This object is solved by a hand-held power tool which comprises a housing with a longitudinal midplane and a drive motor arranged in the housing, wherein a fastening section is provided on a rear end of the housing for receiving a first rechargeable battery pack for supplying the drive motor with electrical energy, wherein the fastening section is provided for receiving a second rechargeable battery pack, wherein a protective device for protecting the rechargeable battery packs is provided on the fastening section, wherein the rechargeable battery packs extend in each case in their longitudinal direction from a first end face up to a second end face, wherein the first end face of the rechargeable battery packs faces the fastening section and the second end face of the rechargeable battery packs faces away from the fastening section, wherein the protective device comprises at least one first cover element, the first cover element extending in the longitudinal direction of the first rechargeable battery pack at least up to the second end face of the first rechargeable battery pack. The first cover element protects the first rechargeable battery pack from impact loads, for example if the power tool falls onto the ground. Damage to the first rechargeable battery pack can thus be prevented. A robust structure of the power tool to protect the rechargeable battery pack is ensured.

The protective device comprises at least one second cover element. The second cover element preferably extends in the longitudinal direction of the second rechargeable battery pack, at least up to the second end face of the second rechargeable battery pack. Thus, the second cover element protects the second rechargeable battery pack from impact loads, for example if the power tool falls onto the ground. Damage to the second rechargeable battery pack can thus be prevented.

It is advantageously provided that the rechargeable battery packs are each slid in their longitudinal direction into the fastener. Particularly preferably, the rechargeable battery packs are slid into the fastener, wherein the first rechargeable battery pack and the second rechargeable battery pack each have a longitudinal axis running in the longitudinal direction of the respective rechargeable battery pack. The longitudinal axes of the rechargeable battery packs are in particular aligned parallel to the longitudinal midplane of the housing. The longitudinal axes of the rechargeable battery packs can preferably also run at an angle to each other. The longitudinal axes of the rechargeable battery packs lie particularly preferably in the longitudinal midplane the housing. In a transverse direction, the rechargeable battery packs are preferably arranged one above the other. The transverse direction is advantageously aligned perpendicular to the longitudinal direction of the first rechargeable battery pack and/or to the longitudinal direction of the second rechargeable battery pack. The transverse direction preferably lies in a plane that is aligned parallel to the longitudinal midplane of the housing. Therefore, in a plan view of the power tool, the rechargeable battery packs lie one above the other, thereby enabling a particularly slim structural design of the power tool.

It is advantageously provided that the rechargeable battery packs are arranged offset from one another in their longitudinal direction, and that the second end faces of the rechargeable battery packs lie in different planes. Therefore, the rechargeable battery packs are arranged offset from one another in the longitudinal direction. Preferably, the rechargeable battery packs are arranged at least overlapping one another in the longitudinal direction. Preferably, the planes of the end faces of the first rechargeable battery pack and of the second rechargeable battery pack run parallel to each other.

Advantageously, the protective device comprises at least one third cover element. Preferably, the protective device comprises at least one fourth cover element. The third cover element preferably extends in the longitudinal direction of the rechargeable battery packs, at least up to the second end face of the rechargeable battery packs. The fourth cover element preferably extends in the longitudinal direction of the rechargeable battery packs, at least up to the second end face of the rechargeable battery packs. Particularly advantageously, the third cover element and the fourth cover element extend in the longitudinal direction of the rechargeable battery packs at least up to the second end face of the rechargeable battery packs. As a result, once inserted, the rechargeable battery packs are also protected from impact loads by the third cover element and by the fourth cover element.

Preferably, the rechargeable battery packs each have a substantially triangular cross-sectional contour with rounded corners. The rechargeable battery packs are preferably of identical construction. The rechargeable battery packs preferably each have a back wall formed between two rounded corners. The rechargeable battery packs are arranged in the fastening section in relation to each other in such a way that the back walls of the rechargeable battery packs lie opposite one another. Viewed in the direction of the longitudinal axes of the rechargeable battery packs and/or the direction in which the rechargeable battery packs are inserted, a contour encompassing the rechargeable battery packs has a diamond-shaped geometry. Due to this arrangement, the power tool has a slim structural design at its rear end. Advantageously, in this case, the first cover element is arranged on a rounded corner of the first rechargeable battery pack that faces away from the second rechargeable battery pack. The second cover element is preferably arranged on a rounded corner of the second rechargeable battery pack that faces away from the first rechargeable battery pack. As a result, the first cover element and the second cover element at least partially encompass the rechargeable battery packs together, whereby the first cover element also provides increased robustness for the second rechargeable battery pack and the second cover element also provides increased robustness for the first rechargeable battery pack.

Particularly preferably, the third cover element and the fourth cover element are arranged in a transverse direction between the rechargeable battery packs. The third cover element and the fourth cover element are designed to be opposite one another in relation to a plane aligned parallel to the longitudinal plane of the guide bar. The third cover element and the fourth cover element thus offer lateral protection for the rechargeable battery packs.

The protective device preferably has cutouts between the cover elements for gripping the rechargeable battery packs. The operator can consequently reach into the cutouts and pull the rechargeable battery packs out of the fastening section. The locking elements of the rechargeable battery packs are preferably arranged in the cutouts, so that the user can actuate the unlocking and subsequently remove the rechargeable battery from the appliance.

It is preferably provided that movement gaps are provided between the cover elements and the rechargeable battery packs. Preferably, the movement gaps taper in the direction of the first end face of the rechargeable battery packs. If one of the cover elements is subjected to an impact load, the latter deforms elastically, whereby the impact energy is mostly dissipated by the deformation of the cover element, thereby avoiding damage to the rechargeable battery pack.

The third cover element and/or the fourth cover element preferably have an outer face facing away from the rechargeable battery packs, wherein the outer face has a concave curvature that projects between the rechargeable battery packs. As a result, the third cover element and/or fourth cover element run close to the outer contour the rechargeable battery pack, thereby improving the protection for the rechargeable battery packs.

Advantageously, the drive motor drives a saw chain, which is guided in the guide groove of the guide bar, in a rotary motion via a drive chain sprocket, the guide bar being arranged on a front end of the housing and having a longitudinal plane spanned by the guide groove, wherein the housing comprises a first handle on which a hand of the operator can rest, wherein in particular the first handle is assigned an actuating element for actuating the drive motor, wherein the fastening section is arranged on the housing, in particular at least on the first handle, in such a way that a center of gravity of the power tool lies in the first handle when the power tool is in a state in which the first rechargeable battery pack and the second rechargeable battery pack are arranged on the fastening section.

The center of gravity of the power tool lies in the first handle of the power tool, whereby the user grips the power tool in the center of gravity. This reduces gravity-induced tilting moments that act around the handle and would have to be corrected by the operator. Consequently, the operator can easily hold and guide the power tool.

It is provided preferentially that the guide bar has a longitudinal center axis and a transverse plane that is aligned orthogonal to the longitudinal plane. The longitudinal center axis lies preferentially in the longitudinal plane and in the transverse plane. Preferably, the transverse plane divides the power tool into an upper section comprising the drive motor and into a lower section. The center of gravity of the power tool preferably lies in the lower section of the power tool. As a result, the power tool has a particularly low center of gravity and can be easily guided by the operator.

The fastening section for the rechargeable battery packs of the housing preferentially lies in the lower section of the power tool. Therefore, the rechargeable battery packs also lie in the lower section of the power tool when they have been inserted into the fastening section. As a result, the center of gravity can be shifted further into the lower section.

The drive motor preferably has a rotational axis, wherein the rotational axis runs parallel to the longitudinal plane of the guide bar or lies in the longitudinal plane of the guide bar. As a result, the power tool can have a slim structural design.

It is preferably provided that the fastening section is designed in such a way that the rechargeable battery packs can be inserted into the fastening section in an insertion direction. Advantageously, the insertion direction substantially corresponds to the longitudinal direction of the first handle. When inserting the rechargeable battery packs, the operator can hold the power tool with one hand and use their other hand to slide the rechargeable battery packs into the fastening section or pull them out. Since preferably the insertion direction and the longitudinal direction of the handle substantially correspond, the operator can easily apply the counterforce needed to slide in or pull out the rechargeable battery packs.

Preferably, the fastening section is designed in such a way that when the power tool is in a state in which the first rechargeable battery pack and the second rechargeable battery pack are inserted, a distance, measured in the direction of the longitudinal center axis, between a center of gravity of the first rechargeable battery pack and the center of gravity of the power tool is greater than a distance, measured in the longitudinal direction, between a center of gravity of the second rechargeable battery pack and the center of gravity of the power tool. Therefore, the rechargeable battery packs are arranged offset from each other in the direction of the longitudinal center axis. In other words, the distance between the first rechargeable battery pack and the center of gravity of the power tool differs from distance between the second rechargeable battery pack and the center of gravity of the power tool.

It is advantageously provided that the fastening section is designed in such a way that when the power tool is in a state in which the first rechargeable battery pack and the second rechargeable battery pack are inserted, a distance, measured perpendicularly to the transverse plane, between the center of gravity of the first rechargeable battery pack and the center of gravity of the power tool is smaller than a distance, measured perpendicularly to the transverse plane, between the center of gravity of the second rechargeable battery pack and the center of gravity of the power tool. Therefore, the rechargeable battery packs are arranged offset from each other in terms of “height”, i.e. in the direction perpendicular to the transverse plane.

Particularly preferably, the actuating element is arranged on the first handle. Preferably, the actuating element is designed as a lever that can pivot about a first pivot axis, wherein the actuating element has an outer contour with a maximum first radius with respect to the first pivot axis, wherein the first radius is greater than the distance between the center of gravity of the power tool and the first pivot axis. Preferably, the distance between the actuating element and the center of gravity of the power tool is not greater than 3 cm, preferentially not greater than 2 cm. Thus, the center of gravity of the power tool lies particularly close to the actuating element. The actuating element is actuated during normal operation of the power tool by means of the operator's index finger. Therefore, the operator grasps the handle with their index finger close to the center of gravity of the power tool. By clasping the center of gravity of the power tool with the thumb and the index finger, the operator is able to handle the power tool particularly ergonomically.

Preferably, the housing has a longitudinal midplane running parallel to the longitudinal plane, wherein the longitudinal midplane bisects the housing, wherein the center of gravity of the power tool lies almost in the longitudinal midplane, particularly preferably in the longitudinal midplane of the housing. Therefore, no lateral tilting moments arise that the operator would have to correct.

It is provided preferentially that the housing comprises a second handle on which the operator's other hand can rest, and wherein the center of gravity of the power tool is designed to be between the second handle and the actuating element assigned to the first handle. Preferably, the center of gravity of the power tool is designed to be between the second handle and the actuating element in relation to a direction perpendicular to the transverse plane of the guide bar.

Particularly preferably, the power tool has a fastener. The fastener preferably has at least one first fastening element for holding the power tool on the first fastening element. The fastener is arranged in particular on the handle housing. The operator can fasten the power tool to a carrying device or similar via the fastener. The power tool can be fastened via the at least one first fastening element, for example, to a cord, which is hung at the other end, for example, on a carrying device of the operator. If the operator accidentally drops the power tool, the latter can be held via the cord. Preferably, the first fastening element is designed as an eyelet.

The fastener has preferably a second fastening element for holding the power tool on the second fastening element. The second fastening element can be used analogously to the first fastening element. The second fastening element is designed in particular as an eyelet.

It is advantageously provided that the housing a first longitudinal outer side and a second longitudinal outer side. The longitudinal outer sides are arranged opposite each other with respect to a plane that is aligned parallel to the longitudinal plane of the guide bar. The first fastening element is preferably arranged on the first longitudinal outer side. The second fastening element is preferably arranged on the second longitudinal outer side.

It is provided preferentially that the fastener is arranged in the fastening section of the housing. The fastening section is in particular part of the handle housing. Thus, the fastener lies more at the rear end of the power tool, whereby the power tool hangs from the fastener with the guide bar aligned towards the ground.

The fastener is preferably arranged in a transverse direction between the first rechargeable battery pack and the second rechargeable battery pack when the power tool is in a state in which the first rechargeable battery pack and the second rechargeable battery pack are inserted.

The fastener preferably comprises a base body. Preferentially, the fastener, in particular the base body of the fastener, is made as a single part. The base body is preferably flat. Due to the single-part design of the fastener, high forces can preferably be transmitted to the housing. On the other hand, the fastener therefore has a simple construction and can be produced cost-effectively.

Preferably, the housing comprises a first housing half and a second housing half, wherein the fastener is held between the first housing half and the second housing half, in particular in a form-fitting manner. Therefore, simple assembly of the power tool with regard to the fastener is possible.

It is advantageously provided that the base body extends in a longitudinal direction, wherein a fastening element is formed on at least one of the longitudinal ends of the base body. Particularly preferably, a fastening element is formed in each case on the longitudinal ends of the base body. Advantageously, the first housing half and the second housing half are connected to each another via a mechanical connection, adjacent to the fastener. The mechanical connection is preferably a screw connection. In an alternative configuration of the power tool, it may also be expedient to provide other mechanical connections, for example snap connections, rivet connections or similar. As a result, the forces transmitted from the fastener to the housing halves can be supported by the mechanical connection, in particular by the screw connection. Thus, the fastener can withstand high loads.

It is particularly preferably provided that the fastener is arranged between the center of gravity of the power tool and the rear end of the housing. Preferably, the fastener is arranged in relation to a longitudinal direction of the first handle between the center of gravity of the power tool and the rear end of the housing. If the power tool is hanging from its fastener, the power tool will be aligned owing to gravity in such a way that the center of gravity of the power tool lies below the fastener. This also means that the guide bar, which is arranged on the front end of the housing, is aligned towards the ground. On the one hand, this alignment of the power tool allows the operator to easily grip the first handle of the power tool from above. If the operator wishes to pick up the power tool for work again, they do not need to adjust the grip of their hands on the power tool. On the other hand, it is advantageous, in particular when pruning trees, that the power tool which is hanging from the fastener aligns itself with the guide bar pointing in the direction of the ground. If the operator pulls the power tool up towards them, there is less chance that power tool will get caught on the tree's branches with its saw chain.

It is advantageously provided that the first handle comprises a first handle section on which a hand of the operator can rest, wherein the handle section has a top side and a bottom side facing away from the top side. The housing preferably comprises a cover clip. The cover clip preferably extends from its first end up to its second end along the bottom side of the first handle section. Particularly preferably, the cover clip extends substantially parallel to the bottom side of the first handle section. The cover clip preferably has a taper in the direction of its second end. The operator can, for example, fasten the power tool at the taper via a carabiner or another fastening means for example to a carrying device of the operator.

The first end the cover clip is preferably adjacent to a motor housing of the housing and/or to a central housing of the housing.

The cover clip preferably has a maximum width measured perpendicular to the longitudinal plane spanned by the guide groove of the guide bar. The longitudinal plane preferably lies exactly in the center in the guide groove of the guide bar. The cover clip has a minimum width, in particular at its taper, measured perpendicularly to the longitudinal plane spanned by the guide groove of the guide bar. The minimum width at the taper corresponds to in particular at most 70%, preferably at most 60%, advantageously approximately 50% of the maximum width of the cover clip. Particularly preferably, the minimum width of the cover clip at the taper corresponds to at least 10%, preferably at least 20%, particularly preferably at least 30%, preferentially at least 40% of the maximum width of the cover clip. Due to this configuration of the cover clip, the cover clip is slim enough at its taper for the taper to be surrounded by a fastening means. Nevertheless, the cross-section of the cover clip is still sufficiently large at its taper to reinforce the housing.

It is advantageously provided that a lockout lever for locking and releasing the actuating element is provided. The lockout lever preferably has an outer contour which extends over a width perpendicular to the longitudinal plane of the guide bar, the width being in particular less than the maximum width of the cover clip. Particularly preferably, the cover clip extends from a first longitudinal side up to a second longitudinal side. Preferably, the outer contour of the lockout lever is arranged in the direction perpendicular to the longitudinal plane of the guide bar completely between the first longitudinal side and the second longitudinal side of the cover clip, at least in the region of the first end of the cover clip. The actuating element is preferably arranged between the first handle section and the cover clip. Thus, at least part of the actuating element lies behind the cover clip.

It is advantageously provided that the cover clip has a top side facing the bottom side of the first handle section. Preferably, the housing comprises a bridge, the bridge extending from the top side of the cover clip up to the bottom side of the handle section. The bridge has a reinforcing effect on the housing of the power tool. The actuating element is preferably arranged between the bridge and the first end of the cover clip. The taper of the cover clip is preferably arranged between the bridge and the second end of the cover clip. The second end of the cover clip leads into the fastening section of the housing.

It is advantageously provided that a protective device for protecting the rechargeable battery packs is provided on the fastening section, wherein the rechargeable battery packs each extend in their longitudinal direction from a first end face up to a second end face, wherein the first end face of the rechargeable battery packs faces the fastener and the second end face of the rechargeable battery packs faces away from the fastener, wherein the protective device comprises at least one first cover element, the first cover element extending in the longitudinal direction of the first rechargeable battery pack at least up to the second end face of the first rechargeable battery pack. The first cover element protects the first rechargeable battery pack from impact loads, for example if the power tool falls onto the ground. Damage to the first rechargeable battery pack can thus be prevented.

Preferably, the elevation is designed in such a way that the elevation forms a form-fitting stop in the direction of the guide bar for a hand of the operator resting on the second handle section. This can be advantageous in particular when using the power tool to cut branches. While the main load is supported on the first handle by the operator's hand, force can also be exerted via the form-fitting stop by the operator's other hand, in particular when cutting branches.

In the viewing direction perpendicular to the longitudinal plane, the limiting device preferably has an outer contour. The outer contour of the limiting device has in particular a first end adjoining the second handle section and a second end adjacent to the guide bar. Particularly preferably, the elevation of the limiting device is formed on the first end of the outer contour. Therefore, the elevation is directly adjacent to the second handle section of the second handle. By forming the elevation directly adjacent to the second handle section, the operator can place the palm of their other hand on the second handle section of the power tool and at the same time rest the side of the hand, i.e. the side of the little finger, against the elevation. The other hand thus sits firmly on the second handle of the power tool.

It is advantageously provided that the elevation has a concave contact section adjacent to the second handle section. The contact section forms an undercut for an operator's hand resting on the contact section. Therefore, when the operator's other hand rests on the second handle, it is securely molded to the undercut of the handle.

It is in particular provided that in the viewing direction perpendicular to the longitudinal plane, the elevation has a height measured perpendicular to the second handle section at the first end of the outer contour, wherein the height corresponds to at least 15%, in particular at least 20%, preferably approximately 25% of a length, measured in the longitudinal direction of the second handle, of the second handle section.

Preferably, the housing comprises a lubricant tank for supplying the saw chain with lubricant, wherein the limiting device at least partially encompasses the lubricant tank.

Particularly preferably, the housing is open towards the top in the region of the second handle section. It is easier for the operator to grip and release the second handle section.

Preferably, the contact section is provided with an anti-slip coating. As a result, the operator has an improved hold on the power tool on the second handle section, whereby the operator can use the power tool for precise work.

The disclosure relates to a hand-guided power tool such as a hedge trimmer, a chain saw or the like.

Such hand-guided power tools frequently work using a mechanical operator control concept in which, during normal operation, the user has to actuate at least two operating elements to control the power of the drive motor. The first operating element can, for example, be the throttle lever of a combustion engine or the power lever of an electric drive motor. In an unactuated rest position, the throttle trigger or the power lever can be in an idle position. When depressed into an actuated position, the speed of the drive motor increases to operating speed with a corresponding power increase, so that the corresponding tool is powered at operating speed.

In this connection, the second operating element can be a so-called throttle trigger lock, which is held by a spring in an unactuated position. In its unactuated position, the second operating element blocks the first operating element from moving in the direction of its actuated position, so that the tool cannot be accidentally throttled or switched on. The first operating element is only released by actively actuating the second operating element counter to the force of the mentioned spring, so that it can be brought into the actuated position with the corresponding power control of the drive motor.

In practical operation, such power tools are held in different orientations so as to make horizonal or vertical cuts, for example. This is often accompanied by the user changing the position of their hand relative to the handle. Nevertheless, the user must still be able to reach both operating elements.

A hand-guided power tool with such an operator control concept is known from EP 3 792 006 A, wherein a lockout lever acting on the power lever is provided with wing elements for actuating said lockout lever. One wing element in each case projects out of each side of the device housing, so that the lockout lever can be actuated from both sides. In the middle between the wing elements, the lockout lever is provided with an actuating contour against which a leaf spring rests pretensioned. When it is released, this returns the lockout lever to its unactuated starting position. This arrangement has proved to be worthwhile in the shown power tool. However, the leaf spring requires a certain minimum overall length, which adds to the overall axial length of the lockout lever. Moreover, it is difficult to adapt to other handle shapes which are held differently, since the wing elements cannot be freely positioned in the design due to their interaction with the leaf spring.

The disclosure is based on the object of specifying a hand-guided power tool with a more compact structural design in terms of its locking mechanism.

This object is solved by a hand-guided power tool which comprises at least one tool; a drive motor for driving the at least one tool; a housing; a first operating element designed for controlling the drive motor; and a second operating element, which is mounted so as to be pivotable relative to the housing about a pivot axis between an unactuated position and at least one actuated position. In this case, the second operating element in its unactuated position blocks a movement of the first operating element in the direction of an actuated position of the first operating element, wherein the second operating element is held by a spring in the unactuated position. The spring has a tensioning section which is securely attached to the housing. In addition, the spring has an actuating section which interacts with an actuating contour of the second operating element. The second operating element has at least one operating section which is provided for an operator to actuate the second operating element, wherein the operating section has a connecting region at which the operating section projects through an opening of the housing onto the outer face of the housing. The connecting region of the operating section extends from a first plane, running perpendicularly to the pivot axis, to a second plane, running perpendicularly to the pivot axis, and in the process does not project beyond these planes. The mentioned planes enclose an operating section area of the power tool, wherein the tensioning section and the actuating section extend at least partially on opposite sides of the operating section area. In particular, the tensioning section and the actuating section are arranged completely outside the operating section area.

The inventors found that the overall length of the spring is crucial and that to stop excessive stress occurring at a given spring deflection, the spring must not fall short of a minimum overall length. The above-defined arrangement means that one respective end of the spring is positioned in front of the actuating section and one end is positioned behind it. The second operating element, acting as a locking element, requires practically no additional overall length for the entire arrangement. Rather, the overall length of the lockout lever arrangement is substantially reduced to the technical minimum of the spring length. In addition, what is known as an “inserted” construction can be realized, in which the spring lies in the interior of the locking element and therefore does not impede the positioning of one or more operating sections. The operating sections can be freely positioned in terms of ergonomics, so that they can be accessed more easily in different working postures.

In a preferred refinement, the spring is designed as a leaf spring and emerges from the tensioning section in the direction of a midplane, wherein the midplane makes an angle of at least 10°, in particular at least 15°, with the pivot axis of the second operating element.

As a result, the leaf spring at its end opposite the tensioning section runs approximately parallel to and at a small distance from the bearing shaft of the second operating element due to its preloaded bending line and requires only little radial installation space in this area. In addition, the slanted position means that any dirt that gets in falls off, thereby keeping the arrangement clear for a long time, even under harsh working conditions.

Preferably, the opening is covered at least partially by a cover section of the second operating element, wherein the connecting region of the operating section is arranged on the cover section. This makes it more difficult for impurities to enter through the housing opening when the operating element is in different positions.

Expediently, the spring, at the actuating section in the contact region with the actuating contour, has at least one contact section which is bent away from the actuating contour in the circumferential direction relative to the pivot axis, wherein the contact section is arranged outside the cover section. Owing to the bent shape, the contact section can easily slide along the actuating contour without colliding with the cover section in the bent-up state.

In an advantageous refinement, the spring extends between the cover section and the pivot axis. In the process, the cover section covers a middle region of the spring towards the outer face of the housing. In particular, the cover section extends arcuately around the pivot axis over an angle range of at least 120°. Preferably, the operating section at the connecting region with the cover section makes an angle of at least 30°. Expediently, the actuating contour and the cover section delimit an opening through which the spring projects. Advantageously, the second operating element has a bearing shaft which extends from a first bearing journal to a second bearing journal, wherein, in the viewing direction of a pivot axis of the first operating element, the first operating element and the spring are arranged on opposite sides of the bearing shaft of the second operating element. The mentioned features contribute to a compact, soiling-resistant design.

In a preferred refinement, the actuating contour has at least one convexly curved section. In particular, the actuating contour has two convexly curved sections, wherein the spring rests against both convexly curved sections in the unactuated position of the second operating element. A clean, clearly defined return position is achieved, from which a certain amount of finger force is required to move the second operating element into the actuated position. The convex curvature ensures that the actuating force does not increase excessively as the deflection increases.

Advantageously, the first operating element is mounted so as to be able to pivot about a pivot axis between an unactuated position and an actuated position with respect to the housing, wherein the pivot axis of the first operating element and the pivot axis of the second operating element run at an angle to each other, in particular at right angles to each other. This allows for ergonomic actuation.

It can suffice to provide the second operating element with only a single operating section. In a preferred embodiment, the second operating element has at least two and in particular also three operating sections that project out of the housing. As a result, the user can easily reach at least one of the operating elements even when holding the device in a variety of different ways.

Further features of the invention will become apparent from the description and the drawing, which depicts exemplary embodiments of the invention that are described in detail hereinbelow.

### BRIEF DESCRIPTION OF THE DRAWINGS

FIG. A1 shows a perspective illustration of an embodiment of a power tool,

FIG. A2 shows a side view of a further embodiment of the power tool,

FIG. A3 shows a plan view of the power tool according to FIG. A2,

FIG. A4 shows a lateral sectional view of the power tool according to FIG. A2, along the longitudinal midplane of the housing,

FIG. A5 shows a detail from a perspective illustration from behind of the power tool with the handle housing open,

FIG. A6 shows a perspective illustration from behind of the power tool according to FIG. A2,

FIG. A7 shows a new side view of the power tool according to FIG. A2,

FIG. A8 shows a view from below of the power tool according to FIG. A2,

FIG. A9 shows a perspective, schematic view of the rechargeable battery packs for the power tool,

FIG. A10 shows a view from the behind of the power tool according to FIG. A2,

FIG. A11 shows a plan view of the power tool according to FIG. A2,

FIG. A12 shows a sectional view of the power tool according to FIG. A2, looking through the fastener from above onto the power tool,

FIG. A13 shows a detailed perspective illustration of the power tool according to FIG. A2 with only one housing half,

FIG. A14 shows a detailed perspective illustration of the fastener fastened in a housing half of the power tool according to FIG. A2,

FIG. A15 shows a side view of the power tool, showing the limiting device in detail,

FIG. A16 shows a perspective illustration of the power tool according to FIG. A2 without rechargeable battery packs, and

FIG. A17 shows a perspective illustration of a further embodiment of the power tool without protective device,

FIG. A18 shows a side view of a further embodiment of the hand-guided power tool 1 with a fixing device,

FIG. A19 shows a detailed side view of the fixing device according to FIG. A18 arranged on the rechargeable battery packs,

FIG. A20 shows a side view of the fixing device according to FIG. A18,

FIG. A21 shows an illustration from below of the fixing device according to FIG. A18, and

FIG. A22 shows a side view of a further embodiment of the fixing device,

FIG. B1 shows a perspective illustration of a power tool, using the example of a chain saw, with a first operating element for controlling a drive motor and with a second operating element for locking the first operating element,

FIG. B2 shows a perspective interior view of the region of the handle according to FIG. B1 with details of the arrangement of two operating elements,

FIG. B3 shows the arrangement according to FIG. B1 in a longitudinal sectional illustration,

FIG. B4 shows a side view of the arrangement according to FIG. B2 with further details of the arrangement of the operating elements,

FIG. B5 shows the arrangement according to FIG. B4 in a partially cross-sectional illustration,

FIG. B6 shows the arrangement according to FIG. B2 with the second operating element pivoted into the actuated position,

FIG. B7 shows the arrangement according to FIG. B3 with the second operating element pivoted into the actuated position,

FIG. B8 shows the arrangement according to FIG. B4 with the second operating element pivoted into the actuated position,

FIG. B9 shows the arrangement according to FIG. B5 with the second operating element pivoted into the actuated position,

FIG. B10 shows a rear view of the arrangement according to FIG. B2 with details of the angle range of the second operating element,

FIG. B11 shows a front view of the arrangement according to FIG. B2 with details of the position of the pivot axes of both operating elements, and

FIG. B12 shows a perspective view of a variant of the arrangement according to FIG. B2 with an enlarged housing opening and with a total of three operating sections on the second operating element.

### DETAILED DESCRIPTION

FIG. A1 shows an embodiment of a power tool 1. The hand-held power tool 1 is designed in the exemplary embodiment as a pruner. A pruner is a type of motor-operated saw, which is preferably used to cut branches and shrubs. One preferred use of a pruner is in particular removing branches from trees. In an alternative embodiment, the power tool 1 can also be designed as a hedge trimmer, blower or the like. In addition, the power tool 1 can also be designed as a power tool with a shaft, for example as a pole pruner, hedge cutter, brush cutter, grass trimmer, clearing saw or the like. The term “hand-held” is to be understood in the sense that the power tool is held by the operator during normal operation.

The power tool 1 comprises a housing 2. The power tool 1 comprises a drive motor 3. The drive motor 3 is arranged in the housing 2. Furthermore, the power tool comprises a tool, with the tool being driven by the drive motor 3. In the present exemplary embodiment, the tool is a saw chain 5. The saw chain 5 is driven in a rotary motion in a guide groove of a guide bar 4. The drive shaft of the drive motor 3 drives a drive chain sprocket, which in turn drives the saw chain 5 around the guide bar 4. As shown in FIG. A2, a transport protector 71 is pushed onto the guide bar 4, which engages around the saw chain 5 and protects against damage. The drive motor 3 is designed in the exemplary embodiment as an electric motor. The power tool 1 comprises a first rechargeable battery pack 21. The first rechargeable battery pack 21 is provided for supplying the drive motor 3 with electrical energy. The power tool 1 comprises a second rechargeable battery pack 22. The second rechargeable battery pack 22 is provided for supplying the drive motor 3 with electrical energy. The power tool 1, in particular the drive motor 3 of the power tool 1, can preferably also be operated via just one of the two rechargeable battery packs 21, 22. In the preferred exemplary embodiment, the two rechargeable battery packs 21, 22 are connected in series, however.

As shown in FIG. A1, the guide bar 4 comprises a longitudinal plane 31 spanned by the guide groove of the guide bar 4. In addition, the guide bar 4 comprises a longitudinal center axis 30. The longitudinal center axis 30 lies in the longitudinal plane 31. The longitudinal center axis 30 runs through the center of the guide bar 4, whereby the guide bar 4 in the viewing direction perpendicular to the longitudinal plane 31 of the guide bar 4 is divided by the longitudinal center axis 30 into approximately two parts of the same size. Furthermore, the guide bar 4 comprises a transverse plane 32. The transverse plane 32 is aligned orthogonal to the longitudinal plane 31 of the guide bar 4. The longitudinal center axis 30 lies in the transverse plane 32.

As shown in FIG. A1, the housing 2 has a front end 6 and a rear end 7. The guide bar 4 is arranged on the front end 6 of the housing 2. A fastening section 14 is provided on the rear end 7 of the housing 2. The fastening section 14 is provided for receiving the first rechargeable battery pack 21. The fastening section 14 is likewise provided for receiving the second rechargeable battery pack 22.

As shown in FIG. A1, the housing 2 comprises a central housing 47. The front end 6 of the housing 2 is formed on the central housing 47. The guide bar 4 projects at the front end 6 of the housing 2 out from the central housing 47 and extends in the direction from the rear end 7 of the housing 2 to the front end 6 of the housing 2. The power tool 1 comprises a guide bar fastener 75 for fastening the saw chain 5. In an operating state of the guide bar fastener 75, the guide bar 4 is held clamped on the housing 2, in particular on the central housing 47. In a released state of the guide bar fastener 75, the guide bar 4 can be moved in the direction of the longitudinal center axis 30 relative to the housing 2. The guide bar 4 can be pushed away from the housing 2 in the direction of its longitudinal center axis 30, whereby the saw chain 5 can be tensioned. If the guide bar fastener 75 is advantageously closed by means of a screw connection, the guide bar 4 is held clamped on the housing 2.

As shown in FIG. A1, the housing 2 of the power tool 1 comprises a motor housing 49. The drive motor 3 is arranged in the motor housing 49. In addition, the housing 2 comprises a handle housing 48. The power tool 1 comprises a first handle 9 on which a hand of the operator can rest. The first handle 9 is formed on the housing 2, in particular on the handle housing 48 of the housing 2. The rear end 7 of the housing 2 is preferably formed on the handle housing 48. The fastening section 14 is part of the handle housing 48. The central housing 47, the handle housing 48 and the motor housing 49 of the housing 2 are arranged adjacent to one another.

As shown in FIG. A1, the power tool 1 comprises an actuating element 10 for actuating the drive motor 3. The actuating element 10 is assigned to the first handle 9, i.e. that during normal operation of the power tool 1, the operator actuates the actuating element 10 with the hand that rests on the first handle 9. The power tool 1 comprises a, preferably mechanical, lockout lever 26. The lockout lever 26 is designed to lock the actuating element 10 in a locked position, preferably mechanically, and to release it in an operating position. If the operator wants to actuate the actuating element 10, they must first unlock the actuating element 10 by actuating the lockout lever 26. The operator can then actuate the actuating element 10 and control the drive motor 3.

As shown in FIG. A1, the power tool 1 comprises a cover clip 101. The cover clip 101 is part of the housing 2. The cover clip 101 engages around the actuating element 10 and is used to reinforce the housing 2. Furthermore, the power tool comprises a fastener 11. The fastener 11 has at least one fastening element 12 for holding the power tool 1 on the at least one fastening element 12. The operator is therefore able, for example, to fasten the power tool 1 via the fastening element 12 to a cord, whereby the power tool 1 can be secured against falling onto the ground. The particularly preferred embodiment of the power tool 1 has a protective device 80. The protective device 80 is designed such that it protects the rechargeable battery packs 21, 22 from impact loads, for example in the case of impact of the power tool 1 on the ground. Thus, damage to the rechargeable battery packs 21, 22 can be avoided.

As shown in FIG. A1, the power tool 1 comprises a second handle 57. The second handle 57 is provided for the operator's other hand to rest on. The second handle 57 is formed on the housing 2, in particular on the motor housing 3. The power tool 1 also comprises a limiting device 60. The limiting device 60 is arranged between the guide bar 4 and the second handle 57. The limiting device 60 is designed such that the operator's hand is prevented from slipping from the second handle 57 in the direction of the guide bar 4.

FIG. A2 shows a further embodiment of the power tool 1 in a side illustration. The power tool 1 comprises a center of gravity S1. The center of gravity S1 lies in the first handle 9 the power tool 1 when the power tool 1 is in a state in which the first rechargeable battery pack 21 and the second rechargeable battery pack 22 are arranged on the fastening section 14. Such a weight distribution of the power tool 1 is particularly advantageous, since the operator grasps the first handle 9, and thus also the center of gravity S1, with one of their hands when using the power tool 1 as intended. As a result, the operator can easily hold the power tool 1 easily without having to correct any tilting moments of the power tool 1. Unpleasant moments of inertia are also avoided during operation of the power tool 1. In the preferred embodiment of the power tool 1, the fastening section 14 in particular is formed on the housing 2 in such a way that the first rechargeable battery pack 21 and the second rechargeable battery pack 22 are arranged favorably on the housing 2, whereby the center of gravity S1 of the power tool 1 lies in the first handle 9.

As shown in FIG. A2, the first handle 9 extends along a longitudinal direction 35. The longitudinal direction 35 of the first handle 9 corresponds to the direction of a longitudinal center axis 54 of the first handle 9. The first handle 9 comprises a grip region 53, in which the handle 9 can be grasped all the way around. In this grip region 53, the handle 9, in particular the handle housing 48, is designed in the form of a cylinder. The axis of the cylinder corresponds to the longitudinal center axis 54 of the first handle 9. The handle 9 itself extends along its longitudinal center axis from a rear end 77 up to its front end 76. The rear end 77 faces the rear end 7 of the housing 2. The front end 76 faces the front end 6 of the housing 2. The front end 6 of the handle 9 is determined by the section on the handle housing 48 at which the handle 9 can still be fully grasped by the operator's hand. The front end 6 is represented by a dashed line, along which the operator's index finger can grasp the handle housing 48. As shown in FIG. A2, the center of gravity S1 of the power tool 1 is thus right in front of the front end 6 of the handle 9, so that the operator's index finger can grasp the center of gravity S1 of the power tool 1 when operating the power tool 1 as intended. The rear end 77 of the handle 9 is formed in the present exemplary embodiment by a projection 78 with respect to the grip surface of the handle 9. In the present embodiment, the protective device 80 adjoins the projection 78.

As shown in FIG. A2, the transverse plane 32 of the guide bar 4 divides the housing 2 into an upper section 36 and into a lower section 37. The drive motor 3 is arranged with its center of gravity SM in the upper section 36. The center of gravity S1 of the power tool 1 lies in the lower section. Furthermore, a position vector g is shown in FIG. A2, as well as a horizontal, flat ground 112. The longitudinal center axis 30 of the guide bar 4 lies in a plane that is aligned parallel to the ground 112. The first rechargeable battery pack 21 and the second rechargeable battery pack 22 are also arranged in the lower section. The first rechargeable battery pack 21 has a center of gravity SA1. The second rechargeable battery pack 22 has a center of gravity SA2. The centers of gravity SA1, SA2 of the two rechargeable battery packs 21, 22 are arranged in the lower section 37 of the housing 2. The centers of gravity SA1, SA2 of the rechargeable battery packs 21, 22 therefore form a weight counterbalance to the center of gravity SM of the drive motor 3. In the exemplary embodiment, the fastening section 14 of the housing 2 also lies in the lower section 37 of the power tool 1.

As shown in FIG. A3, the power tool 1 comprises a longitudinal midplane 43. The longitudinal midplane 43 runs parallel to the longitudinal plane 31 of the guide bar 4 and bisects the housing 2. The housing 2 preferably has two housing halves—a first housing half 15 and a second housing half 16. Preferably, the parting plane of the first housing half 15 and the second housing half 16 corresponds to the longitudinal midplane 43 of the power tool 1.

As shown in FIG. A3, the centers of gravity SA1, SA2 of the rechargeable battery packs 21, 22 are preferably arranged on the longitudinal midplane 43. The power tool 1 is configured in such a way that the center of gravity S1 of the power tool 1 lies on the longitudinal midplane 43. The drive motor 3 is arranged in the housing 2, in particular in the motor housing 49, in such a way that the center of gravity SM of the drive motor 3 also lies in the longitudinal midplane 43 of the power tool 1. For this purpose, the drive motor 3 is aligned in such a way that its rotational axis 33 (FIG. A4) is parallel to the longitudinal plane 31 of the guide bar 4 or preferably lies in the longitudinal plane 31 of the guide bar 4. In the exemplary embodiment, the rotational axis 33 lies in the longitudinal midplane 43 of the power tool 1.

As shown in FIG. A4, the fastening section 14 is designed such that the rechargeable battery packs 21, 22 can be inserted in an insertion direction 34 into the fastening section 14. The insertion direction 34 corresponds preferably substantially to the longitudinal direction 35 of the first handle 9. To fasten the rechargeable battery packs 21, 22 in the fastening section 14 of the housing 2, they should be introduced in the insertion direction 34 until they make contact with a stop element 23, 24. The first stop element 23 of the fastening section 14 limits the movement of the first rechargeable battery pack 21 in the insertion direction 34. The second stop element 24 limits a movement of the second rechargeable battery pack 22 in the insertion direction 34. In the preferred exemplary embodiment, a latching connection is provided between the fastening section 14 and the rechargeable battery pack 21, 22, which latches into place when the rechargeable battery packs 21, 22 are inserted. Each rechargeable battery pack 21, 22 is provided with are two unlocking elements 111 (FIG. A2), the actuation of which releases the latching connection between the rechargeable battery pack 21, 22 and the fastening section 14. The rechargeable battery pack 21, 22 can be removed again.

As shown in FIG. A2, the fastening section 14 is designed such that the first rechargeable battery pack 21 and the second rechargeable battery pack 22 are arranged offset from one another in the direction of the longitudinal center axis 30 of the guide bar 4. The second rechargeable battery pack 22 lies, measured in the direction of the longitudinal center axis 30 of the guide bar 4, closer to the front end 6 of the housing 2 than the first rechargeable battery pack 21. Therefore, when the power tool 1 is in the state in which the first rechargeable battery pack 21 and the second rechargeable battery pack 22 are inserted, a distance a, measured in the direction of the longitudinal center axis 30, between the center of gravity SA1 of the first rechargeable battery pack 21 and the center of gravity S1 of the power tool 1 is greater than a distance b, measured in the longitudinal direction 30, between the center of gravity SA2 of the second rechargeable battery pack 22 and the center of gravity S1 of the power tool 1. Particularly preferably, the distance b corresponds to at most 90%, in particular at most 80% of the distance a.

As shown in FIG. A2, in the preferred exemplary embodiment, the first rechargeable battery pack 21 and the second rechargeable battery pack 22 are arranged offset from one another perpendicularly to the transverse plane 32 of the guide bar 4. Therefore, the fastening section 14 is designed such that when the power tool 1 is in a state in which the first rechargeable battery pack 21 and the second rechargeable battery pack 22 are inserted, a distance c, measured perpendicularly to the transverse plane 32, between the center of gravity SA1 of the first rechargeable battery packs 21 and the center of gravity S1 of the power tool 1 is smaller than a distance d, measured perpendicularly to the transverse plane 32, between the center of gravity SA2 of the second rechargeable battery pack 22 and the center of gravity S1 of the power tool 1. The distance c corresponds to at most 90% of the distance d.

As shown in FIG. A4, the actuating element 10 is arranged on the first handle 9 of the power tool 1. A distance q is provided between the actuating element 10 and the center of gravity S1 of the power tool 1, with the distance q in the exemplary embodiment not being greater than 3 cm, preferably not greater than 2 cm, in particular not greater than 1 cm. This means when the operator grasps the first handle 9 and actuates the actuating element 10, they also at least partially grasps the center of gravity S1 of the power tool 1. The center of gravity S1 of the power tool 1 in the preferred exemplary embodiment is between the second handle 57 and the actuating element 10.

As shown in FIG. A4, in the preferred embodiment of the power tool 1, the lockout lever 26 is arranged in the handle housing 48. In the exemplary embodiment, the lockout lever 26 is arranged outside the handle 9 (FIG. A2). The lockout lever 26 has a distance r from the center of gravity S1 of the power tool 1, in which case the distance r is not greater than 3 cm, preferably not greater than 2 cm, in particular not greater than 1 cm.

As shown in FIG. A4, in the preferred exemplary embodiment, the actuating element 10 is designed as a pivotable lever. The actuating element 10 is mounted so as to be able to pivot about a first pivot axis 38 with respect to the housing 2. The first pivot axis 38 is preferably aligned perpendicularly to the longitudinal plane 31 of the guide bar 4. The actuating element 10 comprises an outer contour 25. The outer contour 25 has a maximum first radius r1 with respect to the first pivot axis 38. In other words, the maximum first radius r1 corresponds to the maximum, radial extent of the actuating element 10 with respect to the first pivot axis 38. The actuating element 10 is arranged in the handle 9 in such a way that the maximum first radius r1 is greater than the distance e between the center of gravity S1 of the power tool 1 and the first pivot axis 38 of the actuating element 10. Thus, the center of gravity S1 of the power tool 1 lies very close to the pivot axis 38 of the actuating element 10.

As shown in FIG. A5, the lockout lever 26 is also designed as a pivotable lever. The lockout lever 26 is mounted so as to be able to pivot about a second pivot axis 39 with respect to the housing 2. The pivot axis 39 of the lockout lever 26 preferably lies in a plane aligned parallel to the longitudinal plane 31 of the guide bar 4. The pivot axis 39 of the lockout lever 26 preferably lies in the longitudinal midplane 43 of the housing 2. The lockout lever 26 has an outer contour 27, wherein the outer contour 27 has a maximum second radius r2 with respect to the second pivot axis 39. The maximum second radius r2 is greater than a distance f between the center of gravity S1 of the power tool 1 and the second pivot axis 39. Thus, the center of gravity S1 lies in the viewing direction of the second pivot axis 39 of the lockout lever 26 inside the maximum second radius r2 of the lockout lever 26. During normal operation of the power tool 1, it is provided that the operator actuates the lockout lever 26 by means of their thumb. The position of the center of gravity S1 of the power tool 1 now means that the operator grasps the center of gravity S1 with both their thumb and with their index finger. Consequently, the operator grips the power tool 1 directly at the center of gravity S1, thereby ensuring particularly ergonomic handling of the power tool 1.

FIGS. A6 and A7 show the exemplary embodiment of the power tool 1 according to FIG. A2. The view according to FIG. A2 of the power tool 1 is shown again in FIG. A7 for reasons of better clarity.

As shown in FIG. A6 and 7, the first handle 9 comprises a first handle section 55 on which the operator's hand can rest, in particular for grasping the first handle 9. The handle section 55 has a top side 51 and a bottom side 52 facing away from the top side 51. The top side 51 of the handle section 55 faces away from the actuating element 10. The bottom side 52 of the handle section 55 faces the actuating element 10. Preferably, the actuating element 10 is arranged in the housing 2 in such a way that the actuating element projects out of the housing 2 directly at an opening in the bottom side 52 of the handle section 55.

As shown in FIGS. A6 and A7, the cover clip 101 extends from its first end 103 to its second end 104 along the bottom side 52 of the first handle section 55. In the exemplary embodiment, the cover clip 101 extends substantially parallel to the bottom side 52 of the first handle section 55. The actuating element 10 is thus arranged between the handle 9, in particular the handle section 55, and the cover clip 101. The first front end 103 of the cover clip 101 is directly adjacent to the motor housing 49 and to the central housing 47 of the housing 2. The cover clip 101 separates the handle housing 48 from the motor housing 49 and the central housing 47. The second end 104, i.e. the rear end of the cover clip 101, leads into the handle housing 48 of the housing 2, in particular into the fastening section 14 of the handle housing 48. The handle housing 48 and the cover clip 101 form an opening 110, through which the operator's fingers can reach when they grip the handle section 55. The cover clip 101 serves to reinforce the housing 2. In particular, if great forces and torques are acting on the housing 2, it is particularly advantageous that owing to the cover clip 101 the corresponding loads are also absorbed via the cover clip 101, thus avoiding damage to the housing 2. Advantageously, the cover clip 101 is designed integrally with the central housing 47 and/or the handle housing 48.

As shown in FIG. A6, the cover clip 101 has a taper 102 in the direction of its second end 104. The taper 101 allows the operator to fasten the power tool 1 via a carabiner 113 or another locking element to a carrying device. The carabiner 113 is schematically illustrated in FIG. A6 by dashed lines.

As shown in FIG. A8, the cover clip 101 extends in the direction perpendicular to the longitudinal plane 31 of the guide bar 4 from a first longitudinal side 108 of the power tool 1 to a second longitudinal side 109 of the power tool 1. The cover clip 101 comprises a maximum width k, measured perpendicularly to the longitudinal plane 31, which corresponds to the maximum distance between the first longitudinal side 108 of the power tool 1 and the second longitudinal side 109 of the power tool 1. Furthermore, the cover clip 101 has a minimum width l at its taper 102, with the minimum width l of the taper 102 corresponding to the minimum distance between the first longitudinal side 108 and the second longitudinal side 109. The minimum width l corresponds to at most 70%, preferably at most 60%, in particular approximately 50% of the maximum width k of the cover clip 101. In the preferred exemplary embodiment, the minimum width l of the cover clip 101 at the taper 102 corresponds to at least 10%, preferably at least 20%, particularly preferably at least 30%, preferably at least 40% of the maximum width k of the cover clip 101.

As shown in FIG. A8, the lockout lever 26 is arranged between the first longitudinal side 108 and the second longitudinal side 109 of the cover clip 101 in the direction perpendicular to the longitudinal plane 31 of the guide bar 4. The lockout lever 26 is preferably designed and arranged in the housing 2 in such a way that it does not project beyond either the first longitudinal side 108 nor the second longitudinal side 109 at the broadest point of the cover clip 101 in the direction perpendicular to the longitudinal plane 31 of the guide bar 4. The outer contour 27 of the lockout lever 26 is arranged completely between the first longitudinal side 108 and the second longitudinal side 109 of the cover clip 101 in the direction perpendicular to the longitudinal plane 31 of the guide bar 4, at least in the region of the first end 103 of the cover clip 101. The outer contour 27 of the lockout lever 26 extends perpendicularly to the longitudinal plane 31 of the guide bar 4, measured over a maximum width m, wherein the maximum width m of the outer contour 27 is less than the maximum width k of the cover clip 101. The lockout lever 26 is preferably rotatably mounted and has two actuating sections for left-side and right-side use.

As shown in FIGS. A6 and A7, the housing 2 comprises a bridge 107. The bridge 107 extends from the first handle section 55 to the cover clip 101. The bridge extends preferably from the bottom side 52 of the first handle section 55 to a top side 105 of the cover clip 101. The top side 105 of the cover clip 101 faces the bottom side 52 of the first handle section 55. In addition, the cover clip 101 comprises a bottom side 106 facing away from the top side 105. The bridge 107 divides the opening 110 bounded by the handle 9 and the cover clip 101 into a first opening 110′ and a second opening 110″. The actuating element 10 is arranged between the bridge 107 and the first end 103 of the cover clip 101. The actuating element 10 projects into the first opening 110′. The taper 102 of the cover clip 101 is arranged between the bridge 107 and the second end 104 of the cover clip 101. Therefore, the taper 102 of the cover clip 101 partially bounds the second opening 110″.

As shown in FIG. A7, the cover clip 101 has a length n. The length n corresponds to the distance, measured in the longitudinal direction 35 of the first handle 9, between the first end 103 of the cover clip 101 and the second end 104 of the cover clip 101. Furthermore, a distance p, measured in the longitudinal direction 35 of the first handle 9, between the bridge 107 and the first end 103 of the cover clip 101 corresponds to at most 50%, in particular at most 40% of the length n of the cover clip 101. A distance o, measured in the longitudinal direction 35 of the first handle 9, between the bridge 107 and the second end 104 of the cover clip 101 corresponds to at least 40%, preferably at least 50% of the length n of the cover clip 101.

As also shown in particular in FIG. A6, the hand-held power tool 1 comprises the protective device 80 to protect the rechargeable battery packs 21, 22. The protective device 80 is arranged on the fastening section 14 of the rechargeable battery packs 21, 22.

As shown in FIG. A9, the first rechargeable battery pack 21 extends in its longitudinal direction 85 (FIG. A7, FIG. A9) from a first end face 86 to a second end face 87. The second rechargeable battery pack 22 also extends in its longitudinal direction 85′ from a first end face 86′ to a second end face 87′. The rechargeable battery packs 21, 22 preferably have a substantially triangular cross-sectional contour 88, 88′ with rounded corners 99, 99′. The rechargeable battery packs 21, 22 also have a shoulder 100, 100′ that serves as a stop when the rechargeable battery packs 21, 22 are being slid into the fastening section 14 of the power tool 1. A cross-sectional area of the rechargeable battery packs 21, 22 in a region between the second end face 87, 87′ and the shoulder 100, 100′ is greater than a cross-sectional area of the rechargeable battery packs 21, 22 in a region between the shoulder 100, 100′ and the first end face 86, 86′. When the power tool 1 is in a state in which the rechargeable battery packs 21, 22 are installed in the fastening section 14, the first end face 86, 86′ of the rechargeable battery packs 21, 22 faces the fastening section 14. The second end face 87, 87′ of the rechargeable battery packs 21, 22 faces away from the fastening section 14. When the rechargeable battery packs 21, 22 are inserted, the second end faces 87, 87′ form the free end faces of the rechargeable battery packs 21, 22. By contrast, when the rechargeable battery packs 21, 22 are inserted, the first end faces 86, 86′ are concealed by the fastening section 14. The first rechargeable battery pack 21 and the second rechargeable battery pack 22 each have a longitudinal axis 50, 50′ running in the longitudinal direction 85, 85′ of the respective rechargeable battery pack 21, 22. The longitudinal axes 50, 50′ of the rechargeable battery packs 21, 22 run along the centroidal axes of the cross-sectional planes of the rechargeable battery pack 21, 22, which are aligned approximately parallel to the end faces 86, 86′, 87, 87′. The first rechargeable battery pack 21 and the second rechargeable battery pack 22 are preferably of identical construction. Furthermore, FIG. A9 also indicates the unlocking elements 111, 111′ of the rechargeable battery packs 21, 22 for locking and unlocking the latching connection between the rechargeable battery packs 21, 22 and the fastening section 14.

As shown in FIGS. A6 and A7, the protective device 80 comprises at least one first cover element 81. The at least first cover element 81 extends in the longitudinal direction 85 of the first rechargeable battery pack 21 in the installed state at least to the second end face 87 of the first rechargeable battery pack 21. The longitudinal direction 85, 85′ of the rechargeable battery packs 21, 22 corresponds in the installed state preferably to the insertion direction 35 the rechargeable battery packs 21, 22, in particular the longitudinal direction 43 of the first handle 9. The protective device 80 comprises a second cover element 82. The second cover element 82 extends in the longitudinal direction 85′ of the second rechargeable battery pack 22 in the installed state of the rechargeable battery pack 22 at least to the second end face 87′ of the second rechargeable battery pack 22.

As shown in FIG. A6 to A8, the rechargeable battery packs 21, 22 are slid into the fastening section 14. In one preferred embodiment, in the installed state of the rechargeable battery packs 21, 22, the longitudinal axes 50, 50′ lie in the longitudinal midplane 43 of the housing 2. In the preferred exemplary embodiment, the longitudinal axes 50, 50′ of the rechargeable battery packs 21, 22 are arranged parallel to the longitudinal plane 31 of the guide bar 4. As shown in particular in FIG. A7, in the installed state of the rechargeable battery packs 21, 22, the rechargeable battery packs 21, 22 are arranged offset from one another in their longitudinal direction. The second end faces 87, 87′ of the rechargeable battery packs 21, 22 lie in different planes. In a transverse direction 91, the rechargeable battery packs 21, 22 are arranged one above the other. The transverse direction 91 is aligned perpendicular to the longitudinal direction 85 of the first rechargeable battery pack 21 and/or to the longitudinal direction 85′ of the second rechargeable battery pack 22. The transverse direction 91 is in a plane that is aligned parallel to the longitudinal midplane 43 of the housing 2. In the preferred exemplary embodiment, in the installed state the rechargeable battery packs 21, 22, the longitudinal axes 50, 50′ of the rechargeable battery packs 21, 22 are aligned parallel to one another. As schematically indicated in FIG. A7, it may also be expedient if the fastening section 14 is designed in such a way that, in the installed state of the rechargeable battery packs 21, 22, the longitudinal axes 50, 50′ of the rechargeable battery packs 21, 22 are arranged at an angle to one another. The second rechargeable battery pack 22 is schematically illustrated by a dashed line.

In the preferred exemplary embodiment, the longitudinal axes 50, 50′ of the two rechargeable battery packs 21, 22 lie in a plane that is aligned parallel to the longitudinal midplane 43 of the housing 2. Preferably, the longitudinal axes 50, 50′ of the two rechargeable battery packs 21, 22 lie in the longitudinal midplane 43 of the housing 2.

As shown in particular in FIG. A10, the protective device 80 comprises a third cover element 83 and a fourth cover element 84. As shown in FIGS. A7 and A8, in the preferred exemplary embodiment, the third cover element 83 and/or the fourth cover element 84 extends in the longitudinal direction 85, 85′ of the rechargeable battery packs 21, 22 at least to the second end face 87, 87′ of the rechargeable battery packs 21, 22. As shown in FIG. A10, the first cover element 81 is arranged on a rounded corner 99 of the first rechargeable battery pack 21 that faces away from the second rechargeable battery pack 22. The second cover element 82 is arranged on a rounded corner 99′ of the second rechargeable battery pack 22 that faces away from the first rechargeable battery pack 21. Preferably, the first cover element 81 and the second cover element 82 are each designed to be symmetrical to the longitudinal midplane 43.

As shown in FIG. A7, the third cover element 83 and the fourth cover element 84 are arranged in a transverse direction 91 between the rechargeable battery packs 21, 22 (FIG. A7). As shown in FIG. A10, the third cover element 83 and the fourth cover element 84 are formed opposite one another in relation to a plane aligned parallel to the longitudinal plane 31 of the guide bar, in particular in relation to the longitudinal midplane 43. Particularly preferably, the third cover element 83 and the fourth cover element 84 are designed to be symmetrical to one another in relation to the longitudinal midplane 43.

As shown in FIG. A6 and 7, the protective device 80 has cutouts 90 between the cover elements 81, 82, 83, 84 for gripping the rechargeable battery packs 21, 22. In particular, the unlocking elements 111, 111′ are freely accessible in the cutouts 90 to the operator, whereby the unlocking elements 111, 111′ can be actuated by the operator and the rechargeable battery packs 21, 22 can be pulled out of the fastener 14.

As shown in FIGS. A4 and A10, movement gaps 92 are provided between the cover elements 81, 82, 83, 84 and the rechargeable battery packs 21, 22. The movement gaps 92 taper in the direction of the first end face 86, 86′ of the rechargeable battery packs 21, 22. The rechargeable battery packs 21, 22 are particularly well protected by the movement gaps 92, since the cover elements 81, 82, 83, 84 in the region of the movement gaps 92 are elastically deformed when force is applied to the protective device 80 and in the process the energy applied to the protective device 80 can dissipate, without any force being applied to the rechargeable battery packs 21, 22.

As shown in FIG. A11, the first cover element 81 and/or the second cover element 82 of the protective device 80 has a width i measured perpendicularly to the longitudinal plane 31 of the guide bar 4. The width i corresponds to at least 30%, preferably at least 50% of the width j—measured perpendicular to the longitudinal plane 31 of the guide bar 4—of the first rechargeable battery pack 21 and/or the second rechargeable battery pack 22.

As shown in FIG. A7, the third cover element 83 and/or the fourth cover element 84 comprise a rear protective contour 93 and a front protective contour 94. The rear protective contour 93 is adjacent in the longitudinal direction 85 of the first rechargeable battery pack 21 to the second end face 87 of the first rechargeable battery pack 21 and the front protective contour 94 is adjacent in the longitudinal direction 85′ of the second rechargeable battery pack 22 to the second end face 87′ of the second rechargeable battery pack 22. The front protective contour 93 is connected to the rear protective contour 94 via a shoulder 95. The mutually facing inner faces of the rechargeable battery packs 21, 22 are protected by the third cover element 83 and the fourth cover element 84.

As shown in FIG. A10, the third cover element 83 and/or the fourth cover element 84 have an outer face 97, 97′ facing away from the rechargeable battery packs 21, 22. The outer face 97, 97′ has a concave curvature 98, 98′. The concave curvature 98, 98′ projects between the rechargeable battery packs 21, 22. As a result, the contours of the third cover element 83 and the fourth cover element 84 follow the outer contour of the rechargeable battery packs 21, 22, thereby guaranteeing that the rechargeable battery packs 21, 22 are better protected.

Several illustrations of the power tool 1 according to FIG. A2 are shown in FIGS. A12 to A14, in which the fastener 11 is shown. The fastener 11 is used to secure the power tool 1 and to protect it from being accidentally dropped by the operator. Thus, for example, the power tool 1 can be fastened via the fastener 11 to an end of a cord, while the other end of the cord is held, for example, on a carrying device of the operator. If the operator drops the power tool, it is secured via the cord, thus preventing the power tool 1 from hitting the ground.

As shown in FIGS. A12 to A14, in the preferred exemplary embodiment the fastener 11 is arranged on the handle housing 48 of the housing 2. The fastener 11 has at least one first fastening element 12 for holding the power tool 1 on the first fastening element 12. In the preferred exemplary embodiment, the fastener 11 has a second fastening element 13 for holding the power tool 1 on the second fastening element 13. The fastener 11 is designed such that the power tool 1 can be held on the first fastening element 12 and/or on the second fastening element 13. In the preferred exemplary embodiment, the fastening elements 12, 13 are designed as eyelets. Other configurations of the fastening elements 12 may also be expedient.

As shown in particular in FIG. A12, the fastener 11 is designed such that the fastening elements 12, 13 are outside of the housing 2. The fastener 11 is designed such that the fastening elements 12, 13 are accessible to the operator. The first fastening element 12 is arranged on the first housing half 15 of the housing 2. The second fastening element 13 of the fastener 11 is arranged on the second housing half 16 of the housing 2.

As shown in particular in FIG. A12, the housing 2 has a first longitudinal outer side 28 and a second longitudinal outer side 29. The longitudinal outer sides 28, 29 are arranged opposite one another with respect to a plane aligned parallel to the longitudinal plane 31 of the guide bar 4, in particular with respect to the longitudinal midplane 43. The first fastening element 12 is arranged on the first longitudinal outer side 28 of the housing 2. The second fastening element 13 is arranged on the second longitudinal outer side 29 of the housing 2.

As shown in FIG. A12, the fastener 11 comprises a base body 44. The base body 44 of the fastener 11 is flat, as shown in FIG. A12 to 14. The base body 44 can alternatively also have another form, for example, curved, bulging or similar. The base body 44 extends in a longitudinal direction 45 from a first longitudinal end 46 up to a second longitudinal end 46′. As shown in FIG. A12, a fastening element 12, 13 is formed on at least one of the two longitudinal ends 46, 46′, preferably on both longitudinal ends 46, 46′ of the base body 44. Preferably, in each case a fastening element 12, 13 is formed on each longitudinal end 46, 46′. The longitudinal direction 45 of the base body 44 is aligned approximately perpendicular to the longitudinal plane 31 of the guide bar 4. As shown in FIG. A12, wing-like projections 19, 20 are provided on the base body 44, with the wing-like projections 19, 20 being arranged between the fastening elements 12, 13. The wing-like projections 19, 20 of the base body 44 extend transversely to the longitudinal direction 45 of the base body 44.

As shown in FIG. A12 to 14, the fastener 11 is arranged in the fastening section 14 of the housing 2. The fastener 11 is held between the first housing half 15 and the second housing half 16. In the preferred exemplary embodiment according to FIGS. A12 to A14, the fastener 11, in particular the base body 44 of the fastener 11, is held in a form-fitting manner between the first housing half 15 and the second housing half 16. The two housing halves 15, 16 form a slot-like recess 17, in which the fastener 11 is held with a form fit. In an alternative embodiment, it may also be expedient to fasten the base body 44 in the housing 2 in some other way, for example glue it in, etc. The fastener 11 is particularly preferably arranged between the first rechargeable battery pack 21 and the second rechargeable battery pack 22. The fastener 11, in particular the base body 44 of the fastening section 14, is made as a single part, whereby high forces can be transmitted via the base body to the housing 2. The wing-like projections 19, 20 are advantageous in particular when absorbing tilting moments of the base body 44 around the longitudinal axis 45 of the base body 44.

If the power tool 1 is caught by a cord or by the fastener 11 in the event of a fall, high forces must be transmitted from the fastener 11 to the housing 2. This creates high loads on the housing 2. Therefore, a mechanical connection, in particular a screw connection 18, is provided close to the fastener 11 for connecting the first housing half 15 and the second housing half 16. The distance between the mechanical connection and the fastener 11 in the exemplary embodiment is less than 3 cm, preferably less than 2 cm, particularly preferably less than 1 cm. As a result, the forces transmitted by the fastener 11 to the housing halves 15, 16 of the housing 2 can be supported by the mechanical connection. Provision can also be made to provide several mechanical connections close to the fastener 11.

As shown in FIG. A2, the fastener 11 is arranged between the rear end 7 of the housing 2 and the center of gravity S1 of the power tool 1. If the power tool 1 hangs via its fastener 11 on a cord, for example, then the front end 6 of the power tool 1, in particular its guide bar 4, points in the direction of the ground. Consequently, the operator can easily grip the power tool 1 from above.

As shown in FIG. A15, the second handle 57 of the housing 2 has a second handle section 58 on which the operator's other hand can rest. The second handle section 58 is formed on the motor housing 49 of the housing 2. The second handle section 58 is formed from a bearing surface of the motor housings 49 that extends in a longitudinal direction 59 of the second handle section 58 from a rear end 73 to a front end 72 of the handle section 58. The bearing surface has approximately the shape of a cylinder segment over its entire length, wherein the direction of the cylinder axis corresponds to the longitudinal direction of the second handle section 58. The diameter of the cylinder corresponds to approximately the width of the motor housing 49 measured perpendicularly to the longitudinal plane 31. The cylinder segment corresponds to approximately a half cylinder. In an alternative embodiment (not shown in more detail) of the power tool 1, it can also be provided that hollow-like depressions are formed on the bearing surface of the handle section 58, said depressions being provided to support and for the ergonomic positioning of the individual fingers.

As shown in FIG. A15, the limiting device 60 is provided between the second handle section 58 and the guide bar 4. The limiting device 60 has an elevation 61 with respect to the second handle section 58, said elevation extending at least within the longitudinal plane 31 of the guide bar 4. In the viewing direction perpendicular to the longitudinal plane 31 of the guide bar 4, the elevation 61 extends, starting from the handle section 58, perpendicularly to the longitudinal direction 59 of the handle section 58 away from the handle section 58. The elevation 61 is designed such that the operator's hand is prevented from slipping from the second handle section 58 in the direction of the guide bar 4. The elevation 61 is designed such that the elevation 61 forms a form-fitting stop in the direction of the guide bar 4 for the operator's hand that is resting on the second handle section 58.

As shown in FIG. A15, in the viewing direction perpendicular to the longitudinal plane 31 of the guide bar 4, the limiting device 60 has an outer contour 62. The outer contour 62 of the limiting device 60 has a first end 63 adjoining the second handle section 58 and a second end 64 adjacent to the guide bar 4. The elevation 61 is formed on the first end 63 of the outer contour 62. The elevation 61 consequently extends from the first end 63 of the outer contour 62 in the direction away from the handle section 58. The elevation 61 has a contact section 65. The contact section 65 is provided to support the operator's hand which rests on the second handle section 58. The contact section 65 of the elevation is designed such that the hand resting on the second handle section 58 comes into contact, in particular form-fitting contact, with the contact section 65 if the hand moves in the longitudinal direction 59 of the second handle section 58. The contact section 65 of the elevation 61 thus forms a stop towards the guide bar 4 for the hand resting on the second handle 57 in the longitudinal direction 59 of the second handle section 59. The contact section 68 is concave. The contact section 65 forms an undercut for a hand of the operator resting on the contact section 65. If the operator's hand is in contact with the contact section 65 and the hand moves, in the viewing direction perpendicular to the longitudinal plane 31, perpendicularly to the longitudinal direction 59 away from the handle section 58, the operator's hand is caught on the contact section 65 due to the undercut of the bearing surface 65. The contact section 65 has the form of a hollow, into which the operator's hand resting on the second handle section 58 of the second handle 57 molds itself when moving in the longitudinal direction 59 of the handle section 58.

As shown in FIG. A15, an edge 68 is formed on the contact section 65. The edge 68 is formed by a channel 69. The channel 69 forms the housing boundary between the motor housing 49 and the central housing 47. The power tool 1 comprises a lubricant tank 70 for supplying the saw chain 5 with lubricant. The lubricant tank 70 is part of the housing 2, in particular part of the central housing 47. The limiting device 60 is preferably formed at least partially from the wall of the lubricant tank 70.

As shown in FIG. A15, in the viewing direction perpendicular to the longitudinal plane 31 of the guide bar 4, the elevation 61 has a height h measured perpendicularly to the longitudinal direction 59 of the second handle section 58 at the first end 63 of the outer contour 62. The height h corresponds to at least 15%, in particular at least 20%, preferably approximately 25% of a length l, measured in the longitudinal direction 59 of the second handle section 58, of the second handle section 58. The length l corresponds to the distance between the front end 72 and the rear end 73 of the handle section 58.

As shown in FIG. A15, the concave contact section 65 ends at a further edge 74 of the elevation 61. At this further edge 74, the elevation 61 has its maximum height in relation to the handle section 58. The contact section 65 is designed such that, in the viewing direction perpendicular to the longitudinal plane 31 of the guide bar 4, a tangent 75 to the contact section 65 at the edge 74 intersects a straight line in the direction of the longitudinal direction 59 of the second handle section 58 at an angle α. The angle α is open towards the second handle section 58 and is at most 90°, preferably at most 80°, in particular approximately 75°. Preferably, the angle α is more than 30°.

As shown in FIG. A15 shown, the housing 2 in the region of the second handle section 58 is open towards the top. Therefore, in the viewing direction perpendicular to the longitudinal plane 31 of the guide bar 4, the housing 2 is open in the direction perpendicular to the longitudinal direction 59 of the second handle section 58, away from the handle section 58. Thus, the operator can easily the second handle section 58 from above. In an alternative embodiment not shown in more detail, the contact section 65 is provided with an anti-slip coating. In a preferred embodiment, a grip detector (not shown in more detail) is provided on the second handle 57. The grip detector can be mechanical and/or electrical and/or electronic. An electronic grip detector is preferably in the form of a resistive, capacitive or inductive grip detector. The mechanical and/or electrical signal of such a grip position detector can be used as an enable signal for actuating the drive motor 3. Such a signal can also be used in conjunction with a dead man's switch. The person skilled in the art can use such a signal in various ways for functions known from the prior art.

FIG. A16 shows the power tool with the rechargeable battery packs 21, 22 having been removed. Thus, the rechargeable battery packs 21, 22 can be charged in external charging stations and then inserted back into the power tool 1.

As shown in particular in FIG. A16, raised elements 114 can be provided on the lubricant tank 70. The raised elements 114 form elevations starting from the lubricant tank 70. In the present exemplary embodiment, three raised elements 114 are provided. In the present case, the raised elements 114 have a substantially triangular outer contour with respect to the viewing direction perpendicular to the longitudinal plane 31 of the guide bar 4. Other outer contours may also be expedient. In the preferred exemplary embodiment, the raised elements 114 are arranged one behind the other in series with respect to the direction of the longitudinal center axis 30. The three raised elements 114 lie in the longitudinal midplane 43. Other arrangements on the top side of the lubricant tank 70 may also be expedient.

As likewise shown in FIG. A16, the power tool 1 preferably comprises a connection unit 115. The connection unit 115 is designed to store, send and/or receive data to/from the power tool 1. Such data can be, for example, the overall run time of the power tool 1. If a predetermined threshold for the run time is reached, the operator can be informed that maintenance is required. Furthermore, the position of the power tool 1 can also be determined and communicated to other devices via the connection unit 115.

An alternative embodiment of the power tool 1 is shown in FIG. A17. This embodiment differs from the power tool 1 according to the previous figures merely in that no protective device 80 is provided for the rechargeable battery packs 21, 22. Therefore, the housing 2 ends with the fastening section 14, into which the rechargeable battery packs 21, 22 are inserted.

A further embodiment of the electrical, hand-guided power tool 1 is shown in FIGS. A18 to A22. The same reference signs show the same components of the power tool 1. The hand-held power tool 1 comprises the housing 2 and the drive motor 3 arranged in the housing 2, wherein the fastening section 14 for receiving the first rechargeable battery pack 21 for supplying the drive motor 3 with electrical energy is provided on the rear end 7 of the housing 2. Furthermore, the power tool 1 comprises at least the first rechargeable battery pack 21 and in particular the second rechargeable battery pack 22, with the first rechargeable battery pack 21 and in particular the second rechargeable battery pack 22 being held on the fastening section 14. The first rechargeable battery pack 21 and in particular the second rechargeable battery pack 22 extend in their longitudinal direction 85, 85′ from their first end face 86, 86′ to their second end face 87, 87′, wherein the first end face 86, 86′ of the first rechargeable battery pack 21 and in particular the second rechargeable battery pack 22 faces the fastening section 14 and the second end face 87, 87′ of the first rechargeable battery pack 21 and in particular the second rechargeable battery pack 22 faces away from the fastening section 14. The power tool 1 comprises a fixing device 130, wherein the fixing device 130 engages at least partially around the second end face 87 of the first rechargeable battery pack 21 and in particular of the second rechargeable battery pack 22, wherein the fixing device 130 is releasably held on the housing 2, in particular on the fastening section 14.

As shown in FIG. A19, the fixing device 130 comprises a first fixing section 131 and a second fixing section 132. The first fixing section 131 forms a receiving space in which the first rechargeable battery pack 21 is arranged. The fixing device 130 bears with its first fixing section 131 against the second end face 87 of the first rechargeable battery pack 21 and in particular against the longitudinal side of the first rechargeable battery pack 21. The second fixing section 132 forms a further receiving space in which the second rechargeable battery pack 22 is arranged. The fixing device 130 bears with its second fixing section 132 against the second end face 87′ of the second rechargeable battery pack 22 and in particular against the longitudinal side of the second rechargeable battery pack 22. The second end face 87 of the first rechargeable battery pack 21 is covered by the first fixing section 131 at least partially. The second end face 87′ of the second rechargeable battery pack 22 is covered by the second fixing section 132 at least partially. In an alternative embodiment of the power tool 1, it can also be provided that the second end faces 87, 87′ of the two rechargeable battery packs 21, 22 are completely covered by the fixing sections 131, 132.

As shown in FIG. A19, the fixing device 130 comprises a middle section 133. The first fixing section 131 and the second fixing section 132 are connected to one another via the middle section 133. In the present embodiment, the fixing device 130 extends in the longitudinal direction 85, 85′ of the rechargeable battery packs 21, 22 merely in the region of the rechargeable battery pack 21, 22 themselves without contacting the fastening section 14 in the process. The rechargeable battery packs 21, 22 project with a free end out of the fastening section 14. The fixing device 130 extends in the longitudinal direction 85, 85′ of the rechargeable battery packs 21, 22 in particular over at least 50%, preferably over 70%, in particular over 85% of the free end of the rechargeable battery packs 21, 22. It can also be provided that the fixing device 130 extends up to the fastening section 14 and contacts the latter.

As shown in FIG. A19, the fixing device 130 is held on the housing 2 via a positioning unit 134, presently designed as a tether. The positioning unit 134 is fastened to the fastener 11. The positioning unit 134 can also comprise an eyelet, in particular an elastic eyelet, which is suspended from the fastener 11 and to which the tether is fastened. The tether is shown in FIG. A19 schematically, in dashed lines. As shown in FIGS. A19, A20 and A21, a retaining guide 135 is formed on the middle section 133. The retaining guide 135 is formed from a first opening 136, through which the tether is threaded from the receiving space to the outside. The tether then runs in a first channel 137 assigned to the retaining guide 135 along a longitudinal side of the fixing device 130. Provided in the channel 137 is a second opening 138, into which the tether is threaded and runs onto the other longitudinal side of the fixing device 130. On the other longitudinal side of the fixing device 130, a first opening 136′, a channel 137 and a second opening 138′ are likewise provided mirror-symmetrically, through which the tether runs back again.

The tether is preferably elastic. To release the fixing device 130 from the rechargeable battery packs 21, 22, it should be pulled away from the rechargeable battery packs 21, 22 in the longitudinal direction 85, 85′ of the rechargeable battery packs 21, 22. Subsequently, the fixing device 130 can hang loosely from the fastener 11. The rechargeable battery packs 21, 22 can now be released from the fastening section 14 and charged or replaced with other rechargeable battery packs 21, 22. Once the rechargeable battery packs 21, 22 have been fastened to fastening section 14 again, the fixing device 130 can be put back on the second end faces 87, 87′ of the rechargeable battery packs 21, 22 by stretching the tether.

FIG. A22 shows an alternative design of the fixing device 130. This has, alternatively to the retaining guide 135, a first opening 136 on at least two longitudinal sides, through which opening the tether can be threaded.

It can also be provided in one alternative embodiment that the fixing device 130 extends as far as the fastening section 14 and partially overlaps the latter. The overlapping of the fastening section 13 by the fixing device 130 can be designed in such a way that a clamping effect is created which holds the fixing device 130 on the fastening section 14. In such an embodiment, no positioning unit 134 is necessary, but one can also be used in addition.

The fixing device 130 is preferably made as a single part. The fixing device 130 is in particular formed from a plastic, in particular from an elastomer. Thus, the fixing device 130 is used to protect the first rechargeable battery pack 21 and in particular the rechargeable battery pack 22 against impacts, for example if the power tool 1 falls onto the ground.

FIG. B1 shows a perspective illustration of a power tool, using the example of a chain saw. However, a hedge trimmer, a brush cutter or the like may also be provided. The power tool 1 is shown here in a parked position 2 on a parking area 3 as a reference area. However, when it is in operation, it can also be brought into various other positions.

The power tool 1 comprises a tool 12, which here is embodied as a saw chain rotating around a guide bar 11, and which is driven in its rotary movement during operation by a drive motor 10, which is only indicated here. The drive motor 10 can be a combustion engine and is in the shown exemplary embodiment an electric motor for cordless operation. Alternatively, however, a mains voltage-powered operation is also an option.

The power tool 1 comprises a housing 21, onto the rear end of which that faces the user a handle 4 is molded as part of the housing 21. A grip tube 5 is also attached in the direction of the tool 12 towards the front. Between the rear handle 4 and the front grip tube 5, a battery recess 9 for a spare battery (not shown) for supplying energy to the power tool 1 is molded in the housing 21. Located in front of the grip tube 5 in the direction of the tool 12 is a hand hoop guard 8. A loudspeaker 45 of an optional noise generator for adjusting the operating noise is attached in the region of the hand hoop guard 8.

The power tool 1 is provided on its rear handle 4 with a first operating element 6 for controlling the drive motor 10. The first operating element 6 serves to control the power of the drive motor 10, wherein a power setting between “off” and “full load” can be set steplessly via corresponding control electronics. Alternatively, however, a simple on/off switch may also be expedient. A second operating element 7, likewise attached to the handle 4, serves as a locking element for the first operating element 6. In the unactuated state of the second operating element 7, the first operating element 6 cannot be depressed, so that the drive motor 10 is prevented from being accidentally powered. Only in the actively actuated state of the second operating element 6 can the first operating element 6 be depressed, which causes the drive motor 10 to start up and drive the tool 12.

FIG. B2 shows a perspective interior view of the region of the handle 4 according to FIG. B1, wherein to illustrate the inner mechanical structural design, a half-shall, facing the viewer, of the handle 4 has been taken off and is not illustrated. For further clarification, FIG. B3 shows the arrangement according to FIG. B2 in a longitudinal sectional illustration, wherein the following embodiments relate to viewing FIG. B2 and 3 in combination.

The first operating element 6 is pivotably mounted on a bearing journal with a pivot axis 16 and is pressed by means of a return spring 20 into the unactuated position 14 illustrated here. The pivot axis 16 of the first operating element 6 lies transverse to the longitudinal direction of the power tool 1 according to FIG. B1. An operating section of the first operating element 6 that is accessible to the user projects downwards out of the handle 4 formed as part of the housing 21. The first operating element 6 is provided with an operating element opening 40 in its lower region in its weight direction, which allows dirt to exit from the region of the second operating element 7.

The second operating element 7 has a bearing shaft 35 that extends from a first, front bearing journal 23 to a second, rear bearing journal 24. The two bearing journals 23, 24 are pivotably mounted in corresponding bearing openings of the housing 21 and thereby define a pivot axis 17 of the second operating element 7. The pivot axis 17 of the second operating element 7 runs approximately parallel to the longitudinal axis of the power tool 1 according to FIG. B1. FIG. B11 shows a front view of the arrangement described herein. It is apparent from looking at FIG. B2, 3 and 11 in combination that the pivot axis 16 of the first operating element 6 and the pivot axis 17 of the second operating element 7 are inclined towards one another and here in the preferred exemplary embodiment run perpendicular to one another.

The second operating element 7 has at least one operating section 26, here two operating sections 26 auf, which are provided for the operator to actuate the second operating element 7. The operating sections 26 have a connecting region 27, by means of which they are preferably connected in one piece to the other sections of the second operating element 7. The housing 21 is provided with an opening 22 in the region of the handle 4. The two operating sections 26 project at this connecting region 27 through the opening 22 to the outer face of the housing 21.

The second operating element 7 is shown here in an unactuated position 18. The arrangement comprises a spring 13, which interacts with an actuating contour 30 of the second operating element and thereby holds the second operating element 7 in this unactuated position 18. In particular, it can be seen in FIG. B3 that the spring 13 has a tensioning section 28, which is securely attached to the housing. This is adjoined by a middle region 41 of the spring 13. On its opposite, rear end, the spring 13 is provided with an actuating section 29, which rests on the actuating contour 30 and thereby exerts the desired holding and return effect on the second operating element 7.

Lastly, it can still be seen that the second operating element 7 comprises a cover section 32 which partially encircles the pivot axis 17 in the form of a cylinder section. The operating sections 26 are integrally connected to or molded on this cover section 32 via its connecting regions 27. The opening 22 is at least partially covered on the inner face of the housing 21 by the cover section 32. It is apparent from looking at FIG. B2 and 3 in combination with FIG. B5 and 9 that the opening 22 is completely covered in all positions of the second operating element 7, both in the circumferential direction and in the direction of the pivot axis 17.

FIG. B4 and 5 show the arrangement according to FIG. B2 and 3 in each case in a side view with a viewing direction parallel to the pivot axis 16 of the first operating element 6. It can be seen that in this viewing direction, the first operating element 6 is arranged below the bearing journal 23, whereas the spring 13 is located thereabove. In other words, the first operating element 6 and the spring 13 are arranged in the mentioned viewing direction on opposite sides of the bearing journal 23 of the second operating element 7.

In the direction of the pivot axis 17 of the second operating element 7, the connecting region 27 of the operating sections 26 extends along an operating section area 38 of the power tool 1. Perpendicular to the pivot axis 17 of the second operating element 7 lie two planes 36, 37, between which the connecting region 27 of the operating sections 26 lie. In other words, the connecting regions 27 of the operating sections 26 extend from the first plane 36, which is perpendicular to the pivot axis 17, to the second plane 37, which is likewise perpendicular to the pivot axis 17, and they do not project beyond the mentioned planes 36, 37. The planes 36, 37 furthermore enclose the operating section area 38 of the power tool 1 (FIG. B1).

Furthermore, it can be seen from looking at FIG. B4 and 5 in combination that, in relation to the direction of the pivot axis 17 of the second operating element 7, the tensioning section 28 and the actuating section 29 of the spring 13 extend at least partially on opposite sides of the operating section area 38. In the preferred exemplary embodiment shown, the tensioning section 28 and the actuating section 29 are arranged completely outside the operating section area 38 and on opposite sides thereof.

The spring 13 extends between the cover section 32 and the pivot axis 17. In the process, the cover section 32 covers the central region 41 of the spring 13 towards the outer face of the housing 21. In a combined view with FIG. B10, it can still be seen that the actuating contour 30 of the second operating element 7 and the cover section 32 delimit an opening 42 through which the spring 13 projects. In other words, the spring 13 plunges through the second operating element 7 in the longitudinal direction.

FIG. B6 to 9 show the same arrangement in same views as FIG. B2 to 5, with the difference that the second operating element 7, starting from the unactuated position 18 according to FIG. B2, is now pivoted corresponding to an arrow 44 about the pivot axis 17 and into an actuated position 19 (FIG. B6). The user does this by pressing a finger on one of the two operating sections 26. In the actuated position 19 (FIG. B6) of the second operating element 7, the first operating element 6, starting from its unactuated position 14, can be pivoted or pressed about its pivot axis 16 counter to the force of the return spring 20 and into an actuated position 15. Firstly, it is apparent from FIG. B2 to 5 that the second operating element 7, in its shown unactuated position 18 shown there, blocks a movement of the first operating element 6 in the direction of the actuated position 15 (FIG. B6). For this purpose, the second operating element 7 is provided with a downwardly projecting extension 25 that interacts with a locking section 31 of the first operating element 6. In the actuated position 19 according to FIG. B6 to 9, the extension 25 is, however, 7 pivoted away so far to the side owing to the pivoting movement of the second operating element that it no longer overlaps the locking section 31 of the first operating element 6. The first operating element 6 can be depressed into the actuated position 15, without that the locking section 31 colliding with the extension 25.

Furthermore, it can be seen that the spring 13 acting on the second operating element 7 is designed as a leaf spring. It is apparent from a combined view of FIG. B5 and 9 that the leaf spring has a midplane 33 with which it emerges from the housing restraint in the region of its tensioning section 28. In this case, the midplane 33 is designed to have an incline relative to the pivot axis 17 of the second operating element 7 in such a way that the midplane 33 makes an angle α with the pivot axis 17. The angle α is preferentially at least 10° and is at least 15° in the shown exemplary embodiment. Starting from the tensioning section 28, the leaf spring runs along a bending line due to its pre-tension, so that in the region of the longitudinally opposite end, in the bent-up state according to FIG. B9, it runs approximately parallel to and at a small distance from the bearing shaft 35.

It is apparent from looking in particular at FIG. B6 and 7 in combination that the actuating section 29 of the spring 13 has one contact section 39, here two laterally mutually opposite contact sections 39, in the contact region with the actuating contour 30. The contact sections 39 are bent away from the actuating contour 30 in the circumferential direction relative to the pivot axis 17. Moreover, the actuating section 29 with its contact section 39 is arranged in the direction of the pivot axis 17 outside the cover sections 32, so that the bent-up contact sections cannot collide with the cover section 29 even when in the raised state according to FIG. B9.

From looking at FIG. B2 and 6 in combination, it is apparent that the actuating contour 30 of the second operating element 7 has at least one convexly curved section 43 against which the spring 13 rests with its actuating section 29 in particular in the actuated position 19 (FIG. B6). In the shown preferred exemplary embodiment, comprises the actuating contour 30 comprises a respective convexly curved section 43 on either side of the pivot axis 17. The two convexly curved sections 43 are designed to be mirror-symmetrical to each other. In the unactuated position 18 of the second operating element 7 according to FIG. B2, the spring 13 with its actuating section 29 lies in the center between and on both convexly curved sections 43. The arrangement of the convexly curved sections 43 on both sides allows the second operating element 7 to be actuated not just in the direction of the arrows 44 (FIG. B6) in order to reach an actuated position 19. Rather, a pivoting movement of the second operating element 7 counter to the direction of the arrow 44 is also possible in order to reach an actuated position 19. Both actuated positions have the effect that the blocking of the first operating element 6 by means of the extension 25 is removed.

Furthermore, it can be seen in FIG. B6 that on pivoting the second operating element 7 into the respective actuated position 19, the actuating section 29 of the spring 13 slides with one of its bent contact sections 39 along the associated, convexly curved section 43, to allow a free pivoting movement. By comparing FIG. B5 and 9 it becomes apparent that the actuating section 29 of the spring 13 sliding on the actuating contour 30 is raised counter to its spring force, thereby increasing the acting spring force. The convex shape of the curved sections 43 causes an only initially high force increase, which then increases only slightly as the deflection progresses. Since, moreover, in the actuated position 19 the actuating section 29 presses eccentrically to the pivot axis 17 on the curved section 43 (FIG. B6), a self-aligning torque is created, which automatically turns the second operating element 7 from the actuated position 19 (FIG. B6) back into the unactuated position 18 (FIG. B2).

It can be seen from the rear view according to FIG. B10 that one of the two operating sections 26 in the unactuated position 18 (FIG. B2) protrudes straight up at a right angle to the associated tangent of the cover section 32. The further operating section 26 projects laterally at an angle and is ergonomically offset. In this case, however, it makes an angle β of at least 30° with the associated tangent of the cover section 32 in the connecting region 27. In the exemplary embodiment shown, this angle β is equal to 90°, just as in the case of the vertical operating section 26. It is also apparent from the same view that the cover section 32 extends over an angle range γ of at least 120°, here of slightly more than 180°, arcuately about the pivot axis 17.

FIG. B12 shows a perspective view of a variant of the grip region according to FIG. B2 to 11, in which the opening 22 in the housing 21 is enlarged towards the right side to make space for an optional third operating section 26 of the second operating element 7. This optional operating section 26, only indicated here schematically in dashed lines, can be configured for example mirror-symmetrically to the opposite-lying offset operating section 26, in order to make it easier to access.

Further advantageous embodiments of the power tool are:
1. Pruner, comprising a housing 2 and a drive motor 3, wherein the drive motor 3 drives a saw chain 5, which is guided in a guide groove of a guide bar 4, in a rotary motion via a drive chain sprocket,
   wherein the guide bar 4 is arranged on a front end 6 of the housing 2 and has a longitudinal plane 31 spanned by the guide groove,
   wherein a fastening section is provided on a rear end 7 of the housing 2 for receiving a first rechargeable battery pack 21 for supplying the drive motor 3 with electrical energy, wherein the housing 2 comprises a first handle 9 on which a hand of the operator can rest, wherein in particular the first handle 9 is assigned an actuating element 10 for actuating the drive motor 3,
   characterized in that the fastening section 14 is provided for receiving a second rechargeable battery pack 22, wherein the fastening section 14 is arranged on the housing 2, in particular at least on the first handle 9, in such a way that a center of gravity S1 of the pruner 1 lies in the first handle 9 when the pruner 1 is in a state in which the first rechargeable battery pack 21 and the second rechargeable battery pack 22 are arranged on the fastening section 14.
2. Pruner according to embodiment 1,
   characterized in that the guide bar 4 has a longitudinal center axis 30 and a transverse plane 32 that is aligned orthogonal to the longitudinal plane 31, wherein the longitudinal center axis 30 lies in the longitudinal plane 31 and in the transverse plane 32, wherein the transverse plane 32 of the pruner 1 is divided into an upper section 36 comprising the drive motor 3 and into a lower section 37.
3. Pruner according to embodiment 2,
   characterized in that the center of gravity S1 of the pruner 1 lies in the lower section 37 of the pruner 1.
4. Pruner according to embodiment 2 or 3,
   characterized in that the fastening section 14 of the housing 2 lies in the lower section 37 of the pruner 1.
5. Pruner according to one of embodiments 1 to 4,
   characterized in that the drive motor 3 has a rotational axis 33, and the rotational axis 3 runs parallel to the longitudinal plane 31 of the guide bar 4 or lies in the longitudinal plane 31 of the guide bar 4.
6. Pruner according to one of embodiments 1 to 5,
   characterized in that the fastening section 14 is designed in such a way that the rechargeable battery packs 21, 22 can be inserted into the fastening section 14 in an insertion direction 34.
7. Pruner according to embodiment 6,
   characterized in that the insertion direction 34 substantially corresponds to the longitudinal direction 35 of the first handle 9.
8. Pruner according to one of embodiments 1 to 7,
   characterized in that the fastening section 14 is designed in such a way that when the pruner 1 is in a state in which the first rechargeable battery pack 21 and the second rechargeable battery pack 22 are inserted, a distance a, measured in the direction of the longitudinal center axis 30, between a center of gravity SA1 of the first rechargeable battery pack 21 and the center of gravity S1 of the pruner 1 is greater than a distance b, measured in the longitudinal direction 30, between a center of gravity SA2 of the second rechargeable battery pack 22 and the center of gravity S1 of the pruner 1.
9. Pruner according to one of embodiments 1 to 8,
   characterized in that the fastening section 14 is designed in such a way that when the pruner 1 is in a state in which the first rechargeable battery pack 21 and the second rechargeable battery pack 22 are inserted, a distance c, measured perpendicularly to the transverse plane 32, between the center of gravity SA1 of the first rechargeable battery pack 21 and the center of gravity S1 of the pruner 1 is smaller than a distance d, measured perpendicularly to the transverse plane 32, between the center of gravity SA2 of the second rechargeable battery pack 22 and the center of gravity S1 of the pruner 1.
10. Pruner according to one of embodiments 1 to 9,
   characterized in that the actuating element 10 is arranged on the first handle 9.
11. Pruner according to embodiment 10,
   characterized in that the actuating element 10 is designed as a lever that can pivot about a first pivot axis 38, wherein the actuating element 10 has an outer contour 25 with a maximum first radius r1 with respect to the first pivot axis 38, wherein the first radius r1 is greater than the distance e between the center of gravity S1 of the pruner 1 and the first pivot axis 38.
12. Pruner according to one of embodiments 1 to 11,
   characterized in that the housing 2 has a longitudinal midplane 43 running parallel to the longitudinal plane 31, wherein the longitudinal midplane 43 bisects the housing 2, wherein the center of gravity S1 of the pruner 1 lies almost in the longitudinal midplane 43 of the housing 2.
13. Pruner according to one of embodiments 1 to 12,
   characterized in that the housing 2 comprises a second handle 57 on which the operator's other hand can rest, and wherein the center of gravity S1 of the pruner 1 is designed to be between the second handle 57 and the actuating element 10 assigned to the first handle 9.
14. Pruner according to one of embodiments 1 to 13,
   characterized in that the distance between the actuating element 10 and the center of gravity S1 of the pruner 1 is not greater than 3 cm, preferentially not greater than 2 cm.
15. Pruner, comprising a housing 2 and a drive motor 3, wherein a fastening section 14 is provided on a rear end 7 of the housing 2 for receiving a first rechargeable battery pack 21 for supplying the drive motor 3 with electrical energy,
   wherein the housing 2 comprises a handle housing 48 with a first handle 9 on which a hand of the operator can rest, wherein the first handle 9 is assigned an actuating element 10 for actuating the drive motor 3,
   characterized in that the pruner 1 has a fastener 11, which in particular comprises a base body 44, wherein the fastener 11 has at least one first fastening element 12 for holding the pruner 1 on the first fastening element 12, wherein the first fastening element 12 is designed in particular as an eyelet,
   and in that the fastener 11 is arranged on the handle housing 48.
16. Pruner according to embodiment 15,
   characterized in that the fastener 11 has a second fastening element 13 for holding the pruner 1 on the second fastening element 13, wherein the second fastening element 13 is designed in particular as an eyelet.
17. Pruner according to one of embodiments 15 to 16,
   characterized in that the pruner 1 comprises a guide bar 4 with a guide groove and a saw chain 5 that rotates in the guide groove, wherein the guide bar 4 has a longitudinal plane 31 spanned by the guide groove, and in that the housing 2 has a first longitudinal outer side 28 and a second longitudinal outer side 29, wherein the longitudinal outer sides 28, 29 are arranged opposite each other with respect to a plane that is aligned parallel to the longitudinal plane 31 of the guide bar 4, wherein the first fastening element 12 is arranged on the first longitudinal outer side 28 and the second fastening element 13 is arranged on the second longitudinal outer side 29.
18. Pruner according to one of embodiments 15 to 17,
   characterized in that the fastener 11 is arranged in the fastening section 14 of the housing 2, wherein the fastening section 14 is part of the handle housing 47.
19. Pruner according to one of embodiments 15 to 18,
   characterized in that the fastening section 14 is provided for receiving a second rechargeable battery pack 22, and in that the fastener 11 is arranged between the first rechargeable battery pack 21 and the second rechargeable battery pack 22 when the pruner is in a state in which the first rechargeable battery pack 21 and the second rechargeable battery pack 22 are inserted.
20. Pruner according to one of embodiments 15 to 19,
   characterized in that the fastener 11 is made as a single part.
21. Pruner according to one of embodiments 15 to 20,
   characterized in that the housing 2 comprises a first housing half 15 and a second housing half 16, wherein the fastener 11 is held between the first housing half 15 and the second housing half 16, in particular in a form-fitting manner.
22. Pruner according to one of embodiments 15 to 21,
   characterized in that the base body 44 of the fastener 11 is flat.
23. Pruner according to one of embodiments 15 to 22,
   characterized in that the base body 44 extends in a longitudinal direction 45, wherein a fastening element 12, 13 is formed on at least one of the longitudinal ends 46, 46′ of the base body 44, preferably a fastening element 12, 13 is formed in each case on the longitudinal ends 46, 46′ of the base body 44.
24. Pruner according to one of embodiments 21 to 23,
   characterized in that the first housing half 15 and the second housing half 16 are connected to each other via a mechanical connection, in particular a screw connection 18, adjacent to the fastener 11.
25. Pruner according to one of embodiments 15 to 24,
   characterized in that the fastening section 14 is provided for receiving a second rechargeable battery pack 22, wherein the pruner 1 has a center of gravity S1 when the pruner is in a state 1 in which the first rechargeable battery pack 21 and the second rechargeable battery pack 22 are inserted, and in that the fastener 11 is arranged between the center of gravity S1 of the pruner 1 and the rear end 7 of the housing 2.
26. Pruner, comprising a housing 2 and a drive motor 3, wherein the housing 2 comprises a first handle 9 with a first handle section 55 on which a hand of the operator can rest, wherein the first handle 9 is assigned an actuating element 10 for actuating the drive motor 3, and wherein the handle section 55 has a top side 51 and a bottom side 52 facing away from the top side 51,
   characterized in that the housing 2 comprises a cover clip 101, wherein the cover clip 101 extends from its first end 103 up to its second end 104 along the bottom side 52 of the first handle section 55, in particular substantially parallel to the bottom side of the first handle section, and wherein the cover clip 101 has a taper 102 in the direction of its second end 104.
27. Pruner according to embodiment 26,
   characterized in that the first end 103 of the cover clip 101 is adjacent to a motor housing 49 of the housing 2 and/or to a central housing 47 of the housing 2.
28. Pruner according to embodiment 26 or 27,
   characterized in that the pruner 1 comprises a guide bar 4 with a guide groove and a saw chain 5 guided in the guide groove, and in that the cover clip 101 has a maximum width k measured perpendicular to a longitudinal plane 31 of the guide bar 4 spanned by the guide groove of the guide bar 4 and has a minimum width l at its taper 102, wherein the minimum width l corresponds to at most 70%, preferentially at most 60%, in particular approximately 50% of the maximum width k of the cover clip 101.
29. Pruner according to embodiment 28,
   characterized in that the minimum width l at the taper 102 of the cover clip 101 corresponds to at least 10%, preferably at least 20%, particularly preferably at least 30%, preferentially at least 40% of the maximum width k of the cover clip 101.
30. Pruner according to embodiment 28 or 29,
   characterized in that a lockout lever 26 for locking and releasing the actuating element 10 is provided, wherein the lockout lever 26 has an outer contour 27 which extends over a width m perpendicular to the longitudinal plane 31 of the guide bar 4, the width m being less than the maximum width k of the cover clip 101.
31. Pruner according to embodiment 30,
   characterized in that the cover clip 101 extends from a first longitudinal side 108 up to a second longitudinal side 109, wherein the outer contour 27 of the lockout lever 26 is arranged in the direction perpendicular to the longitudinal plane 31 of the guide bar 4 completely between the first longitudinal side 108 and the second longitudinal side 109 of the cover clip 101, at least in the region of the first end 103 of the cover clip 101.
32. Pruner according to one of embodiments 26 to 31,
   characterized in that the actuating element 10 is arranged between the first handle section 55 and the cover clip 101.
33. Pruner according to one of embodiments 26 to 32,
   characterized in that the cover clip 101 has a top side 105 facing the bottom side 52 of the first handle section 55, wherein the housing 2 comprises a bridge 107, the bridge 107 extending from the top side 105 of the cover clip 101 up to the bottom side 52 of the handle section 55.
34. Pruner according to embodiment 33,
   characterized in that the actuating element 10 is arranged between the bridge 107 and the first end 103 of the cover clip 101.
35. Pruner according to embodiment 33 or 34,
   characterized in that the taper 102 of the cover clip 101 is arranged between the bridge 107 and the second end 104 of the cover clip 101.
36. Pruner according to one of embodiments 26 to 35,
   characterized in that a fastening section 14 for receiving a first rechargeable battery pack 21 for supplying the drive motor 3 with electrical energy is provided on a rear end 7 of the housing 2.
37. Pruner according to embodiment 36,
   characterized in that the fastening section 14 is provided for receiving a second rechargeable battery pack 22.
38. Pruner according to embodiment 36 or 37,
   characterized in that the second end 104 of the cover clip 101 is formed by the fastening section 14 of the housing 2.
39. Pruner, comprising a housing 2 and a drive motor 3,
   wherein the drive motor 3 drives a saw chain 5, which is guided in a guide groove of a guide bar 4, in a rotary manner via a drive chain sprocket, wherein the guide bar 4 is arranged on a front end 6 of the housing 2 and has a longitudinal plane 31 spanned by the guide groove, wherein the housing 2 comprises a first handle 9 with a first handle section 55 on which a hand of the operator can rest, wherein the first handle 9 is assigned an actuating element 10 for actuating the drive motor 3, wherein the housing 2 comprises a second handle 57 with a second handle section 58 on which the operator's other hand can rest,
   characterized in that a limiting device 60 is provided between the second handle section 58 and the guide bar 4, wherein the limiting device 60 has an elevation 61, extending at least within the longitudinal plane, with respect to the second handle section 58, wherein the elevation 61 is designed in such a way that the hand is prevented from slipping off the second handle section 58 in the direction of the guide bar 4.
40. Pruner according to embodiment 39,
   characterized in that the elevation 61 is designed in such a way that the elevation 61 forms a form-fitting stop in the direction of the guide bar 4 for a hand of the operator resting on the second handle section 58.
41. Pruner according to embodiment 39 or 40,
   characterized in that in the viewing direction perpendicular to the longitudinal plane 31, the limiting device 60 has an outer contour 62, wherein the outer contour 62 of the limiting device 60 has a first end 63 adjoining the second handle section 58 and a second end 64 adjacent to the guide bar 4.
42. Pruner according to embodiment 41,
   characterized in that the elevation 61 is formed on the first end 63 of the outer contour 62.
43. Pruner according to one of embodiments 39 to 42,
   characterized in that the elevation 61 has a concave contact section 65 adjacent to the second handle section 58.
44. Pruner according to embodiment 42 or 43,
   characterized in that the contact section 65 forms an undercut for an operator's hand resting on the contact section 65.
45. Pruner according to one of embodiments 41 to 44,
   characterized in that in the viewing direction perpendicular to the longitudinal plane 31, the elevation 61 has a height h measured perpendicular to the second handle section 58 at the first end 63 of the outer contour 62, wherein the height h corresponds to at least 15%, in particular at least 20%, preferentially approximately 25% of a length l, measured in the longitudinal direction 59 of the second handle section 58, of the second handle section 58.
46. Pruner according to one of embodiments 39 to 45,
   characterized in that the housing 2 comprises a lubricant tank 70 for supplying the saw chain 5 with lubricant, wherein the limiting device 60 at least partially encompasses the lubricant tank 70 is.
47. Pruner according to one of embodiments 39 to 46,
   characterized in that the housing 2 is open towards the top in the region of the second handle section 58.
48. Pruner according to one of embodiments 43 to 47,
   characterized in that the contact section 65 is provided with an anti-slip coating.
49. Hand-held power tool, comprising a housing 2 with a longitudinal midplane 43 and a drive motor 3 arranged in the housing 2, wherein a fastening section 14 for receiving a first rechargeable battery pack 21 for supplying the drive motor 3 with electrical energy is provided on a rear end 7 of the housing 2,
   characterized in that the fastening section 14 is provided for receiving a second rechargeable battery pack 22,
   and in that a protective device 80 for protecting the rechargeable battery packs 21, 22 is provided on the fastening section 14, wherein the rechargeable battery packs 21, 22 each extend in their longitudinal direction 85, 85′ from a first end face 86, 86′ up to a second end face 87, 87′, wherein the first end face 86, 86′ of the rechargeable battery packs 21, 22 faces the fastening section 14 and the second end face 87, 87′ of the rechargeable battery packs 21, 22 faces away from the fastening section 14, wherein the protective device 80 comprises at least one first cover element 81, the first cover element 81 extending in the longitudinal direction 85 of the first rechargeable battery pack 21 at least up to the second end face 87 of the first rechargeable battery pack 21.
50. Power tool according to embodiment 49,
   characterized in that the protective device 80 comprises at least one second cover element 82, wherein the second cover element 82 extends in the longitudinal direction 85′ of the second rechargeable battery pack 22 at least up to the second end face 87′ of the second rechargeable battery pack 22.
51. Power tool according to embodiment 49 or 50,
   characterized in that the rechargeable battery packs 21, 22 are each slid in their longitudinal direction 85, 85′ into the fastening section 14.
52. Power tool according to one of embodiments 49 to 51,
   characterized in that the rechargeable battery packs 21, 22 are slid into the fastening section 14 and in that the first rechargeable battery pack 21 and the second rechargeable battery pack 22 each have a longitudinal axis 50, 50′ running in the longitudinal direction 85, 85′ of the respective rechargeable battery pack 21, 22, wherein the longitudinal axes 50, 50′ are aligned parallel to the longitudinal midplane 43 of the housing 2.
53. Power tool according to one of embodiments 49 to 52,
   characterized in that the rechargeable battery packs 21, 22 are arranged offset from one another in their longitudinal direction 85, 85′, and in that the second end faces 87, 87′ of the rechargeable battery packs 21, 22 lie in different planes.
54. Power tool according to one of embodiments 49 to 53,
   characterized in that the rechargeable battery packs 21, 22 are arranged one above the other in a transverse direction 91, wherein the transverse direction 91 is aligned perpendicularly to the longitudinal direction 85 of the first rechargeable battery pack 21 and/or to the longitudinal direction 85′ of the second rechargeable battery pack 22 and lies in a plane that is aligned parallel to the longitudinal midplane 43 of the housing 2.
55. Power tool according to one of embodiments 49 to 54,
   characterized in that the protective device 80 comprises at least one third cover element 83 and preferentially at least one fourth cover element 84, wherein the third cover element 83 and/or in particular the fourth cover element 84 extends in the longitudinal direction 85, 85′ of the rechargeable battery packs 21, 22 at least up to the second end face 87, 87′ of the rechargeable battery packs 21, 22.
56. Power tool according to one of embodiments 49 to 55,
   characterized in that the rechargeable battery packs 21, 22 each have a substantially triangular cross-sectional contour 88, 88′ with rounded corners 99, 99′, the rechargeable battery packs 21, 22 being preferably of identical construction, and in that the rechargeable battery packs 21, 22 each have a back wall 89, 89′ formed between two rounded corners 99, 99′, wherein the rechargeable battery packs 21, 22 are arranged in the fastening section 14 in relation to each other in such a way that the back walls 89, 89′ of the rechargeable battery packs 21, 22 lie opposite one another, and that the first cover element 81 is arranged on a rounded corner of the first rechargeable battery pack 21 that faces away from the second rechargeable battery pack 22, and that in particular the second cover element 82 is arranged on a rounded corner of the second rechargeable battery pack 22 that faces away from the first rechargeable battery pack 21.
57. Power tool according to one of embodiments 53 to 56,
   characterized in that the third cover element 83 and the fourth cover element 84 is arranged in a transverse direction 91 between the rechargeable battery packs 21, 22.
58. Power tool according to embodiment 57,
   characterized in that the third cover element 83 and the fourth cover element 84 are formed opposite one another in relation to a plane aligned parallel to the longitudinal plane 31 of the guide bar 4.
59. Power tool according to one of embodiments 50 to 58,
   characterized in that the protective device 80 have cutouts 90 between the cover elements 81, 82, 83, 84 for gripping the rechargeable battery packs 21, 22.
60. Power tool according to one of embodiments 50 to 59,
   characterized in that movement gaps 92 are provided between the cover elements 81, 82, 83, 84 and the rechargeable battery packs 21, 22, wherein the movement gaps 92 preferentially taper in the direction of the first end face 86, 86′ of the rechargeable battery packs 21, 22.
61. Power tool according to one of embodiments 53 to 60,
   characterized in that the third cover element 83 and/or the fourth cover element 84 has an outer face 97, 97′ facing away from the rechargeable battery packs 21, 22, wherein the outer face 97, 97′ has a concave curvature 98, 98′ that projects between the rechargeable battery packs 21, 22.
62. Hand-guided power tool comprising: at least one tool 12; a drive motor 10 for driving the at least one tool 12; a housing 21; a first operating element 6 designed for controlling the drive motor 10; and a second operating element 7, which is mounted so as to be pivotable relative to the housing 21 about a pivot axis 17 between an unactuated position 18 and at least one actuated position 19, wherein the second operating element 7 in its unactuated position 18 blocks a movement of the first operating element 6 in the direction of an actuated position 15 of the first operating element 6, wherein the second operating element 7 is held by a spring 13 in the unactuated position 18, wherein the spring 13 has a tensioning section 28 which is securely attached to the housing, and wherein the spring 13 has an actuating section 29 which interacts with an actuating contour 30 of the second operating element 7, wherein the second operating element 7 has at least one operating section 26 which is provided for an operator to actuate the second operating element 7, wherein the operating section 26 has a connecting region 27 at which the operating section 26 projects through an opening 22 of the housing 21 onto the outer face of the housing 21, wherein the connecting region 27 of the operating section 26 extends from a first plane 36, running perpendicularly to the pivot axis 17, to a second plane 37, running perpendicularly to the pivot axis 17, and does not project beyond the planes 36, 37, wherein the planes 36, 37 enclose an operating section area 38 of the power tool 1, and wherein the tensioning section 28 and the actuating section 29 extend at least partially on opposite sides of the operating section area 38.
63. Power tool according to embodiment 62,
   characterized in that the tensioning section 28 and the actuating section 29 are arranged completely outside the operating section area 38.
64. Power tool according to embodiment 62 or 63,
   characterized in that the spring 13 is designed as a leaf spring and emerges from the tensioning section 28 in the direction of a midplane 33, wherein the midplane 33 makes an angle α of at least 10°, in particular at least 15°, with the pivot axis 17.
65. Power tool according to one of embodiments 62 to 64,
   characterized in that the opening 22 is covered at least partially by a cover section 32 of the second operating element 7, wherein the connecting region 27 of the operating section 26 is arranged on the cover section 32.
66. Power tool according to embodiment 65,
   characterized in that the spring 13, at the actuating section 29 in the contact region with the actuating contour 30, has at least one contact section 39 which is bent away from the actuating contour 30 in the circumferential direction relative to the pivot axis 17, wherein the contact section 39 is arranged outside the cover section 32.
67. Power tool according to embodiment 65 or 66,
   characterized in that the spring 13 extends between the cover section 32 and the pivot axis 17, wherein the cover section 32 covers a middle region 41 of the spring 13 towards the outer face of the housing 21.
68. Power tool according to one of embodiments 65 to 67,
   characterized in that the cover section 32 extends arcuately around the pivot axis 17 over an angle range γ of at least 120°.
69. Power tool according to one of embodiments 65 to 68,
   characterized in that the operating section 26 at the connecting region 27 with the cover section 32 makes an angle β of at least 30°.
70. Power tool according to one of embodiments 65 to 69,
   characterized in that the actuating contour 30 and the cover section 32 delimit an opening 42 through which the spring 13 projects.
71. Power tool according to one of embodiments 62 to 70,
   characterized in that the actuating contour 30 has at least one convexly curved section 43.
72. Power tool according to embodiment 71,
   characterized in that the actuating contour 30 has two convexly curved sections 43 and in that the spring 13 rests against both convexly curved sections 43 in the unactuated position 18 of the second operating element 7.
73. Power tool according to one of embodiments 62 to 72,
   characterized in that the first operating element 6 is mounted so as to be able to pivot about a pivot axis 16 between an unactuated position 14 and an actuated position 15 with respect to the housing 21 and in that the pivot axis 16 of the first operating element 6 and the pivot axis 17 of the second operating element 7 run at an angle to each other, in particular at right angles to each other.
74. Power tool according to one of embodiments 62 to 73,
   characterized in that the second operating element 7 has a bearing shaft 35 which extends from a first bearing journal 23 to a second bearing journal 24, and in that, in the viewing direction of a pivot axis 16 of the first operating element 6, the first operating element 6 and the spring 13 are arranged on opposite sides of the bearing shaft 35 of the second operating element 7.
75. Power tool according to one of embodiments 62 to 74,
   characterized in that the second operating element 7 has at least two operating sections 26 that project out of the housing 21.

1.-75. (canceled)

76. A pruner, comprising:
a housing (2); and
a drive motor (3),
wherein the drive motor (3) drives a saw chain (5) in a rotary motion via a drive chain sprocket,
wherein the saw chain (5) is guided in a guide groove of a guide bar (4),
wherein the guide bar (4) is arranged on a front end (6) of the housing (2) and has a longitudinal plane (31) spanned by the guide groove,
wherein the housing (2) comprises a first handle (9) with a first handle section (55) on which a hand of an operator can rest,
wherein the first handle (9) is coupled to an actuating element (10) for actuating the drive motor (3),
wherein the housing (2) comprises a second handle (57) with a second handle section (58) on which the operator's other hand can rest,
wherein a limiting device (60) is provided between the second handle section (58) and the guide bar (4),
wherein the limiting device (60) has an elevation (61), extending at least within the longitudinal plane, with respect to the second handle section (58), and
wherein the elevation (61) is designed such that the hand is prevented from slipping off the second handle section (58) toward the guide bar (4).

77. The pruner according to claim 76,
wherein the elevation (61) forms a form-fitting stop toward the guide bar (4) for the operator's other hand resting on the second handle section (58).

78. The pruner according to claim 76,
wherein, in a viewing direction perpendicular to the longitudinal plane (31), the limiting device (60) has an outer contour (62),
wherein the outer contour (62) of the limiting device (60) has a first end (63) adjoining the second handle section (58) and a second end (64) adjacent to the guide bar (4), with the elevation (61) being formed on the first end (63) of the outer contour (62).

79. The pruner according to claim 76,
wherein the elevation (61) has a concave contact section (65) adjacent to the second handle section (58).

80. The pruner according to claim 79,
wherein the concave contact section (65) forms an undercut for the operator's other hand resting on the concave contact section (65).

81. The pruner according to claim 78,
wherein, in the viewing direction perpendicular to the longitudinal plane (31), the elevation (61) has a height (h) measured perpendicularly to the second handle section (58) at the first end (63) of the outer contour (62),
wherein the height (h) corresponds to at least 15% of a length (l), measured in a longitudinal direction (59) of the second handle section (58), of the second handle section.

82. The pruner according to claim 76,
wherein the housing (2) comprises a lubricant tank (70) for supplying the saw chain (5) with lubricant,
wherein the limiting device (60) at least partially encompasses the lubricant tank (70).

83. The pruner according to claim 76,
wherein the housing (2) is open towards a top in a region of the second handle section (58).

84. The pruner according to claim 79,
wherein the concave contact section (65) is provided with an anti-slip coating.

85. A pruner, comprising:
a housing (2); and
a drive motor (3),
wherein the housing (2) comprises a first handle (9) with a first handle section (55) on which a hand of an operator can rest,
wherein the first handle (9) is coupled to an actuating element (10) for actuating the drive motor (3),
wherein the first handle section (55) has a top side (51) and a bottom side (52) facing away from the top side (51),
wherein the housing (2) comprises a cover clip (101),
wherein the cover clip (101) extends from a first end (103) to a second end (104) along the bottom side (52) of the first handle section (55), and
wherein the cover clip (101) has a taper (102) toward the second end (104).

86. The pruner according to claim 85,
wherein the first end (103) of the cover clip (101) is adjacent to a motor housing (49) of the housing (2) and/or to a central housing (47) of the housing (2).

87. The pruner according to claim 85,
wherein the pruner (1) comprises a guide bar (4) with a guide groove and a saw chain (5) guided in the guide groove, and
wherein the cover clip (101) has a maximum width (k) measured perpendicularly to a longitudinal plane (31) of the guide bar (4), the longitudinal plane being spanned by the guide groove of the guide bar (4), and has a minimum width (l) at the taper (102),
wherein the minimum width (l) corresponds to at most 70% of the maximum width (k) of the cover clip (101).

88. The pruner according to claim 87,
wherein the minimum width (l) of the cover clip (101) at the taper (102) corresponds to at least 10% of the maximum width (k) of the cover clip (101).

89. The pruner according to claim 87,
wherein a lockout lever (26) for locking and releasing the actuating element (10) is provided,
wherein the lockout lever (26) has an outer contour (27) which extends over a width (m) perpendicular to the longitudinal plane (31) of the guide bar (4),
wherein the width (m) is less than the maximum width (k) of the cover clip (101).

90. The pruner according to claim 89,
wherein the cover clip (101) extends from a first longitudinal side (108) to a second longitudinal side (109),
wherein the outer contour (27) of the lockout lever (26) is arranged, in a direction perpendicular to the longitudinal plane (31) of the guide bar (4), completely between the first longitudinal side (108) and the second longitudinal side (109) of the cover clip (101), at least in a region of the first end (103) of the cover clip (101).

91. The pruner according to claim 85,
wherein the actuating element (10) is arranged between the first handle section (55) and the cover clip (101).

92. A pruner, comprising:
a housing (2); and
a drive motor (3),
wherein the drive motor (3) drives a saw chain (5) in a rotary motion via a drive chain sprocket,
wherein the saw chain (5) is guided in a guide groove of a guide bar (4),
wherein the guide bar (4) is arranged on a front end (6) of the housing (2) and has a longitudinal plane (31) spanned by the guide groove,
wherein a fastening section (14) is provided on a rear end (7) of the housing (2) for receiving a first rechargeable battery pack (21) for supplying the drive motor (3) with electrical energy,
wherein the housing (2) comprises a first handle (9) on which a hand of an operator can rest,
wherein the first handle (9) is coupled to an actuating element (10) for actuating the drive motor (3),
wherein the fastening section (14) is provided for receiving a second rechargeable battery pack (22),
wherein the fastening section (14) is arranged on the housing (2) such that a center of gravity (S1) of the pruner (1) lies in the first handle (9) when the pruner (1) is in a state in which the first rechargeable battery pack (21) and the second rechargeable battery pack (22) are arranged on the fastening section (14).

93. The pruner according to claim 92,
wherein the guide bar (4) has a longitudinal center axis (30) and a transverse plane (32) that is aligned orthogonal to the longitudinal plane (31),
wherein the longitudinal center axis (30) lies in the longitudinal plane (31) and in the transverse plane (32),
wherein the transverse plane (32) of the pruner (1) is divided into an upper section (36) comprising the drive motor (3) and into a lower section (37).

94. The pruner according to claim 93,
wherein the center of gravity (S1) of the pruner (1) lies in the lower section (37) of the pruner (1).

95. The pruner according to claim 93,
wherein the fastening section (14) of the housing (2) lies in the lower section (37) of the pruner (1).
